(19) United States
(12) Patent Application Publication
(10) Pub. No.: US 2016/0200933 A1
(43) Pub. Date: Jul. 14, 2016

(54) RESIN COMPOSITION, PROTECTIVE FILM FOR POLARIZING PLATE, POLARIZING PLATE, AND DISPLAY

(71) Applicant: FUJIFILM Corporation, Tokyo (JP)

(72) Inventors: Masatoshi MIZUMURA, Kanagawa (JP); Nobutaka FUKAGAWA, Kanagawa (JP); Shigeki UEHIRA, Kanagawa (JP)

(73) Assignee: FUJIFILM Corporation, Tokyo (JP)

(21) Appl. No.: 14/990,357

(22) Filed: Jan. 7, 2016

(30) Foreign Application Priority Data
Jan. 8, 2015 (JP) 2015-002122

(51) Int. Cl. C09D 101/12; G02B 1/04; G02B 5/30; G02B 1/14

(52) U.S. Cl. CPC C09D 101/12; G02B 1/14; G02B 1/04; G02B 5/305

(57) ABSTRACT

A resin composition including compounds represented by Formulas (1) and (TA); and a protective film for a polarizing plate and a display using the same:

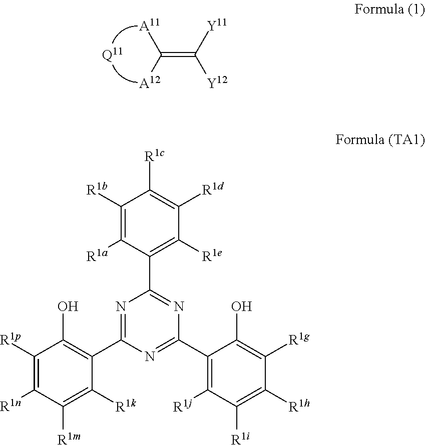

wherein A¹¹ and A¹² independently designate a heteroatom; Y¹¹ and Y¹² independently designate a hydrogen atom or a substituent; at least one of Y¹¹ and Y¹² has the Hammett's substituent constant σp value of 0.2 or more; Q¹¹ designates a group of atoms required for forming a 5- or 6-membered ring bonded with A¹¹, A¹² and the carbon atom of >C═; R^{1a} to R^{1e} each independently designate a hydrogen atom or a substituent other than a hydroxy group; when at least one of R^{1a} to R^{1e} is a substituent, at least one has the Hammett's substituent constant σp value of 0.3 or more; and R^{1g} to R^{1j} and R^{1k} to R^{1p} independently designate a hydrogen atom or a substituent.

### CROSS-REFERENCE TO RELATED APPLICATION

The present application claims priority under 35 U.S.C. §119 to Japanese Patent Application No. 2015-002122, filed on Jan. 8, 2015. The above application is hereby expressly incorporated by reference, in its entirety, into the present application.

### TECHNICAL FIELD

The present invention relates to a resin composition, a protective film for a polarizing plate, a polarizing plate, and a display.

### BACKGROUND ART

An ultraviolet absorber has been used so far together with various resins and so forth to provide the resins with absorbability of ultraviolet rays. As the ultraviolet absorber, an inorganic type and an organic type are known. In the case of inorganic type ultraviolet absorber, while durability such as weather resistance and heat resistance of the ultraviolet absorber per se is excellent, an absorption wavelength is determined depending on a band gap of the compound. Therefore, a degree of freedom of selection is low, and only a limited absorber can absorb light in the region of long wavelength ultraviolet rays (UV-A) having 320 to 400 nm.

In the case of organic type ultraviolet absorber, a degree of freedom of a structural design of the compound is high. Therefore, absorbers having various absorption wavelengths can be obtained. However, an absorber in which a maximum absorption wavelength is in the region of the long wave ultraviolet rays tends to be poor in the light resistance of the ultraviolet absorber per se.

Among the organic ultraviolet absorbers, a benzophenone-based or benzotriazol-based ultraviolet absorber has comparatively good light resistance. However, such an absorber is not always sufficient in order to shield light in the region of the long wave ultraviolet rays (UV-A) having 320 to 400 nm.

Moreover, a proposal has been made on simultaneously using two kinds of organic ultraviolet absorbers having different absorption wavelengths (see Patent Literature 1).

A polarizing plate used in the liquid crystal display and the like plays a role of transmitting only light on a plane of polarization in a fixed direction, and performance of the liquid crystal display is significantly influenced depending on the performance of the polarizing plate. A liquid crystal display is regarded as a space-saving image display having only limited power consumption, and applications thereof are extend year after year. In addition to markets in which high-definition images are required, such as televisions, accordingly as markets are expanding in applications of so-called mobiles such as mobile phones and tablet type personal computers, needs for achieving thickness reduction are much further growing.

A basic configuration of the liquid crystal display is formed, in which polarizing plates are provided on both sides of a liquid crystal cell. The polarizing plate generally has a configuration of sticking polarizer formed of a polyvinyl alcohol (PVA) film on which iodine or dyestuff is adsorbed and oriented, and transparent protective films (protective films for a polarizing plate) on both sides of front and back surfaces of the polarizer.

If the polarizer or the liquid crystal cell receives ultraviolet light, the polarizer or a liquid crystal molecule is decomposed, and display performance is deteriorated. Therefore, methods have been no far proposed in which an ultraviolet absorber is added to a protective film for a polarizing plate to inhibit transmission of the ultraviolet light (for example, see Patent Literature 2 and 3).

### CITATION LIST

### Patent Literatures

Patent Literature 1: JP-A-2009-96974 (“JP-A” means unexamined published Japanese patent application)
Patent Literature 2: JP-A-2008-281680
Patent Literature 3: JP-A-2011-186358

### SUMMARY OF INVENTION

The present invention resides in a resin composition containing a resin, a compound represented by Formula (1) and a compound represented by Formula (TA1); a protective film for a polarizing plate using the resin composition; a polarizing plate using the protective film for a polarizing plate; undo display using the polarizing plate:

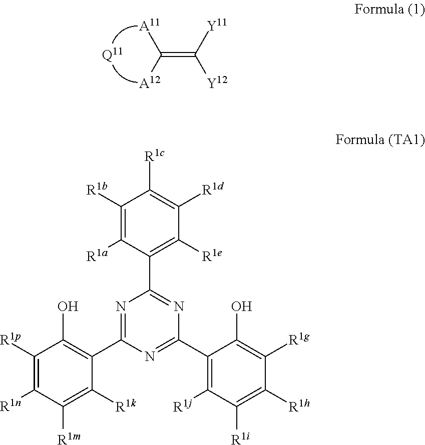

wherein, in Formula (1), A¹¹ and A¹² each independently designate a heteroatom; Y¹¹ and Y¹² each independently designate a hydrogen atom or a substituent; at least one of Y¹¹ and Y¹² is a substituent having the Hammett's substituent constant σp value of 0.2 or more; Y¹¹ and Y¹² may bond to each other to form a ring; and Q¹¹ designates a group of atoms required for forming a 5- or 6-membered ring bonded with A¹¹, A¹² and the carbon atom of >C═; and

wherein, in Formula (TA1), R^{1a} to R^{1e} each independently designate a hydrogen atom or a substituent other than a hydroxy group; when at least one of R^{1a} to R^{1e} is a substituent, at least one of the substituent is a substituent having the Hammett's substituent constant σp value of 0.3 or more; R^{1g} to R^{1j} and R^{1k} to R^{1p} each independently designate a hydrogen atom or a substituent; and among R^{1g} to R^{1j} and R^{1k} to R^{1p}, two substituents adjacent with each other may be bonded to form a ring.

Other and further features and advantages of the invention will appear more fully from the following description, appropriately referring to the accompanying drawing.

### Technical Problem

With regard to an ultraviolet absorber, accordingly as a thickness of a protective film for a polarizing plate decreases, a total amount of the ultraviolet absorber contained in the protective film for a polarizing plate decreases, and ultraviolet absorption capability is reduced according to a decreased amount. Therefore, transmittance of ultraviolet rays in the film increases, and a polarizer is easily deteriorated. Meanwhile, if a concentration of the ultraviolet absorber in the film is increased in order to maintain the ultraviolet absorption capability equivalent to the capability of the protective film for a polarizing plate having a conventional thickness, bleed-out is easily caused, leading to an increment in haze. That is to say, as the protective film for a polarizing plate becomes thinner, it becomes further difficult to satisfy both reduction of the transmittance of ultraviolet rays, and reduction of bleed-out of the ultraviolet absorber.

In addition to the above-described problem, the present inventors have further focused attention on the problems in which durability of the polarizer prepared by immersing an iodine solution into a PVA film tends to be harder in an improvement thereof as the thickness of the polarizing plate is decreased, and if a thin film of cellulose acylate to which the ultraviolet absorber described in the above-described Patent Literature 1 is prepared, absorption of light in a visible region cannot be sufficiently inhibited to cause coloring of the film in several cases, and the transmittance of ultraviolet rays is high, and capability of preventing the ultraviolet rays is insufficient.

The present invention solves the above-described problems, and contemplates for providing a resin composition preferred for film formation, and the resin composition that can form a thin film in which transmittance of ultraviolet rays can be effectively reduced, coloring is hard to be developed, and further an effect of inhibiting the transmittance of ultraviolet rays can be satisfactorily maintained even after the film is continuously irradiated with ultraviolet rays for a long period of time, and bleed-out of an ultraviolet absorber is hard to be caused, and generation of haze can also be inhibited. Further, the present invention contemplates for providing a protective film for a polarizing plate, a polarizing plate, and a display using the resin composition.

### Solution to Problem

The present inventors have found that it is important to inhibit exposure of a polarizer to light having a wavelength near 300 nm and light having a wavelength near 360 to 380 nm in which an iodine complex absorbs the light for durability of the polarizer prepared by immersing an iodine solution into a PVA film, more specifically for prevention of deterioration of polarization performance of the polarizer as caused by ultraviolet light. The present inventors have diligently continued to conduct study. As a result, the present inventors have found that combined use of specific ultraviolet absorbers is effective in improving the durability of the polarizer. The present invention has been completed after the present inventors have further diligently continued to conduct study based on these findings.

According to the present invention, there is provided the following means:
[1] A resin composition, containing:

a resin,

a compound represented by Formula (1), and

a compound represented by Formula (TA1):

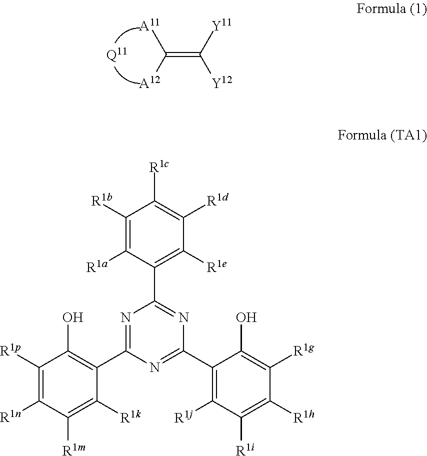

wherein, in Formula (1), A¹¹ and A¹² each independently designate a heteroatom; Y¹¹ and Y¹² each independently designate a hydrogen atom or a substituent; at least one of Y¹¹ and Y¹² is a substituent having the Hammett's substituent constant σp value of 0.2 or more; Y¹¹ and Y¹² may bond to each other to form a ring; and Q¹¹ designates a group of atoms required for forming a 5- or 6-membered ring bonded with A¹¹, A¹² and the carbon atom of >C═; and

wherein, in Formula (TA1), R^{1a} to R^{1e} each independently designate a hydrogen atom or a substituent other than a hydroxy group; when at least one of R^{1a} to R^{1e} is a substituent, at least one of the substituent is a substituent having the Hammett's substituent constant σp value of 0.3 or more; R^{1g} to R^{1j} and R^{1k} to R^{1p} each independently designate a hydrogen atom or a substituent; and among R^{1g} to R^{1j} and R^{1k} to R^{1p}, two substituents adjacent with each other may be bonded to form a ring.
[2] The resin composition described in the item above [1], wherein the compound represented by Formula (1) is a compound represented by Formula (2):

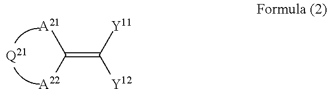

wherein Y¹¹ and Y¹² have the same meaning as the Y¹¹ and Y¹² of Formula (1); A²¹ and A²² each independently designate a heteroatom selected from the group consisting of an oxygen atom, a nitrogen atom, and a sulfur atom; and Q²¹ designates a group of atoms required for forming a 5- or 6-membered ring bonded with A²¹, A²² and the carbon atom of >C═.
[3] The resin composition described in the above item [2], wherein the compound represented by Formula (2) is a compound represented by Formula (3):

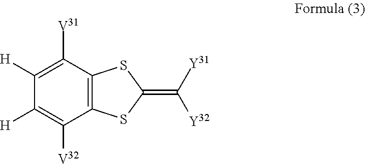

wherein Y³¹ and Y³² each independently designate a substituent; at least one of Y³¹ and Y³² is a cyano group, and the other is a cyano group, an alkylcarbonyl group, an arylcarbonyl group, a heterocyclic carbonyl group, an alkylsulfonyl group, or an arylsulfonyl group; and V³¹ and V³² each independently designate a hydrogen atom or a substituent.
[4] The resin composition described in the above item [3], wherein the compound represented by Formula (3) is a compound represented by Formula (4):

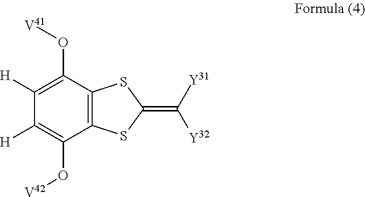

wherein Y³¹ and Y³² have the same meaning as the Y³¹ and Y³² of Formula (3); and V⁴¹ and V⁴² each independently designate an alkyl group, an acyl group, a carbamoyl group, or an alkoxycarbonyl group.
[5] The resin composition described in any one of the above items [1] to [4], wherein the Hammett's substituent constant σp value in Formula (TA1) is 0.3 to 1.2.
[6] The resin composition described in any one of the above items [1] to [5], wherein the substituent satisfying the Hammett's substituent constant σp value defined in Formula (TA1) is a group selected from the group consisting of —COOR^{r}, —CON(R^{s1})(R^{s2}), a cyano group, —CF₃, —NO₂ and —SO₃M; R^{r}, R^{s1} and R^{s2} are each independently a hydrogen atom or a substituent; and M is a hydrogen atom or an alkaline metal.
[7] The resin composition described in any one of the above items [1] to [6], wherein the substituent satisfying the Hammett's substituent constant σp value defined in Formula (TA1) is —COOR^{r} or a cyano group; and R^{r} is a hydrogen atom or a substituent.
[8] The resin composition described in any one of the above items [1] to [7], wherein the substituent satisfying the Hammett's substituent constant σp value defined in Formula (TA1) is R^{1d}.
[9] The resin composition described in any one of the above items [1] to [4], wherein, in Formula (TA1), R^{1a} to R^{1e} each are a hydrogen atom, and R^{1h} and R¹ⁿ each are an alkoxy group.
[10] The resin composition described in any one of the above items [1] to [9], wherein the resin is a cellulose acylate.
[11] A protective film for a polarizing plate, which is formed of the resin composition described in any one of the above items [1] to [10].
[12] A polarizing plate, containing at least one protective film for a polarizing plate described in the above item [11].
[13] A display, containing at least one polarizing plate described in the above item [12].

Note that, in this specification, any numerical expressions in a style of “ . . . to . . . ” will be used to indicate a range including the lower and upper limits represented by the numerals given before and after “to”, respectively.

Herein, in this specification, unless other otherwise specified, a group, which is able to have a substituent (for example, a group having an alkyl moiety, an aryl moiety, or a heterocyclic moiety), may have a substituent. For example, the alkyl group is an alkyl group, which may have a substituent, and the aryl group or the aromatic group is an aryl group or an aromatic group, each of which may have a substituent.

In addition, in the case where any atom has at least two substituents and the case where each of the adjacent bonded atoms has a substituent, these substituents may bond to each other to form a ring.

Moreover, in the case where a plurality of groups represented by the same symbol are present and the case where a plurality of groups represented by the same symbol are present as a result of a plurality of repeatings, these may be the same as or different from each other.

In the present specification, a plurality of substituents or linking groups (hereinafter referred to as substituents or the like) are defined at the same time or alternatively, each of the substituents or the like may be the same or different from one another.

In addition, when a specific group is not identified by simply stating “substituent,” “may have a substituent,” or the like, unless otherwise noted, a group exemplified as the substituent S and its preferable range is referred to. In a similar manner, also in the case of the specific group, unless otherwise noted, a specific group corresponding to that exemplified as the substituent S and its preferable range is referred to.

In addition, ultraviolet rays or ultraviolet light herein is to mean a wavelength of 400 nm or less.

### Advantageous Effects of Invention

With regard to the resin composition of the present invention, a thin film can be formed by using thereof, in which transmittance of ultraviolet rays can be effectively reduced, and coloring is hard to be developed, and further an effect of inhibiting the transmittance of ultraviolet rays can be satisfactorily maintained even after the film is continuously irradiated with the ultraviolet rays for a long period of time, bleed-out of an ultraviolet absorber is hard to be caused, and generation of haze is also inhibited.

The protective film for a polarizing plate of the present invention is formed using the resin composition of the present invention, in which transmittance of ultraviolet rays can effectively inhibited, and coloring is hard to be developed, and further an effect of inhibiting the transmittance of ultraviolet rays can be satisfactorily maintain even after the film is continuously irradiated with the ultraviolet rays for a long period of time, bleed-out of an ultraviolet absorber is hard to be caused, and generation of haze is also inhibited.

The polarizing plate and the display according to the present invention are provided with the protective film for a polarizing plate of the present invention, and are excellent in light resistance.

### BRIEF DESCRIPTION OF DRAWING

FIG. 1 is a schematic diagram showing an outline of a liquid crystal display equipped a polarizing plate into which the protective film for a polarizing plate according to the present invention is assembled.

### DESCRIPTION OF EMBODIMENTS

### <<Resin Composition>>

The resin composition of the present invention is composed of a resin an least two kinds of particular ultraviolet absorbers.

### <Resin>

As the resin used in the protective film for a polarizing plate, a known resin can be used, and is not particularly restricted as long as it is not contrary to the spirit of the present invention. Specific examples of the resin include a cellulose acylate resin, an acryl resin, a cycloolefin resin, and a polyester resin. Among these resins, in the present invention, from a viewpoint of excellent compatibility with the compound represented by Formula (1) and the compound represented by Formula (TA1) as described later, a cellulose acylate resin is preferred.

One kind of these resins may be used, or two or more kinds thereof may be used in combination. When two or more kinds are used, a component contained in the highest amount in the resin components is taken as a main component.

### (Cellulose Acylate)

In the present invention, cellulose acylate is used as a main component of the cellulose acylate film. One kind of cellulose acylate may be used, or alternatively two or more kinds thereof may be used. For example, the cellulose acylate may be a cellulose acylate having only an acetyl group as the acyl substituent thereof; a cellulose acylate having a plurality of different acyl substituents as the acyl substituent thereof may be used. Alternatively, the cellulose acylate may be a mixture of cellulose acylates that are different from one another. In addition, the main component means one in which cellulose acylate is contained in 50% by mass or more in the resin components constituting the film or the layer, and the content of cellulose acylate in the resin components is preferably 60% by mass or more, and further preferably 80% by mass or more.

The cellulose material for cellulose acylate which is used in this invention includes cotton liter and wood pulp (hardwood pulp, softwood pulp), and cellulose acylate obtained from any such cellulose material are usable herein. Those cellulose materials may be mixed for use herein. The cellulose materials are described in detail, for example, by Marusawa & Uda's in “Plastic Material Lecture (17), Cellulose Resin” by Nikkan Kogyo Shinbun (1970) and Hatsumei Kyokai's Disclosure Bulletin 2001-1745 (pp. 7-8), and those celluloses described therein may be usable herein.

In the present specification, the acyl group of the cellulose acylate may be one kind, or two or more kinds of acyl groups. It is preferable that the cellulose acylate used in the present invention has an acyl group having 2 or greater carbon atoms as a substituent. The acyl group having 2 or greater carbon atoms is not particularly limited such that it may be an aliphatic acyl group or an aromatic acyl group. Examples thereof include cellulosic alkylcarbonyl groups, alkenylcarbonyl groups, aromatic carbonyl groups, and aromatic alkylcarbonyl groups, each of which may have a substituted group. Preferable examples thereof include acetyl, propionyl, butanoyl, heptanoyl, hexanoyl, octanoyl, decanoyl, dodecanoyl, tridecanoyl, tetradecanoyl, hexadecanoyl, octadecanoyl, isobutanoyl, tert-butanoyl, cyclohexane carbonyl, oleoyl, benzoyl, naphthyl carbonyl, and cinnamoyl. Among these, acetyl, propionyl, butanoyl, decanoyl, octadecanoyl, tert-butanoyl, oleoyl, benzoyl, naphthyl carbonyl, and cinnamoyl are more preferred. Further, acetyl, propionyl and butanoyl are preferred.

It is preferable that the cellulose acylate used in the present invention has an acyl group having 2 to 4 carbon atoms as a substituent. When two or more kinds of acyl groups are used, it is preferable that one kind of the acyl groups is an acetyl group, and another kind of the acyl group having 2 to 4 carbon atoms is preferably a propionyl group or a butyryl group. By use of these cellulose acylates, solution with a good solubility can be prepared. Especially in non-chlorine organic solvent, preparation of good solution becomes possible. Further, preparation of solution having a low viscosity and a good filterability becomes possible.

In the present invention, particularly, a cellulose acylate having one acetyl group as the acyl group is preferably used.

Hereinafter, cellulose acylate preferably used in the present invention is described in detail.

The glucose unit having a β-1,4 bond, which constitutes the cellulose, has free hydroxy groups at the 2-, 3-, and 6-positions thereof. The cellulose acylate is polymer in which a part of or all of these hydroxy groups is or are acylated.

The acyl substitution degree indicates a degree of acylation of the hydroxy groups located at the 2-, 3-, and 6-positions of the cellulose. When each of the hydroxy groups at the 2-, 3-, and 6-positions of all of the glucose units is acylated, the total acyl substitution degree is 3. For example, when each of the hydroxy groups only at the 6-position of all of the glucose units is acylated, the total acyl substitution degree is 1. In the same manner, when each of the hydroxy groups at either the 6-position or the 2-position of all of the glucose unit is acylated, the total acyl substitution degree is 1.

That is to say, the acyl substitution degree indicates a degree of acylation, provided that when all of the hydroxy groups of the glucose molecule are entirely acylated, the acyl substitution degree is 3.

As the details of the method of measuring the acyl substitution degree, measurement can be performed according to the method described in Tezuka et al., Carbohydrate. Res., vol. 273, p. 83-91 (1995) or in accordance with the method specified in ASTM-D817-96.

When the total acyl substitution degree of the cellulose acylate used in the present invention is taken as A, A is preferably 1.5 or more and 3.0 or less (1.5≦A≦3.0). In the present invention, A is more preferably 2.80 to 2.97 in view of compatibility with the compound represented by Formula (1) and the compound represented by Formula (TA1), and haze reduction.

Moreover, in cellulose acetate in which only the acetyl group is used as the acyl group of the cellulose acylate, when the total acetyl substitution degree is taken as B, B is preferably 2.0 or more and 3 or less (2.0≦B≦3.0). In the present invention, B is more preferably 2.80 to 2.97 in view of compatibility with the compound represented by Formula (1) and the compound represented by Formula (TA1), and haze reduction.

In the case where an acid anhydride or an acid chloride is used as an acylating agent in acylation of the cellulose, methylene chloride or an organic acid, for example, acetic acid and the like, is used as an organic solvent which acts as a reaction solvent.

As for the catalyst, when the acylating agent is an acid anhydride, a protic catalyst, such as sulfuric acid, is preferably used. While, when the acylating agent is an acid chloride (for example, CH₃CH₂COCl), a basic compound is used.

A most common industrial method for the synthesis of a mixed fatty acid ester of cellulose, is a method of acylating cellulose with a mixed organic acid component that includes fatty acids corresponding to an acetyl group and to any other acyl group (acetic acid, propionic acid, valeric acid, and the like) or their acid anhydrides.

The cellulose acylate may be produced, for example, according to the method described in JP-A-10-45804.

The resin composition of the present invention contains the cellulose acylate of preferably from 5% to 99% by mass, more preferably from 20% to 99% by mass, and particularly preferably from 50% to 95% by mass, with respect to the total solid content of the resin composition, from the viewpoint of water-vapor transmission ratio.

### <Ultraviolet Absorber>

The resin composition according to the present invention contains a compound represented by Formula (1) and a compound represented by Formula (TA1).

First, the compound represented by Formula (1) is described.

### (Compound Represented by Formula (1))

The resin composition according to the present invention contains a compound represented by Formula (1).

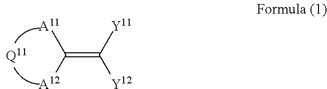

In Formula (1), A¹¹ and A¹² each independently designate a heteroatom. Y¹¹ and Y¹² each independently designate a hydrogen atom or a substituent, and at least one of Y¹¹ and Y¹² is a substituent having the Hammett's substituent constant σp value of 0.2 or more. Further, Y¹¹ and Y¹² may bond to each other to form a ring. Q¹¹ designates a group of atoms required for forming a 5- or 6-membered ring bonded with A¹¹, A¹² and the carbon atom of >C═. The ring formed by Q¹¹ may be condensed with a benzene ring.

Examples of A¹¹ and A¹² include an oxygen atom, a nitrogen atom, a sulfur atom, a boron atom, a silicon atom, a phosphorus atom, a selenium atom, and a tellurium atom. A¹¹ and A¹² each are preferably a nitrogen atom, an oxygen atom, or a sulfur atom; more preferably a nitrogen atom or a sulfur atom; and particularly preferably a sulfur atom.

When Y¹¹ and Y¹² each are a substituent, examples of such a substituent include those exemplified as the substituent S.

At least one of Y¹¹ and Y¹² is a substituent having the Hammett's substituent constant σp value of 0.2 or more. When the Hammett's substituent constant σp value of at least one of Y¹¹ and Y¹² is 0.2 or more, the compound represented by Formula (1) can be easily synthesized by using, as raw materials, a compound having a ring structure including A¹¹, A¹² and Q¹¹, and a compound including Y¹¹ and Y¹².

In addition, both Y¹¹ and Y¹² each are further preferably a substituent having the Hammett's substituent constant σp value of 0.2 or more.

Hammett's σp value is described in, for example, C. Harsch et al, J. Med. Chem., vol. 16, p. 1207 (1973); C. Harsch et al, J. Med. Chem., vol. 20, p. 304 (1977); and Chem. Rev., vol. 91, p. 165 (1991).

Examples of the substituent having the Hammett's substituent constant σp value of 0.2 or more include a halogen atom such as chlorine (0.30), bromine (0.27), and iodine (0.30); a group having carbonyl such as —CHO (0.22), —COCH₃ (0.50), —COC₆H₅ (0.46), —CONH₂ (0.36), —COO⁻ (0.30), —COOH (0.41), —COOCH₃ (0.39), —COOC₂H₅ (0.45), and —CONHCH₃ (0.32); a group having sulfonyl or sulfinyl such as —SOCH₃ (0.49), —SO₂CH₃ (0.72), —SO₂C₆H₅ (0.68), —SO₂CF₃ (0.93), —SO₂NH₂ (0.57), —SO₂N(CH₃)₂ (0.65), —SO₂OC₆H₅ (0.23), and —SO₃H (0.50); a nitrogen-containing group such as —CN (0.66), —NO₂ (0.78), and —N(CF₃)₂ (0.53); and a halogen atom-substituted alkyl group such as —CCl₃ (0.46), —CH₂Cl (0.18), —CHCl₂ (0.32), and —CF₃ (0.54). Herein, a value within a parenthesis represents the σp value.

The substituent having the Hammett's substituent constant σp value of 0.2 or more that is adoptable as Y¹¹ and Y¹² is preferably a group selected from the group consisting of a cyano group, an alkylcarbonyl group, an arylcarbonyl group, a heterocyclic carbonyl group, an alkylsulfonyl group, an arylsulfonyl group, an alkoxycarbonyl group, an aryloxycarbonyl group, a carbamoyl group, a sulfamoyl group and a carboxy group, and further preferably a group selected from the group consisting of a cyano group, an alkylcarbonyl group, an arylcarbonyl group, a heterocyclic carbonyl group, an alkylsulfonyl group and an arylsulfonyl group. At least one of Y¹¹ and Y¹² is still further preferably a cyano group.

The number of carbon atoms in the alkylcarbonyl group that is adoptable as Y¹¹ and Y¹² is preferably 2 to 20, and more preferably 2 to 12. Specific examples include acetyl, propionyl, butyryl, isobutyryl, valeryl, isovaleryl, pivaloyl, and lauroyl.

The number of carbon atoms in the arylcarbonyl group that is adoptable as Y¹¹ and Y¹² is preferably 7 to 20, and more preferably 7 to 12. Specific examples include benzoyl and naphthoyl.

The number of carbon atoms in the heterocyclic carbonyl group that is adoptable as Y¹¹ and Y¹² is preferably 1 to 20, more preferably 1 to 12, and further preferably 2 to 10. The hetero ring in the heterocyclic carbonyl group is preferably a ring in which a ring-constituting heteroatom is selected from the group consisting of an oxygen atom, a nitrogen atom and a sulfur atom, and is preferably a 5- or 6-membered ring. The hetero ring is more preferably an aromatic hetero ring. Specific examples include a furan ring, a thiophene ring, a pyrrole ring, a pyrazole ring, an imidazole ring, an oxazole ring, a thiazole ring, and a pyridine ring.

The number of carbon atoms in the alkylsulfonyl group that is adoptable as Y¹¹ and Y¹² is preferably 1 to 20, and more preferably 1 to 12. Specific examples include methylsulfonyl, ethylsulfonyl, isopropylsulfonyl, butylsulfonyl, octylsulfonyl, and 2-ethylhexylsulfonyl.

The number of carbon atoms in the arylsulfonyl group is preferably 6 to 20, and more preferably 6 to 12. Specific examples include phenylsulfonyl and naphtylsulfonyl.

The number of carbon atoms in the alkoxycarbonyl group that is adoptable as Y¹¹ and Y¹² is preferably 2 to 20, and more preferably 2 to 12. Specific examples include methoxycarbonyl, ethoxycarbonyl, propoxycarbonyl, butoxycarbonyl, and 2-ethylhexyloxycarbonyl.

The number of carbon atoms in the aryloxycarbonyl group that is adoptable as Y¹¹ and Y¹² is preferably 7 to 20, and more preferably 7 to 12. Specific examples include phenoxycarbonyl and naphthoxycarbonyl.

The number of carbon atoms in the carbamoyl group that is adoptable as Y¹¹ and Y¹² is preferably 2 to 20, and more preferably 2 to 12. Specific examples include carbamoyl, N-methylcarbamoyl, N-isopropylcarbamoyl, N,N-dimethylcarbamoyl, N-(2-ethylhexyl)carbamoyl, N-phenylcarbamoyl, and N-methyl-N-phenylcarbamoyl.

The number of carbon atoms in the sulfamoyl group that is adoptable as Y¹¹ and Y¹² is preferably 1 to 20, and more preferably 1 to 12. Specific examples include sulfamoyl, N-methylsulfamoyl, N-isopropylsulfamoyl, N,N-dimethylsulfamoyl, N-(2-ethylhexyl)sulfamoyl, N-phenylsulfamoyl, and N-methyl-N-phenylsulfamoyl.

Each group of them may have a substituent. Examples of such a substituent include those exemplified as the following substituent S.

Both of Y and Y are preferably a substituent, and preferably a substituent having the Hammett's substituent constant σp value of 0.2 or more.

Y¹¹ and Y¹² may be bonded to each other to form a ring. Examples of such a ring are preferably a 5- or 6-membered ring, and more preferably a 6-membered ring.

Q¹¹ designates a group of atoms required for forming a 5- or 6-membered ring bonded with A¹¹, A¹² and the carbon atom of >C═. The ring formed by Q¹¹ may be condensed with a benzene ring. In the case of a form of being fused with a benzene ring, A¹¹ and A¹² are preferably bonded in positions serving as ortho positions of the benzene rings with each other.

The formed ring may a substituent. Examples of such a substituent include those exemplified as the following substituent S. Among them, an alkoxy group, an acyloxy group, a carbamoyloxy group, and an alkoxycarbonyloxy group are preferable.

The compound represented by Formula (1) is preferably a compound represented by Formula (2), more preferably a compound represented by Formula (3), and further preferably a compound represented by Formula (4).

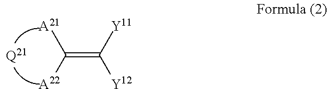

In Formula (2), Y¹¹ and Y¹² have the sane meaning Y¹¹ and Y¹² of Formula (1). A²¹ and A²² each independently designate a heteroatom selected from the group consisting of an oxygen atom, a nitrogen atom, and a sulfur atom. Q²¹ designates a group of atoms required for forming a 5- or 6-membered ring bonded with A²¹, A²² and the carbon atom of >C═. The ring formed by Q¹¹ may be condensed with a benzene ring. In the case of a form of being fused with a benzene ring, A¹¹ and A¹² are preferably bonded in positions serving as ortho positions of the benzene rings with each other.

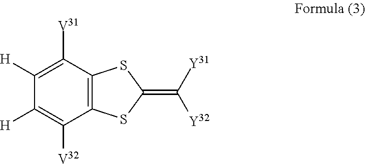

In Formula (3), Y³¹ and Y³² each independently designate a substituent; and at least one of Y³¹ and Y³² is a cyano group, and the other is a cyano group, an alkylcarbonyl group, an arylcarbonyl group, a heterocyclic carbonyl group, an alkylsulfonyl group, or an arylsulfonyl group. V³¹ and V³² each independently designate a hydrogen atom or a substituent. Examples of the substituent designated by V³¹ and V³² include those exemplified as the substituent S.

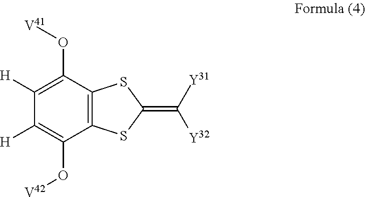

In Formula (4), Y³¹ and Y³² have the same meaning as the Y³¹ and Y³² of Formula (3). V⁴¹ and V⁴² each independently represent an alkyl group, an acyl group, a carbamoyl group, or an alkoxycarbonyl group.

The alkyl group of V⁴¹ and V⁴² in Formula (4) has preferably from 1 to 20 carbon atoms, and more preferably from 1 to 12 carbon atoms. Specific examples include methyl, ethyl, propyl, isopropyl, butyl, tert-butyl, octyl, 2-ethylhexyl, dodecyl, and hexadecyl.

The acyl group of V⁴¹ and V⁴² in Formula (4) includes an alkylcarbonyl group, an arylcarbonyl group and a heterocyclic carbonyl group, and has the same meaning with the alkylcarbonyl group, the arylcarbonyl group and the heterocyclic carbonyl group as described in Y¹¹ and Y¹², and a preferred range is also same.

The carbamoyl group and the alkoxycarbonyl group of V⁴¹ and V⁴² in Formula (4) have the same meaning with the carbamoyl group and the alkoxycarbonyl group as described in Y¹¹ and Y¹², and a preferred range is also same.

Each group of V⁴¹ and V⁴² may have a substituent. Examples of such a substituent include those exemplified as the following substituent S.

In particular, when V⁴¹ and V⁴² are an alkyl group, the substituent for substituting the alkyl group is preferably an alkoxy group.

Specific examples of the compound represented by Formula (1) for use in the present invention are shown below, but the present invention is not limited to these.

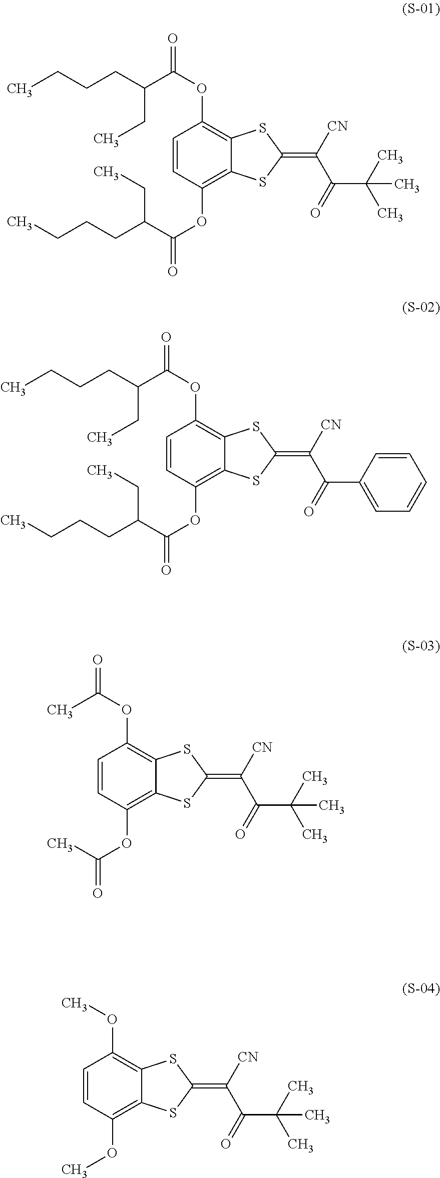

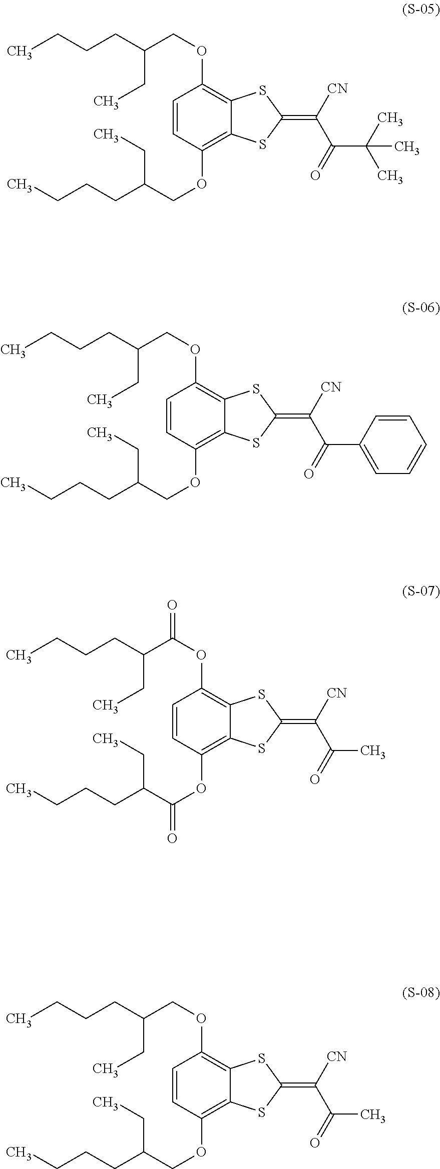

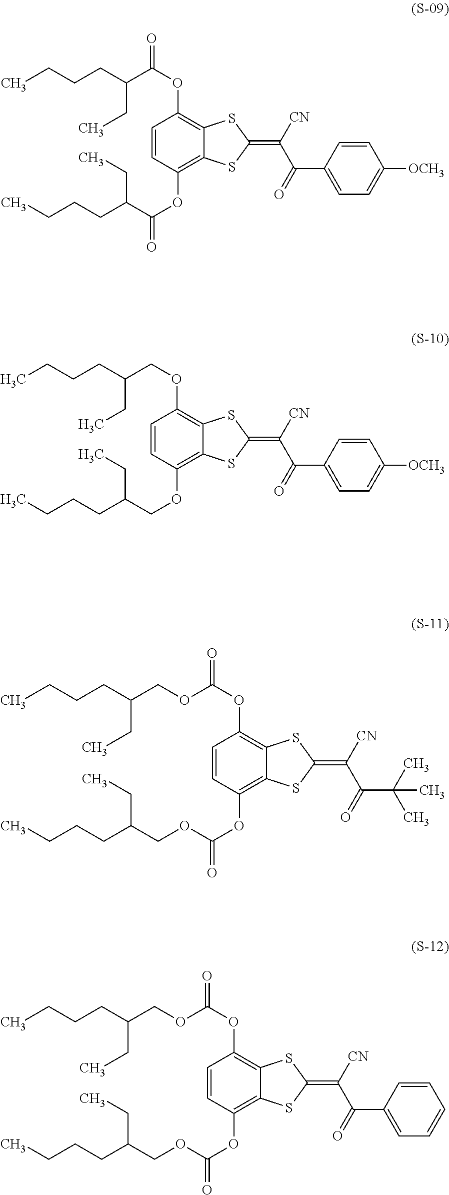

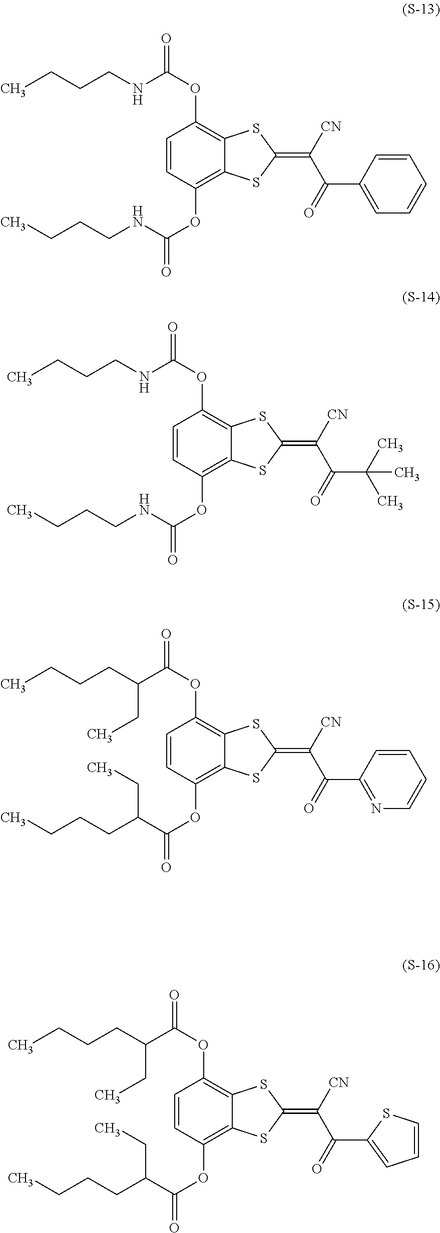

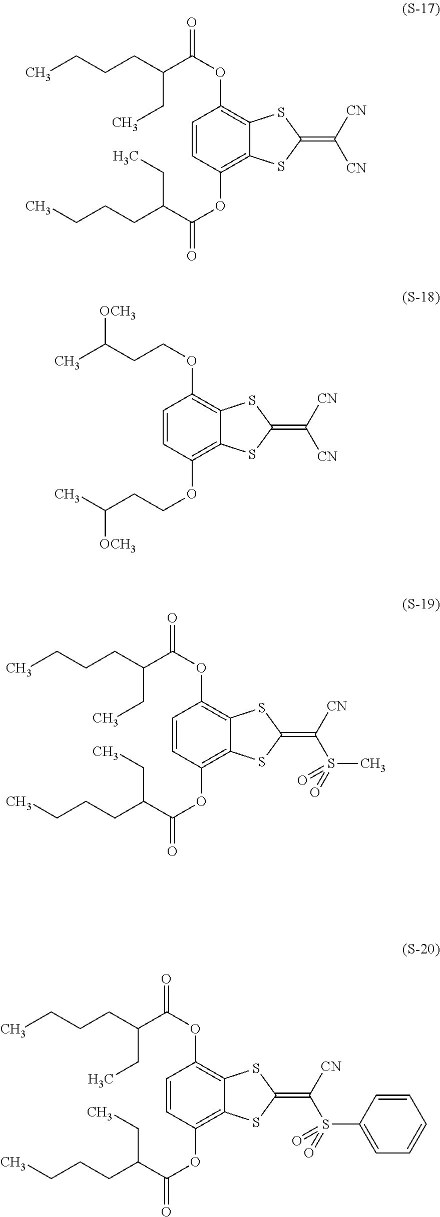

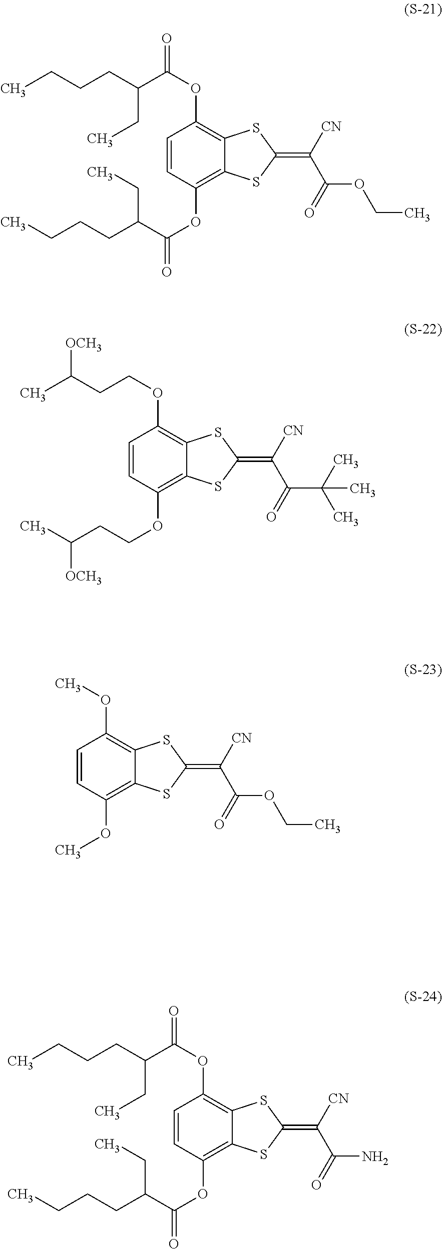

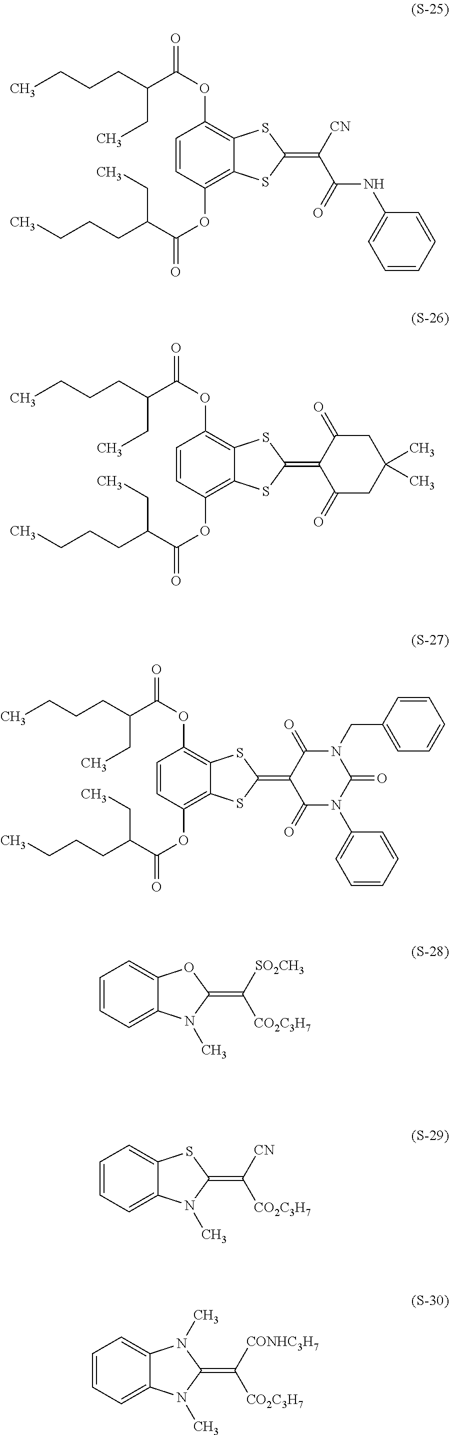

In the resin composition of the present invention, the content of the compound represented by Formula (1) is preferably 0.1 to 5 mass parts with respect to 100 mass parts of the resin content.

When a protective film for a polarizing plate is prepared using the resin composition according to the present invention, ultraviolet rays (particularly, near 380 nm) in a wavelength range in which an iodine complex in the polarizer absorbs the rays can be effectively shielded without adversely affecting transparency at a wavelength in a visible region by adjusting the content of the compound represented by Formula (1) in the resin composition to the above-described preferred range.

In the resin composition of the present invention, the content of the compound represented by Formula (1) is more preferably 0.2 to 4 mass parts, further preferably 0.5 to 3.5 mass parts, further preferably 0.5 to 2.5 mass parts, and further preferably 0.5 to 2 mass parts, with respect to 100 mass parts of the resin content.

### (Compound Represented by Formula (TA1))

The resin composition of the present invention contains a compound represented by Formula (TA1) along with the compound represented by Formula (1).

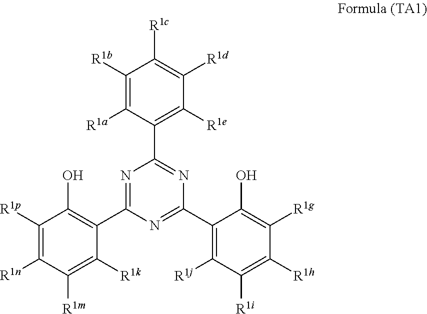

In Formula (TA1), R^{1a} to R^{1e} each independently represent a hydrogen atom or a substituent other than a hydroxy group; and when at least one of R^{1a} to R^{1e} is a substituent, at least one of the substituent is a substituent having the Hammett's substituent constant σp value of 0.3 or more. R^{1g} to R^{1j} and R^{1k} to R^{1p} each independently represent a hydrogen atom or a substituent. Further, among R^{1g} to R^{1j} and R^{1k} to R^{1p}, two substituents adjacent with each other may be bonded to form a ring.

Specific examples of the substituent other than the hydroxy group in R^{1a} to R^{1e} include the substituent other than the hydroxy group among those exemplified as the following substituent S.

In the present invention, when at least one of R^{1a} to R^{1e} is a substituent, at least one of the substituent is a substituent having the Hammett's substituent constant σp value of 0.3 or more.

The Hammett's substituent constant σp value is preferably 0.3 to 1.2.

Specific examples of the substituent having the Hammett's substituent constant σp value of 0.3 or more include a substituent group having the Hammett's substituent constant σp value of 0.3 or more among the substituents having the Hammett's substituent constant σp value of 0.2 or more as exemplified in Y¹¹ and Y¹² in Formula (1). When at least one of substituents among R^{1a} to R^{1e} having the Hammett's substituent constant σp value is 0.3 or more, LUMO is stabilized by an electron withdrawing group, excited lifetime is shortened, and light resistance is improved, and therefore such a case is preferred.

Specific examples include a halogen atom such as chlorine (0.30) and iodine (0.30); a group having carbonyl such as —COCH₃ (0.50), —COC₆H₅ (0.46), —CONH₂ (0.36), —COO⁻ (0.30), —COOH (0.41), —COOCH₃ (0.39), —COOC₂H₅ (0.45), and —CONHCH₃ (0.32); a group having sulfonyl or sulfinyl such as —SOCH₃ (0.49), —SO₂CH3 (0.72), —SO₂C₆H₅ (0.68), —SO₂CF₃ (0.93), —SO₂NH₂ (0.57), —SO₂N(CH₃)₂ (0.65), and —SO₃H (0.50); a nitrogen-containing group such as —CN (0.66), —NO₂ (0.78), and —N(CF₃)₂ (0.53); and a halogen atom-substituted alkyl group such as —CCl₃ (0.46), —CHCl₂ (0.32), and —CF₃ (0.54). Herein, a value within a parenthesis represents the σp value.

Among these, the substituent having the Hammett's substituent constant σp value of 0.3 or more that is adoptable as R^{1a} to R^{1e} is preferably an acyl group, an alkoxycarbonyl group, a carbamoyl group, an alkylsulfonyl group, an arylsulfonyl group, a cyano group, a nitro group, a sulfo group, or a halogen atom-substituted alkyl group.

The acyl group that is adoptable as R^{1a} to R^{1e} includes an alkylcarbonyl group, arylcarbonyl group and a heterocyclic carbonyl group, and each thereof has the same meaning with the alkylcarbonyl group, the arylcarbonyl group and the heterocyclic carbonyl group as described in Y¹¹ and Y¹² in Formula (1), and a preferred range is also same.

The alkoxycarbonyl group, the carbamoyl group, the alkyl sulfonyl group and the arylsulfonyl group those are adoptable as R^{1a} to R^{1e}, each thereof has the same meaning with the alkoxycarbonyl group, the carbamoyl group, the alkyl sulfonyl group and the arylsulfonyl group as described in Y¹¹ and Y¹² in Formula (1), respectively, and preferred ranges thereof are also same.

The sulfo group is preferably a group represented by —SO₃M. Herein, M is a hydrogen atom or an alkaline metal. Among the alkaline metals, potassium and sodium are preferred.

The halogen atom in the halogen atom-substituted alkyl group is preferably a chlorine atom or a fluorine atom, and more preferably a fluorine atom.

The halogen atom-substituted alkyl group is preferably a perchloroalkyl group or a perfluoroalkyl group, more preferably a perfluoroalkyl group, and further preferably a perfluoromethyl group (—CF₃).

The substituent having the Hammett's substituent constant σp value of 0.3 or more that is adoptable as R^{1a} to R^{1e} is further preferably a group selected from the group consisting of —COOR^{r}, —CON(R^{s1})(R^{s2}), a cyano group, —CF₃, —NO₂, and —SO₃M; and particularly preferably —COOR^{r} or a cyano group. Herein, R^{r}, R^{s1}, and R^{s2} each independently designate a hydrogen atom or a substituent.

Examples of the substituent that is adoptable as R^{r}, R^{s1}, and R^{s2} include those exemplified as the substituent S. Among these, an alkyl group or an aryl group is preferred.

The substituent satisfying the Hammett's substituent constant σp value of 0.3 or more may be any of R^{1a} to R^{1e}, and may be plural (2 to 5 substituents). Above all, one or two of R^{1a} to R^{1e} is preferably, and one of R^{1a} to R^{1e} is further preferably a substituent satisfying the Hammett's substituent constant σp value of 0.3 or more.

In the present invention, R^{1d} is preferably the substituent satisfying the Hammett's substituent constant σp value of 0.3 or more.

When any of R^{1a} to R^{1e} is a substituent having the Hammett's substituent constant σp value less than 0.3, they each are preferably an alkyl group, an alkoxy group, an aryloxy group, an alkylthio group, an arylthio group, an amino group, an acylamino group or a halogen atom. A preferred form of each group thereof is identical with a preferred form in a corresponding group exemplified as the following substituent S.

R^{1g} to R^{1j} and R^{1k} to R^{1p} each independently designate a hydrogen atom or a substituent. Examples of the substituent include those exemplified as the following substituent S.

R^{1g} to R^{1j} and R^{1k} to R^{1p} each are preferably a hydrogen atom, an alkyl group, an aryl group, at alkoxy group, an aryloxy group, an alkylthio group, an arylthio group, an amino group, an acylamino group, a halogen atom, an acyl group, an alkoxycarbonyl group, a carbamoyl group, an alkylsulfonyl group, an arylsulfonyl group, a cyano group, a nitro group or a hydroxy group. A preferred form of each group thereof is identical with the preferred form in the corresponding group exemplified as the following substituent S.

In the present invention, among R^{1g} to R^{1j} and R^{1k} to R^{1p}, the case where at least one of R^{1h} and R¹ⁿ is an alkoxy group is preferred, and the case where both of R^{1h} and R¹ⁿ are an alkoxy group is further preferred.

In this case, a group other than the above-described alkoxy group among R^{1g} to R^{1j} and R^{1k} to R^{1p} is further preferably a hydrogen atom.

Among R^{1g} to R^{1j} and R^{1k} to R^{1p}, two substituents adjacent with each other may be bonded to form a ring. Such a rang is preferably a 5- or 6-membered ring. The ring may be a carbocyclic ring or a hetero ring, but a carbocyclic ring is preferred, and a benzene ring is particularly preferred.

Specific examples of the compound represented by Formula (TA1) for use in the present invention are shown below, but the present invention is not limited to these.

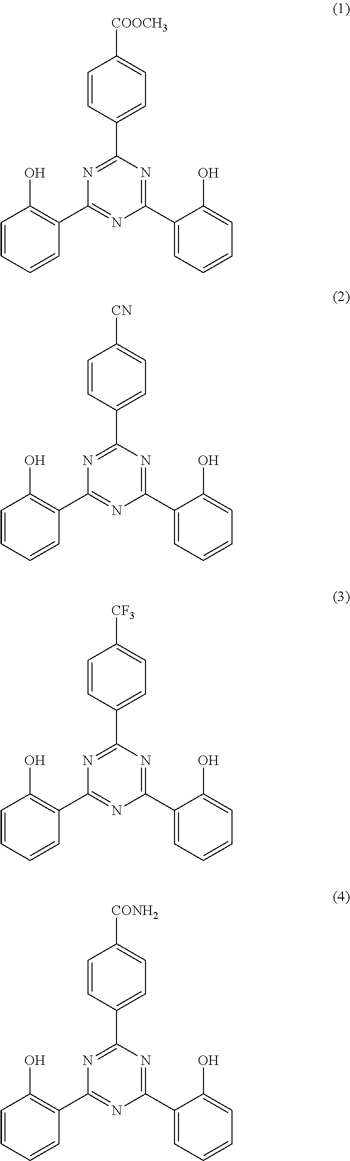 [SMILES: COC(=O)c1ccc(-c2nc(-c3ccccc3O)nc(-c3ccccc3O)n2)cc1 ; N#Cc1ccc(-c2nc(-c3ccccc3O)nc(-c3ccccc3O)n2)cc1 ; Oc1ccccc1-c1nc(-c2ccc(C(F)(F)F)cc2)nc(-c2ccccc2O)n1 ; NC(=O)c1ccc(-c2nc(-c3ccccc3O)nc(-c3ccccc3O)n2)cc1]

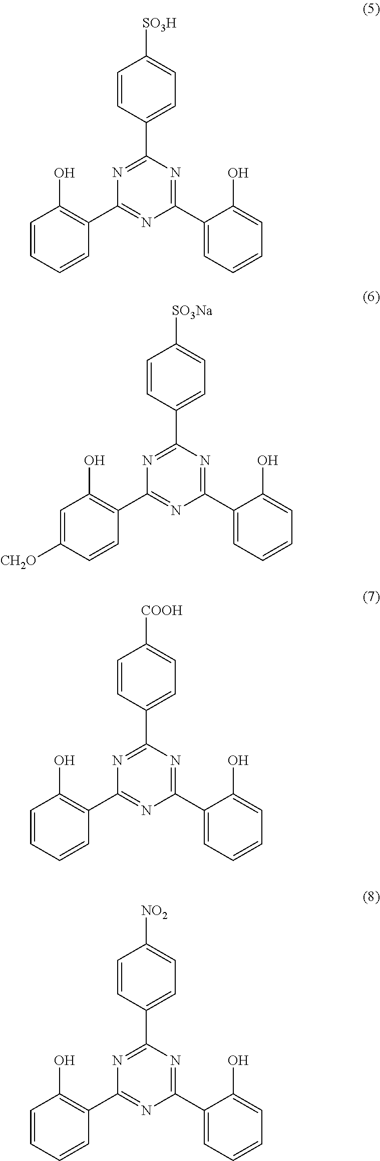

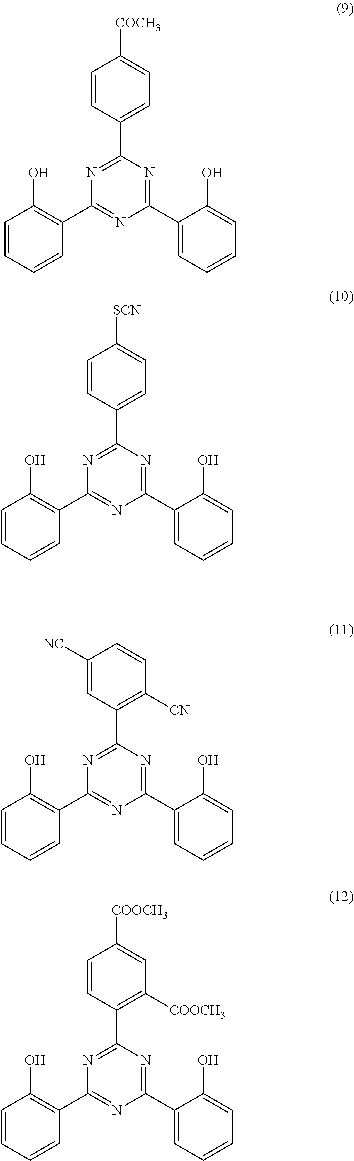

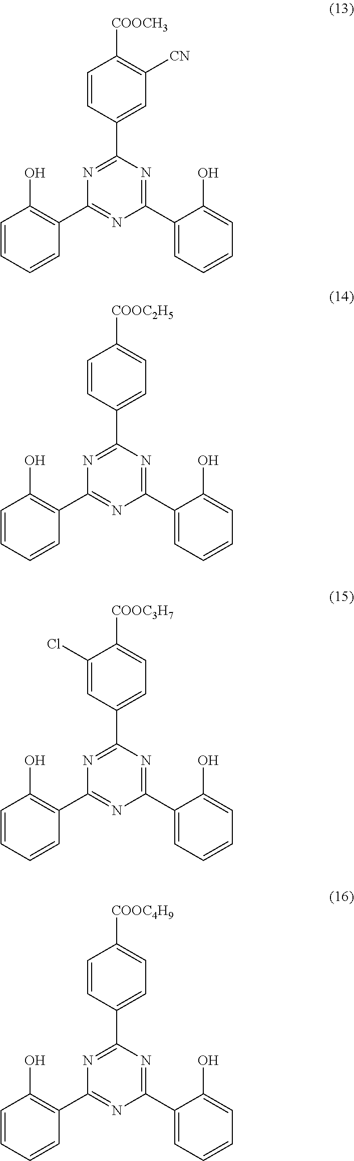

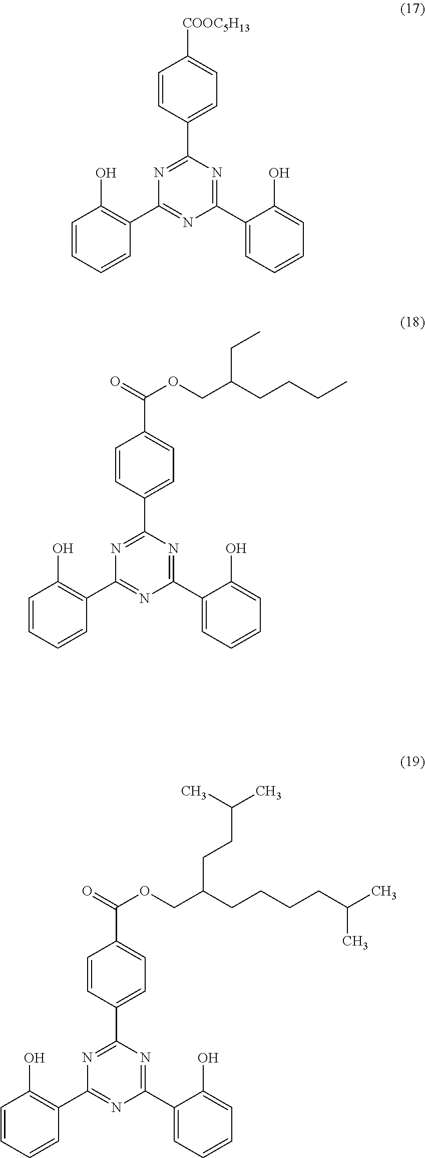

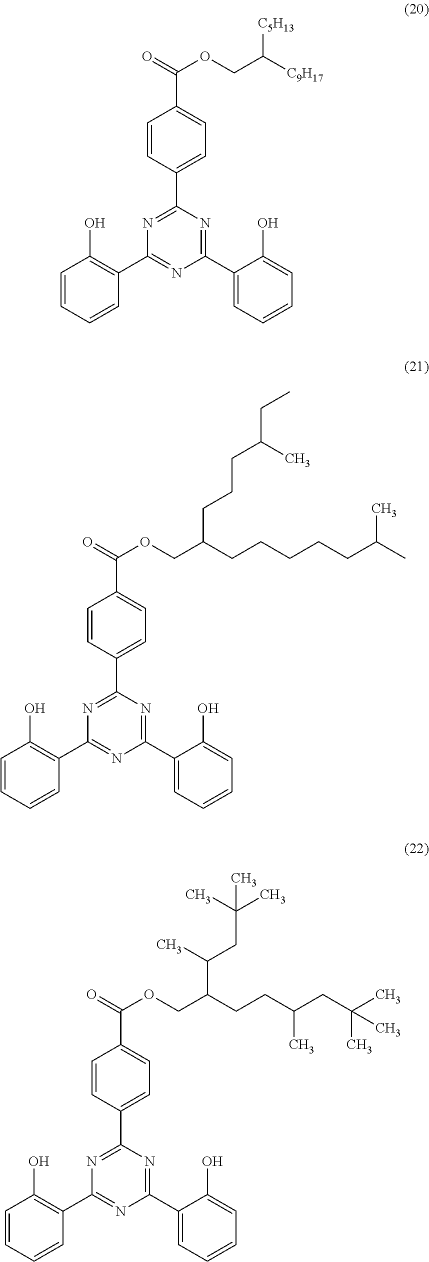

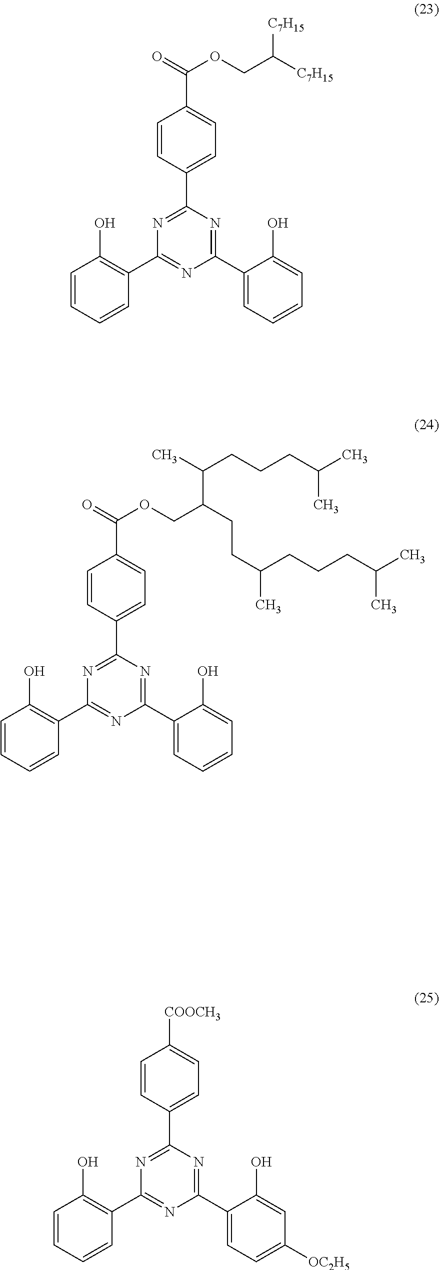

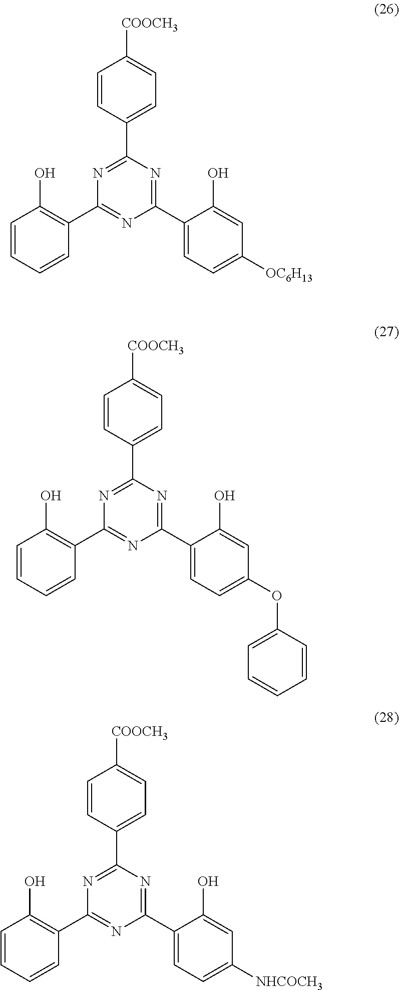

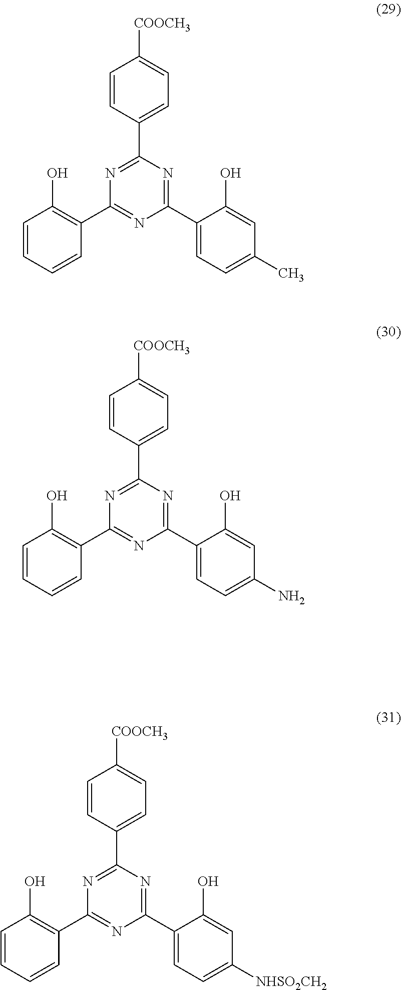

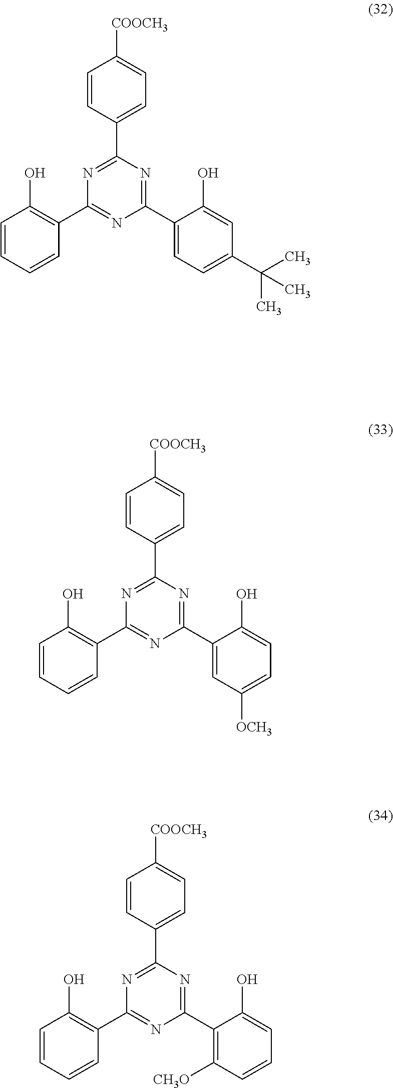

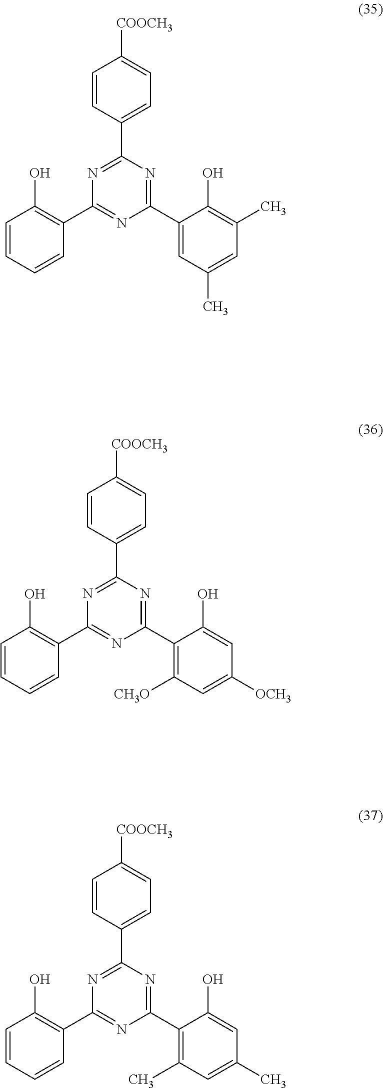

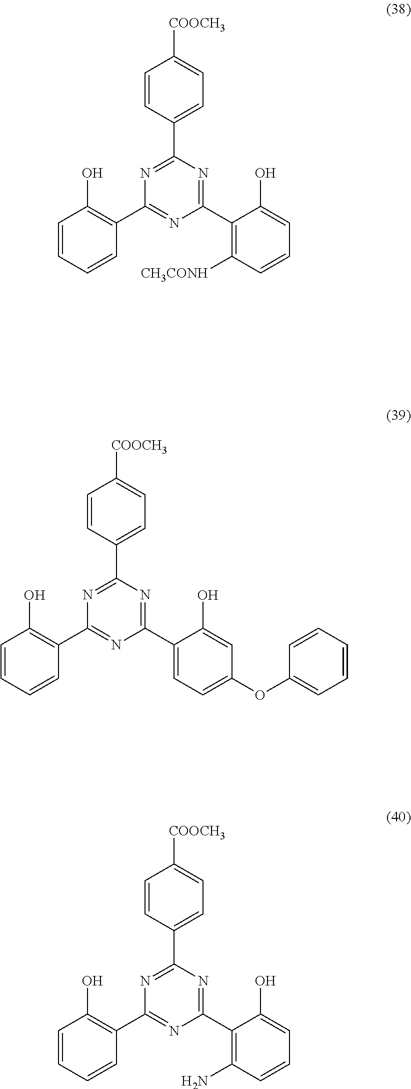

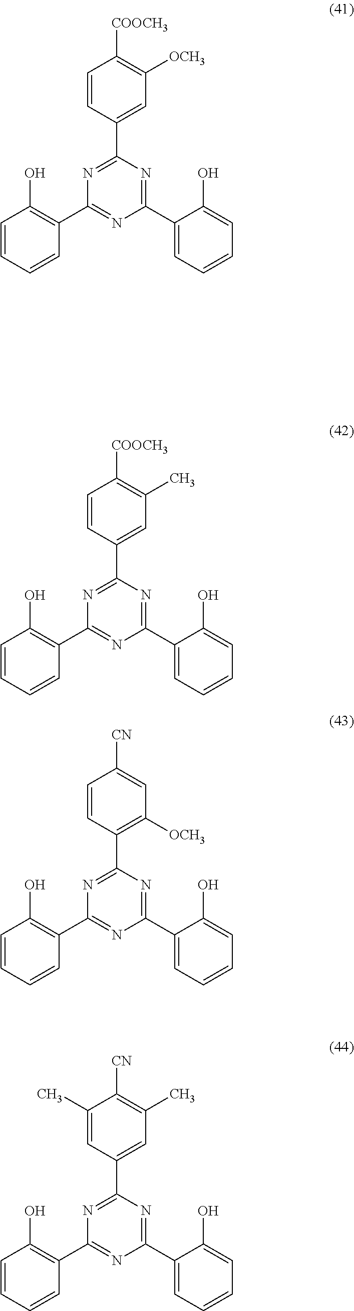 [SMILES: COC(=O)c1ccc(-c2nc(-c3ccccc3O)nc(-c3ccccc3O)n2)cc1OC ; COC(=O)c1ccc(-c2nc(-c3ccccc3O)nc(-c3ccccc3O)n2)cc1C ; COc1cc(C#N)ccc1-c1nc(-c2ccccc2O)nc(-c2ccccc2O)n1 ; Cc1cc(-c2nc(-c3ccccc3O)nc(-c3ccccc3O)n2)cc(C)c1C#N]

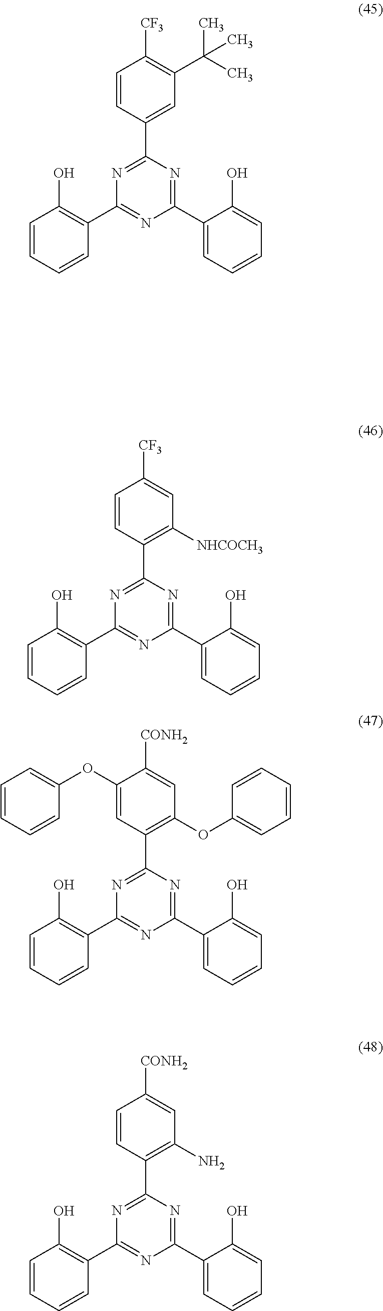

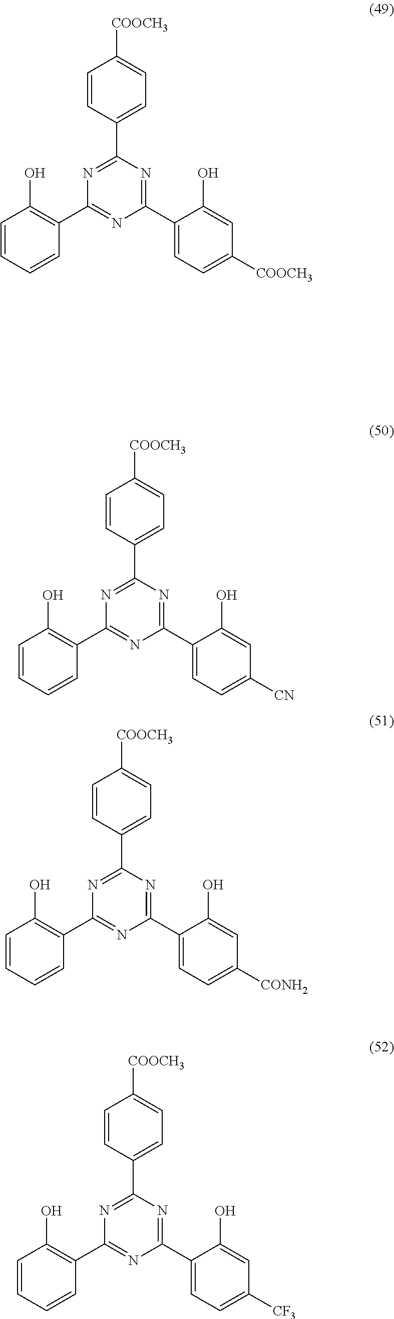 [SMILES: COC(=O)c1ccc(-c2nc(-c3ccccc3O)nc(-c3ccc(C(=O)OC)cc3O)n2)cc1 ; COC(=O)c1ccc(-c2nc(-c3ccccc3O)nc(-c3ccc(C#N)cc3O)n2)cc1 ; COC(=O)c1ccc(-c2nc(-c3ccccc3O)nc(-c3ccc(C(N)=O)cc3O)n2)cc1 ; COC(=O)c1ccc(-c2nc(-c3ccccc3O)nc(-c3ccc(C(F)(F)F)cc3O)n2)cc1]

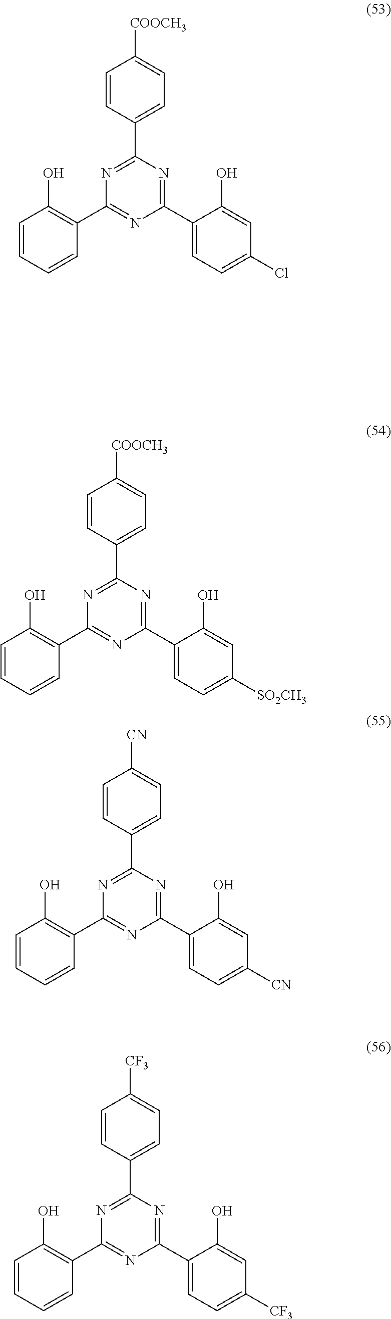 [SMILES: COC(=O)c1ccc(-c2nc(-c3ccccc3O)nc(-c3ccc(Cl)cc3O)n2)cc1 ; COC(=O)c1ccc(-c2nc(-c3ccccc3O)nc(-c3ccc(S(C)(=O)=O)cc3O)n2)cc1 ; N#Cc1ccc(-c2nc(-c3ccccc3O)nc(-c3ccc(C#N)cc3O)n2)cc1 ; Oc1ccccc1-c1nc(-c2ccc(C(F)(F)F)cc2)nc(-c2ccc(C(F)(F)F)cc2O)n1]

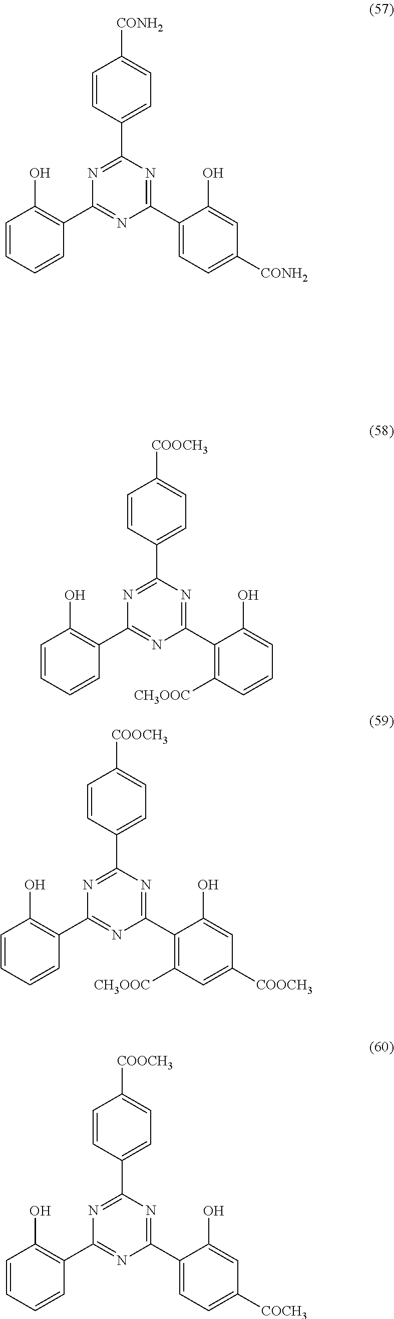

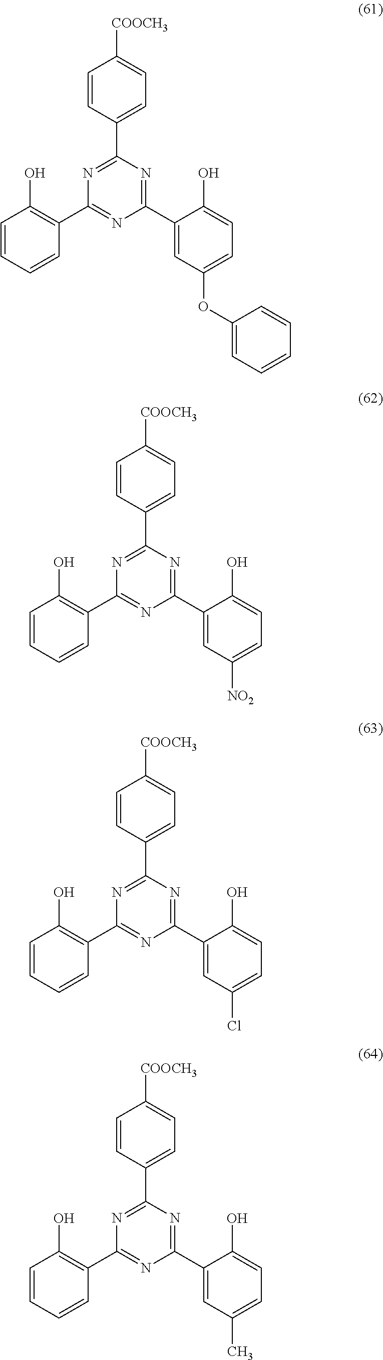 [SMILES: COC(=O)c1ccc(-c2nc(-c3ccccc3O)nc(-c3cc(Oc4ccccc4)ccc3O)n2)cc1 ; COC(=O)c1ccc(-c2nc(-c3ccccc3O)nc(-c3cc([N+](=O)[O-])ccc3O)n2)cc1 ; COC(=O)c1ccc(-c2nc(-c3ccccc3O)nc(-c3cc(Cl)ccc3O)n2)cc1 ; COC(=O)c1ccc(-c2nc(-c3ccccc3O)nc(-c3cc(C)ccc3O)n2)cc1]

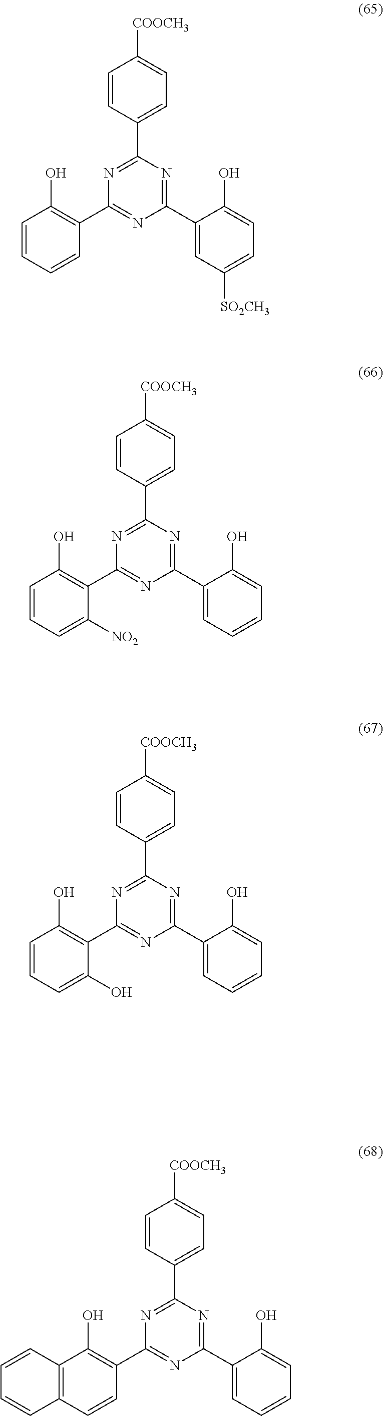 [SMILES: COC(=O)c1ccc(-c2nc(-c3ccccc3O)nc(-c3cc(S(C)(=O)=O)ccc3O)n2)cc1 ; COC(=O)c1ccc(-c2nc(-c3ccccc3O)nc(-c3c(O)cccc3[N+](=O)[O-])n2)cc1 ; COC(=O)c1ccc(-c2nc(-c3ccccc3O)nc(-c3c(O)cccc3O)n2)cc1 ; COC(=O)c1ccc(-c2nc(-c3ccccc3O)nc(-c3ccc4ccccc4c3O)n2)cc1]

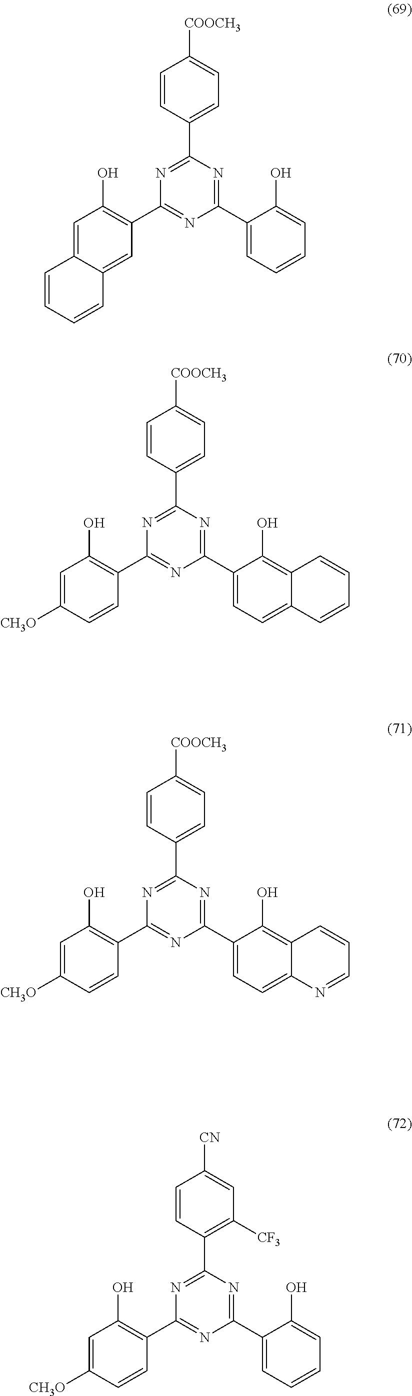

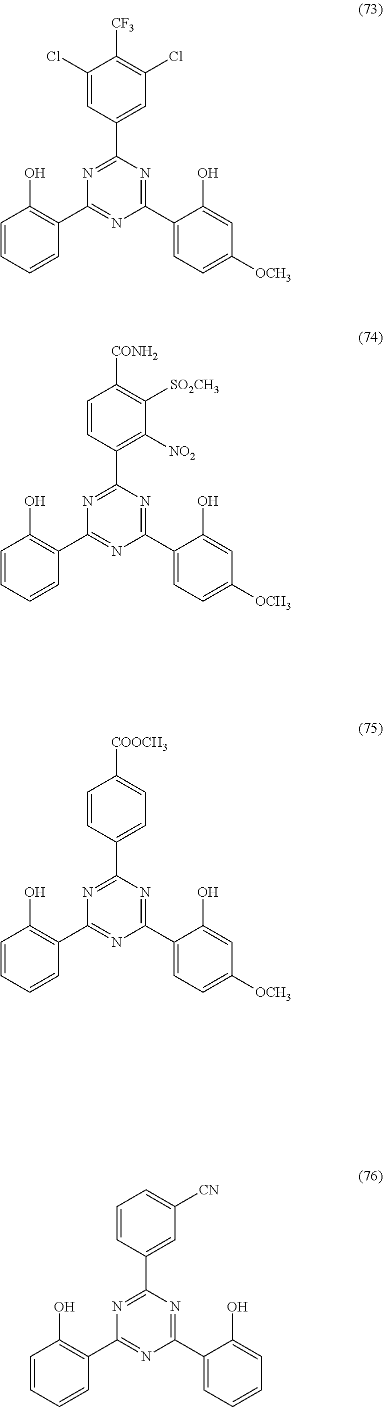 [SMILES: COc1ccc(-c2nc(-c3cc(Cl)c(C(F)(F)F)c(Cl)c3)nc(-c3ccccc3O)n2)c(O)c1 ; COc1ccc(-c2nc(-c3ccccc3O)nc(-c3ccc(C(N)=O)c(S(C)(=O)=O)c3[N+](=O)[O-])n2)c(O)c1 ; COC(=O)c1ccc(-c2nc(-c3ccccc3O)nc(-c3ccc(OC)cc3O)n2)cc1 ; N#Cc1cccc(-c2nc(-c3ccccc3O)nc(-c3ccccc3O)n2)c1]

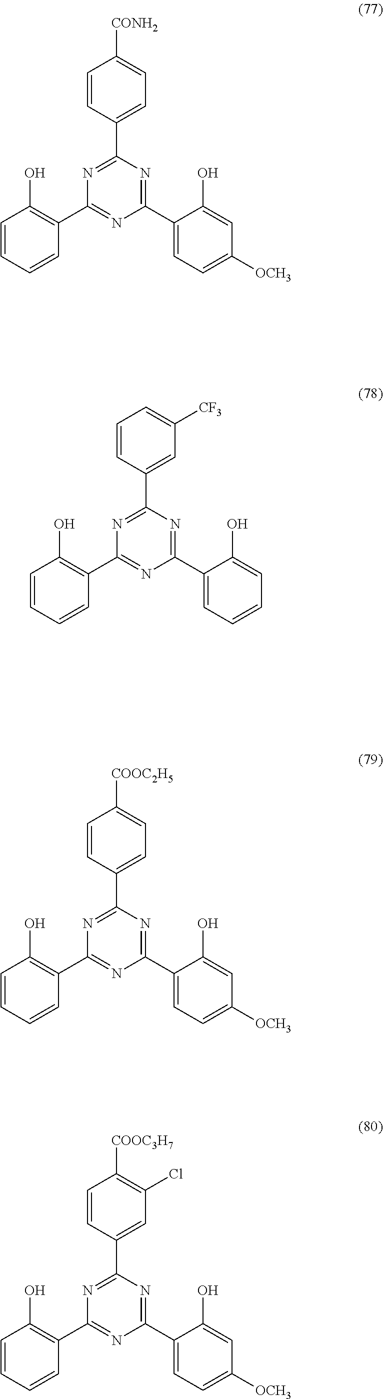

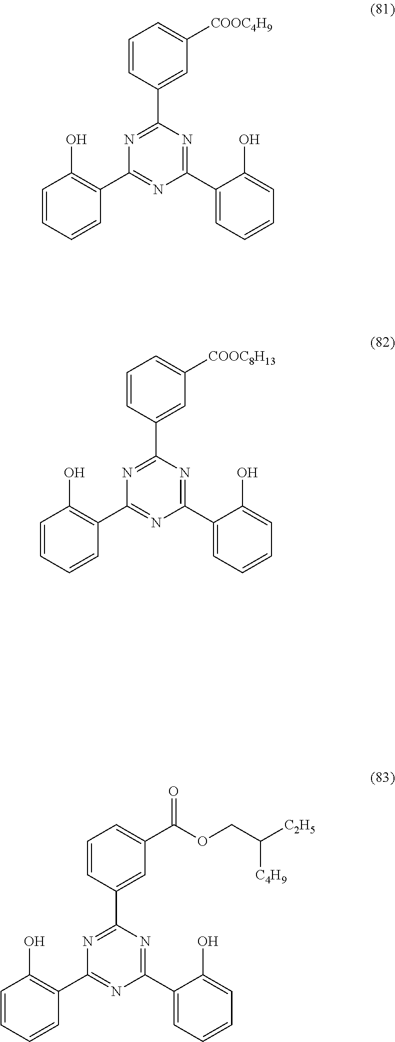

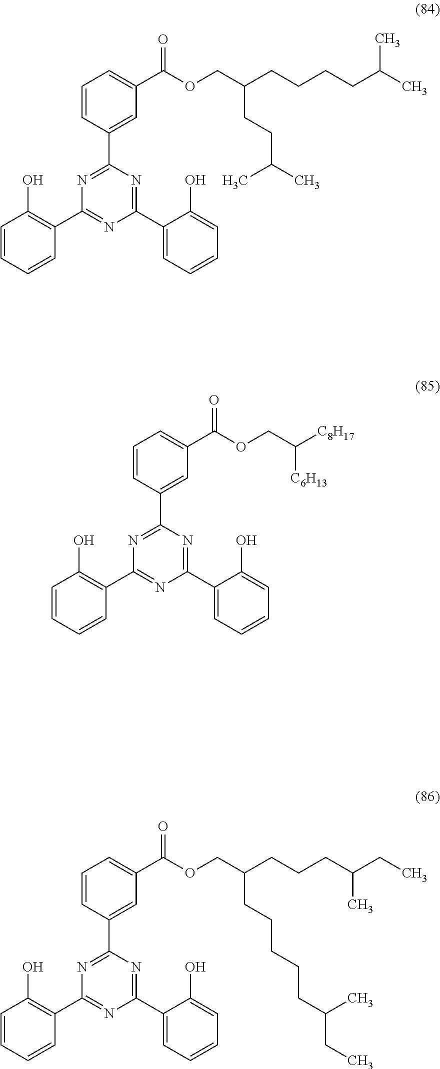

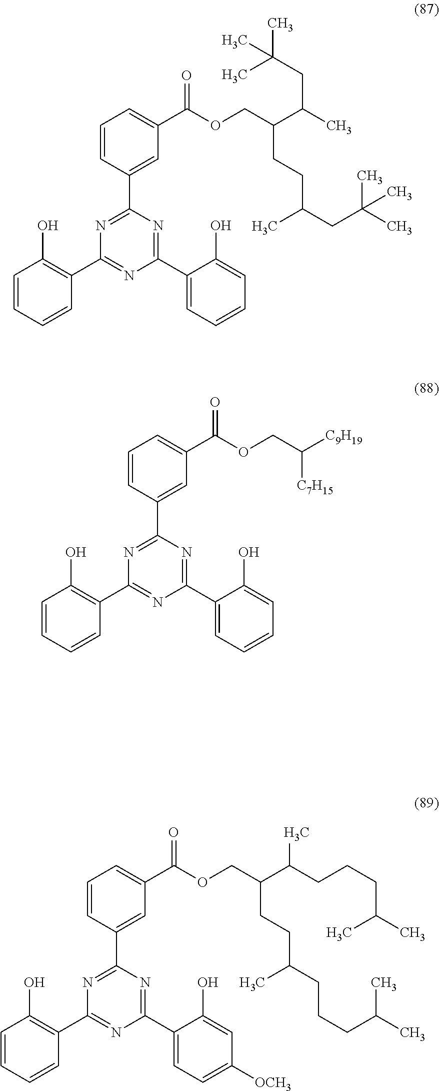

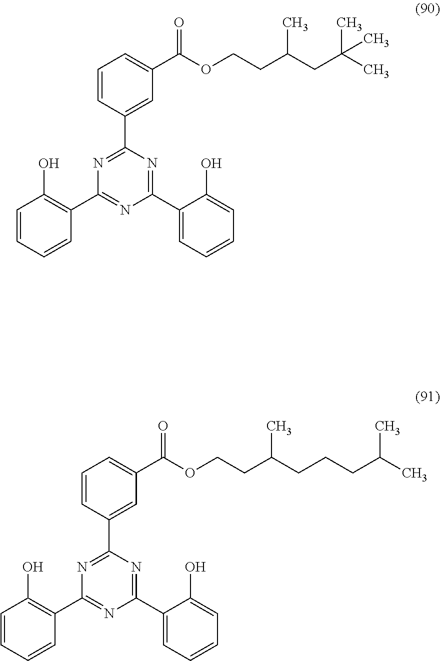 [SMILES: CC(CCOC(=O)c1cccc(-c2nc(-c3ccccc3O)nc(-c3ccccc3O)n2)c1)CC(C)(C)C ; CC(C)CCCC(C)CCOC(=O)c1cccc(-c2nc(-c3ccccc3O)nc(-c3ccccc3O)n2)c1]

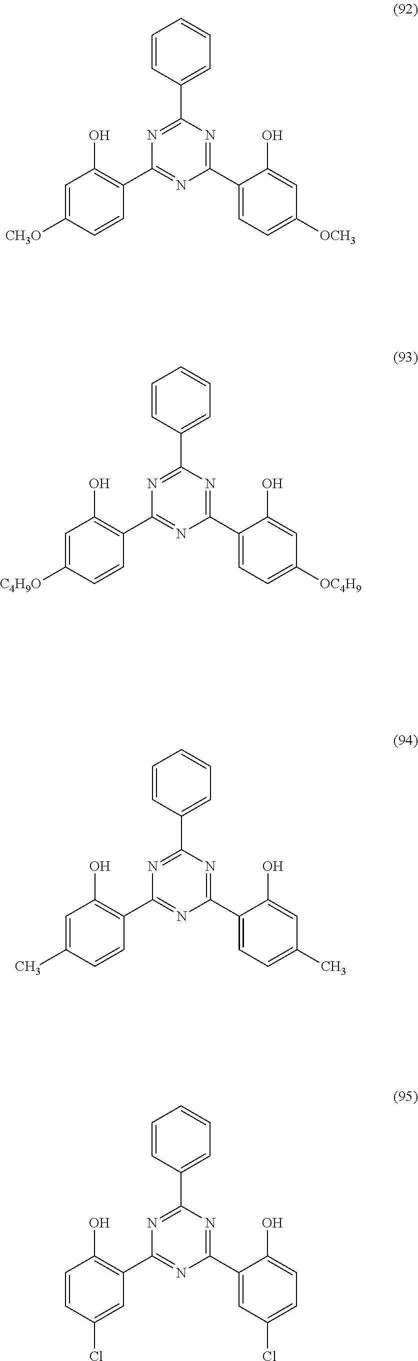

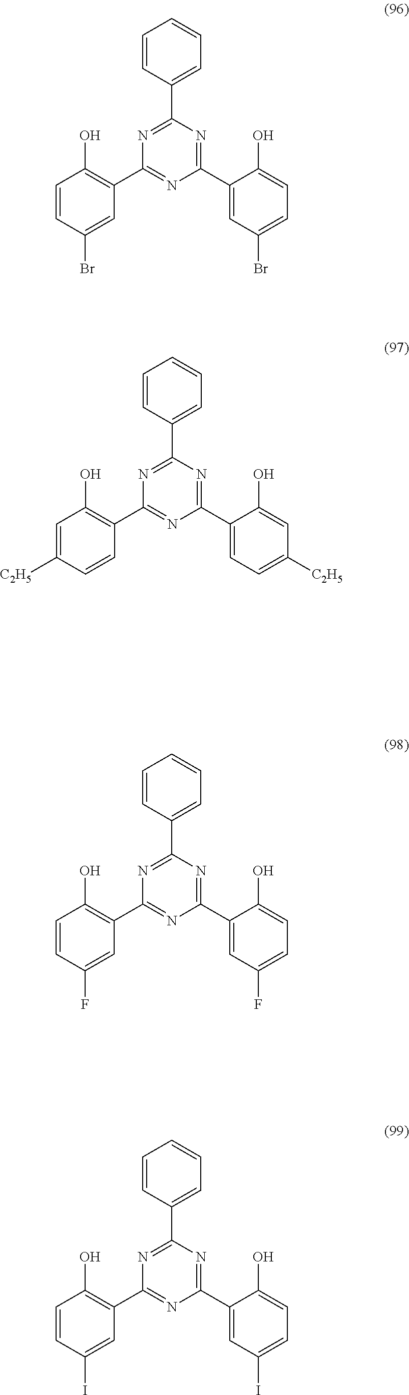 [SMILES: Oc1ccc(Br)cc1-c1nc(-c2ccccc2)nc(-c2cc(Br)ccc2O)n1 ; CCc1ccc(-c2nc(-c3ccccc3)nc(-c3ccc(CC)cc3O)n2)c(O)c1 ; Oc1ccc(F)cc1-c1nc(-c2ccccc2)nc(-c2cc(F)ccc2O)n1 ; Oc1ccc(I)cc1-c1nc(-c2ccccc2)nc(-c2cc(I)ccc2O)n1]

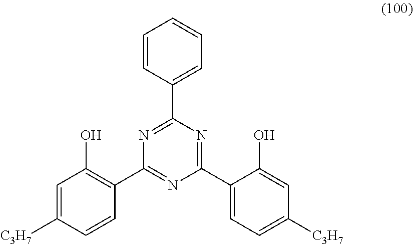

In the resin composition of the present invention, the content of the compound represented by Formula (TA1) is preferably 0.1 to 5 mass parts with respect to 100 mass parts of the resin content.

When a protective film for a polarizing plate is prepared using the resin composition according to the present invention, ultraviolet rays (particularly, near 380 nm) in a wavelength range in which an iodine complex in the polarizer absorbs the rays can be effectively shielded without adversely affecting transparency at a wavelength in a visible region by adjusting the content of the compound represented by Formula (TA1) in the resin composition to the above-described preferred range.

In the resin composition of the present invention, the content of the compound represented by Formula (TA1) is more preferably 0.5 to 4 mass parts, further preferably 1 to 3.5 mass parts, further preferably 1 to 3 mass parts, and further preferably 1 to 2 mass parts, with respect to 100 mass parts of the resin content.

In the resin composition of the present invention, the total content of the compound represented by Formula (1) and the compound represented by Formula (TA1) is preferably 0.5 to 5 mass parts, more preferably 1 to 5 mass parts, further preferably 1 to 4 mass parts, further preferably 1.2 to 3 mass parts, and furthermore preferably 1.5 to 2.7 mass parts, with respect to 100 mass parts of the resin content.

Moreover, in the resin composition of the present invention, the content of the compound represented by Formula (TA1) is preferably higher than the content of the compound represented by Formula (1), and the content of the compound represented by Formula (TA1) is preferably 1.05 to 5 times, further preferably 1.1 to 5 times, and still further preferably 1.5 to 4 times, with respect to the content of the compound represented by Formula (1).

Hereinafter, a substituent S is described in detail.

The substituent S includes the following substituents.

### [Substituent S]

The substituent S include: alkyl groups (preferably those having from 1 to 20 carbon atoms, for example, methyl, ethyl, isopropyl, tert-butyl, pentyl, heptyl, 1-ethylpentyl 2-ethylhexyl, benzyl, 2-ethoxyethyl, 1-carboxymethyl); alkenyl groups (preferably those having from 2 to 20 carbon atoms, for example, vinyl, allyl, oleyl); alkynyl groups (preferably those having from 2 to 20 carbon atoms, for example, ethynyl, 2-propynyl, 2-butynyl, phenylethynyl); cycloalkyl groups (preferably those having from 3 to 20 carbon atoms, for example, cyclopropyl, cyclopentyl, cyclohexyl, 4-methylcyclohexyl); aryl groups (preferably those having from 6 to 20 carbon atoms, for example, phenyl, 1-naphtyl, 4-methoxyphenyl, 2-chlorophenyl, 3-methylphenyl); heterocyclic groups (those preferably having from 0 to 20 carbon atoms and preferably having a ring-constituting heteroatom selected from an oxygen atom, a nitrogen atom or a sulfur atom, and those preferably having a 5- or 6-membered ring which may be condensed with a benzene ring or a hetero ring, and the ring may be a saturated ring, an unsaturated ring or an aromatic ring, for example, 2-pyridyl, 2-imidazolyl, 2-benzoimidazolyl, 2-oxazolyl); alkoxy groups (preferably those having from 1 to 20 carbon atoms, for example, methoxy, ethoxy, isopropyloxy, benzyloxy); aryloxy groups (preferably those having from 6 to 20 carbon atoms, for example, phenoxy, 1-naphthyloxy, 3-methylphenoxy, 4-methoxyphenoxy);
alkylthio groups (preferably those having from 1 to 20 carbon atoms, for example, methylthio, ethylthio, isopropylthio, benzylthio); arylthio groups (preferably those having from 6 to 20 carbon atoms, for example, phenylthio, 1-naphtylthio, 3-methylphenylthio, 4-methoxyphenylthio); a formyl group, acyl groups (those including an alkylcarbonyl group, an alkenylcarbonyl group, an arylcarbonyl group and a heterocyclic carbonyl group, and preferably having 20 or less carbon atoms, for example, acetyl, pivaloyl, acryloyl, methacryloyl, benzoyl, nicotinoyl); alkoxycarbonyl groups (preferably those having from 2 to 20 carbon atoms, for example, ethoxycarbonyl, 2-ethylhexyloxycarbonyl); aryloxycarbonyl groups (preferably those having from 7 to 20 carbon atoms, for example, phenyloxycarbonyl, naphthyloxycarbonyl); amino groups (those including an amino group, an alkylamino group, an arylamino group and a heterocyclic amino group, and preferably having from 0 to 20 carbon atoms, for example, amino, N,N-dimethylamino, N,N-diethylamino, N-ethylamino, anilino, 1-pyrrolidinyl, piperidino, morpholinyl); alkyl- or aryl-sulfonamido groups (preferably those having from 0 to 20 carbon atoms, for example, N,N-dimethylsulfonamido, N-phenylsulfonamido); sulfamoyl groups (preferably those having from 1 to 20 carbon atoms, more preferably —SO₂NH₂, an alkylsulfamoyl group and an arylsulfamoyl group, for example, N,N-dimethylsulfamoyl, N-phenylsulfamoyl); acyloxy groups (preferably those having from 1 to 20 carbon atoms, for example, acetyloxy, benzoyloxy); carbamoyl groups (preferably those having from 1 to 20 carbon atoms, and more preferably —C(═O)NH₂, an alkylcarbamoyl group and an arylcarbamoyl group, for example, N,N-dimethylcarbamoyl, N-phenylcarbamoyl);
acylamino groups (preferably those having from 1 to 20 carbon atoms, for example, acetylamino, acryloylamino, benzoylamino, nicotine amido); thioacyl groups, alkoxythiocarbonyl groups, aryloxythiocarbonyl groups and thiocarbarnoyl groups (those preferred range and specific examples including ones different in only the case where C(═O) moieties in acyl groups, alkoxycarbonyl groups, aryloxy carbonyl groups and carbamoyl groups corresponding thereto are substituted with (C═S)); silyl groups (preferably those having from 3 to 20 carbon atoms, more preferably a silyl group substituted with an alkyl group, an aryl group, an alkoxy group or an aryloxy group, further preferably a trialkylsilyl group and a trialkoxysilyl group, for example, trimethylsilyl, dimethylphenylsilyl, trimethoxysilyl, triethoxysilyl); halogen atoms (for example, a fluorine atom, a chlorine atom, a bromine atom, an iodine atom); acylsulfamoyl groups (those including an alkylcarbonylsulfamoyl group, an alkenylcarbonylsulfamoyl group, an arylcarbonylsulfamoyl group and a heterocyclic carbonylsulfamoyl group, and preferably having 20 or less carbon atoms, for example, acetylsulfamoyl, pivaloylsulfamoyl, acryloylsulfamoyl, methacryloylsulfamoyl, benzoylsulfamoyl, nicotinoylsulfamoyl); alkyl- or aryl-sulfonylsulfamoyl groups (preferably those having from 1 to 20 carbon atoms, for example, methylsulfonylsulfamoyl, ethylsulfonylsulfamoyl, phenylsulfonylsulfamoyl, tolylsulfonylsulfamoyl); a cyano group; a nitro group; a hydroxy group or an anion thereof; a mercapto group or an anion thereof; a sulfo group or a salt thereof; a carboxy group or a salt thereof; a phosphate group or a salt thereof; a boronic acid group or a salt thereof; boronic ester groups; and onio groups (for example, sulfonio groups of sulfonium salt, ammonio groups of ammonium salt, iodonio groups of iodonium salt, phosphonio groups of phosphonium salt).

Any of these substituents may be further substituted with a substituent. Examples of such a substituent include those exemplified as the substituent S.

Specific examples include an aralkyl group in which an alkyl group is substituted with an aryl group (for example, benzyl, phenethyl and diphenylmethyl), a group in which an alkyl group is substituted with an alkoxycarbonyl group or a cyano group (for example, benzoylmethyl), a perfluoroalkyl group in which an alkyl group is substituted with a fluorine atom, such as trifluoromethyl, and a substituted aryl group in which an aryl group is substituted with the a group exemplified as above-described substituent S. Moreover, preferred specific examples include a group having an active methine or an active methylene structure (an alkyl group substituted with an electron withdrawing group, a group having a moiety in which methine or methylene is bonded with an electron withdrawing group, or a group having a methine or methylene moiety interposed by electron withdrawing groups).

### <Additives>

Into the resin composition of the present invention, various additives may be incorporated according to an intended purpose, in addition to the ultraviolet absorbers.

Specific examples of such an additive include a plasticizer, a degradation inhibitor such as an antioxidant, and a matting agent.

When the protective film for a polarizing plate is prepared using the resin composition according to the present invention, in addition thereto, an additive for adjusting performance of the protective film for a polarizing plate, such as a barbituric acid compound, a hardness improver, a retardation regulator (a retardation-developing agent and a retardation-reducing agent) and a peeling promoter can also be added.

Specific examples of the plasticizer include a carboxylic acid ester such as phthalate, and a phosphoric acid ester, and also a sugar ester, a polycondensed ester compound (polymer) and a multivalent ester of polyhydric alcohol.

As the retardation-reducing agent, the retardation-developing agent, the plasticizer, a hydrophobizing agent including a polyhydric alcohol ester type or a polycondensation ester type, a carbohydrate derivative-based plasticizer, the antioxidant, an ultraviolet absorber and the matting agent, compounds or raw materials described in JP-A-2013-28782, paragraphs [0061] to [0126] are preferred, and all descriptions also including the content are preferably incorporated herein.

### (Radical Scavenger)

The resin composition of the present invention preferably contains a radical scavenger. HALSs and reductones are preferably used as the radical scavenger.

The HALSs are preferably a compound having a 2,2,6,6-tetramethyl-piperidine ring; more preferably a compound in which the 1-position of the piperidine is a hydrogen atom, an alkyl group, an alkoxy group, a hydroxy group, an oxy radical group (—O.), an acyloxy group, or an acyl group; and further preferably a compound in which the 4-position thereof is a hydrogen atom, a hydroxy group, an acyloxy group, an amino group which may have a substituent, an alkoxy group or an aryloxy group. In addition, it is also preferably a compound having from two to five 2,2,6,6-tetramethyl-piperidine rings in the molecule.

Examples of such a compound include Sunlizer HA-622 (trade name, manufactured by Sort K.K.); CHIMASSORB 2020FDL, TINUVIN 770DF, TINUVIN 152, TINUVIN 123, and FLAMESTAB NOR 116 FF (each trade name, manufactured by BASF Japan Ltd. (the former Chiba Specialty Chemicals)); and CYASORB UV-3346, and CYASORB UV-3529 (each trade name, manufactured by SUN CHEMICAL Company Ltd.).

Examples of the reductones include compounds exemplified in JP-A-6-27599, paragraphs [0014] to [0034]; compounds exemplified in JP-A-6-110163, paragraphs [0012] to [0020]; and compounds exemplified in JP-A-8-114899, paragraphs [0022] to [0031].

In addition, it is possible to use preferably an oil-solubilized derivative of ascorbic acid or erythorbic acid. Examples thereof include L-ascorbyl stearate, L-ascorbyl tetraisopalmitate, L-ascorbyl palmitate, erythorbyl palmitate, and erythorbyl tetraospalmitate. Among them, those having an ascorbic acid skeleton are preferable, and myristate, palmitate, and stearate of L-ascorbic acid are particularly preferable.

The content of the radical scavenger in the resin composition of the present invention is preferably from 0.001 to 2.0 mass parts, and more preferably from 0.01 to 1.0 mass part, with respect to 100 mass parts of the resin.

### (Degradation Inhibitor)

A degradation inhibitor (for example, an antioxidant, a peroxide decomposition agent, a radical inhibitor, a metal deactivator, an acid trapping agent and an amine) may be added to the resin composition of the present invention. Moreover, the ultraviolet absorber is also one of the degradation inhibitors. These degradation inhibitor and the like are described in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, JP-A-2000-204173, and JP-A-2006-251746.

The radical scavenger also exhibits the degradation preventing action, and an amine is also known as a degradation inhibitor. Examples thereof include compounds described in JP-A-5-194789, paragraphs [0009] to [0080]; and an aliphatic amine, such as tri-n-octylamine, triisooctylamine, tris(2-ethylhexyl)amine, and N,N-dimethyldodecylamine.

In addition, it is also preferable to use a polyvalent amine having two or more amino groups, and those having two or more primary or secondary amino groups are preferable, as the polyvalent amine. Examples of the compound having two or more amino groups include a nitrogen-containing heterocyclic compound (a compound having a pyrazolidine ring, a piperazine ring, or the like), and a polyamine-based compound (a compound which is a chain or cyclic polyamine and contains, for example, diethylenetriamine, tetraethylenepentamine, N,N′-bis(aminoethyl)-1,3-propanediamine, N,N,N′,N″,N″-pentakis(2-hydroxypropyl)diethylenetriamine, polyethyleneimine, modified polyethyleneimine, or cyclam as a basic skeleton).

The content of the degradation inhibitor in the resin composition is preferably from 1 ppm to 10%, more preferably from 1 ppm to 5.0%, and still more preferably from 10 ppm to 1.0%, on the mass basis.

### (Peeling Promoter)

Any peeling promoters may be added to the resin composition of the present invention.

The peeling promoter is preferably an organic acid, a polyvalent carboxylic acid derivative, a surfactant or a chelating agent. For example, compounds described in JP-A-2006-45497, paragraphs [0048] to [0081], compounds described in JP-A-2002-322294, paragraphs [0077] to [0086], and compounds described in JP-A-2012-72348, paragraphs [0030] to [0056], can be preferably used. The content of the peeling promoter in the resin composition is preferably from 1 ppm to 5.0%, more preferably from 1 ppm to 2.0%, on the mass basis.

### (Barbituric Acid Compound)

The resin composition according to the present invention preferably contains a barbituric acid compound represented by Formula (A). In particular, when the resin is cellulose acylate, such a compound is preferably used. The compound represented by Formula (A) can develop many functions, and when the protective film for a polarizing plate is formed, for example, the compound is effective in improving durability of the polarizing plate against light, heat or wet heat, or improving hardness of the cellulose acylate film, or the like.

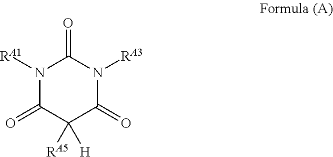

In Formula (A), R^{A1} and R^{A3} each independently designate a hydrogen atom, an alkyl group, a cycloalkyl group, an alkenyl group, or an aromatic group. Herein, the alkyl group, the cycloalkyl group, the alkenyl group, and the aromatic group may have a substituent. R^{A5} designates a hydrogen atom or a substituent.

The compound represented by Formula (A) also includes a tautomer or a salt thereof having a structure in which a hydrogen atom in the ring structure is enolized with a carbonyl in the adjacent ring structure, or in which an imidic acid is formed when R^{A1} and R^{A3} each are a hydrogen atom.

The number of carbon atoms of the alkyl group that is adoptable as R^{A1}, R^{A3}, and R^{A5} is preferably 1 to 20, more preferably 1 to 10, further preferably 1 to 5, and particularly preferably 1 to 3. Among these, a methyl group or an ethyl group is preferred. When the alkyl group is an alkyl group substituted with a group having a ring structure, the alkyl group has preferably from 7 to 20 carbon atoms, more preferably from 7 to 12 carbon atoms, and further preferably from 7 to 10 carbon atoms. The ring structure of the alkyl group having a ring structure may be an aromatic ring (including an aromatic heteroring) or an aliphatic ring, and is preferably an aromatic hydrocarbon ring or an aliphatic ring. Examples of the alkyl group having a ring structure include a benzyl group and a phenethyl group. Of these, a benzyl group is particularly preferable.

The number of carbon atoms of the cycloalkyl group that is adoptable as R^{A1} and R^{A3} is preferably 3 to 20, more preferably 3 to 10, further preferably 4 to 8, and particularly preferably 5 or 6. Examples of the cycloalkyl group include cyclopropyl, cyclopentyl, and cyclohexyl. Of these, cyclohexyl is preferable.

The number of carbon atoms of the alkenyl group that is adoptable as R^{A1} and R^{A3} is preferably 2 to 20, more preferably 2 to 10, and further preferably 2 to 5. Examples of the alkenyl group include vinyl and allyl.

The aromatic group of R^{A1} and R^{A3} may be an aromatic hydrocarbon group or an aromatic heterocyclic group, and is preferably an aromatic hydrocarbon group.

The number of carbon atoms of the aromatic hydrocarbon group is preferably 6 to 20, more preferably 6 to 16, and further preferably 6 to 12. As the aromatic hydrocarbon group, phenyl or naphtyl is preferred, and phenyl is more preferred.

The aromatic heterocyclic group is preferably a 5- or 6-membered hetero ring, and may be condensed with a benzene ring or a hetero ring. The heteroatom for constituting the hetero ring of the aromatic heterocyclic group is preferably a nitrogen atom, an oxygen atom, and a sulfur atom. The number of carbon atoms of the aromatic heterocyclic group is preferably 0 to 20, more preferably 1 to 16, and further preferably 3 to 12. Examples of such a hetero ring include a pyrrole ring, a thiophene ring, a furan ring, a pyrazole ring, an oxazole ring, a thiazole ring, a pyridine ring, and an indole ring.

Examples of the substituent that is adoptable as R^{A5} include groups exemplified as the substituent S. Among these, an alkyl group, a cycloalkyl group, an alkenyl group, an aromatic group, a halogen atom, a formyl group, an acyl group, a cyano group, and a soluble group are preferred.

In the present invention, a soluble group is a group that increases solubility of the compound in water, and is a group of an anion or a cation or a group that is dissociated to be anionized (for example, pKa being preferably 10 or less).

Specific examples of such a group include a sulfo group or a salt thereof, a carboxy group or a salt thereof, a phosphoric acid group or a salt thereof, a hydroxy group, a mercapto group, an amino group, an onio group (preferably an ammonio group), a sulfonamide group, an acylsulfamoyl group, an alkyl- or aryl-sulfonylsulfamoyl group, and a group having an active methine or active methylene structure.

Among these, a sulfo group or a salt thereof, a carboxy group or a salt thereof, a hydroxy group, or an amino group is more preferred.

In addition, the hydroxy group, the mercapto group, the amino group, the sulfonamide group, the acylsulfamoyl group, the alkyl- or aryl-sulfonylsulfamoyl group, and the group having an active methine or active methylene structure include a group in a salt state.

A counter ion that forms the salt of the sulfo group and the salt of the carboxy group, and also the salt of the hydroxy group, the mercapto group, the amino group, the sulfonamide group, the acylsulfamoyl group, the alkyl- or aryl-sulfonylsulfamoyl group, and the group having an active methine or methylene structure may be an inorganic ion or an organic ion.

For example, the inorganic ion preferably includes an ammonium ion and an alkaline metal ion (e.g. a lithium ion, a sodium ion and a potassium ion). Specific examples of the organic ion include an onium ion of organic cation, and include an organic ammonium ion (e.g. a tetramethylammonium ion and a tetramethylguanidinium ion), a cation of a nitrogen-containing heteroaromatic ring (e.g. a pyrrolidinium ion and a pyridinium ion), a phosphonium ion (e.g. a tetramethylphosphonium ion) and a sulfonium ion (e.g. a trimethylsulfonium ion). Among those counter ions, an alkaline metal ion, namely an alkaline metal salt is preferred.

As the counter ion when the compound represented by Formula (A) is formed into a tautomer to form a salt, the counter ion same with the above-described ion is preferably applied thereto.

On the other hand, in the case of a salt of the amino group, an acid that forms the salt may be an inorganic acid or an organic acid.

In the case of the inorganic acid, specific examples include hydrochloric acid, bromic acid, sulfuric acid, phosphoric acid and boric acid. Specific examples of the organic acid include an aliphatic or aromatic-carboxylic acid or sulfonic acid (e.g. formic acid, acetic acid, oxalic acid, benzoic acid, methanesulfonic acid, benzenesulfonic acid and nicotinic acid).

Moreover, in the case of an onio group, the counter ion may be an inorganic or organic anion, and specific examples include an anion of the above-described inorganic acid or organic acid.

R^{A5} is preferably a hydrogen atom, an alkyl group, a cycloalkyl group, an alkenyl group, an aromatic group, a halogen atom, a formyl group, an acyl group, a cyano group, or a hydroxy group.

When R^{A1}, R^{A3} and R^{A5} are an alkyl group, a cycloalkyl group, an alkenyl group, or an aromatic group, examples of the substituent which they may have, include the group exemplified as the substituent S. Among these, an alkyl group, a cycloalkyl group, an alkenyl group, an aromatic group, a heterocyclic group, an alkoxy group, an alkylthio group, an alkylsulfonyl group, a halogen atom, a formyl group, an acyl group, a silyl group, or a soluble group is preferred; an alkyl group, a cycloalkyl group, an aryl group, a heterocyclic group, an alkoxy group, an alkylthio group, an alkylsulfonyl group, a halogen atom, a formyl group, an acyl group, a silyl group, or a soluble group is more preferred; and an alkyl group, a cycloalkyl group, an aryl group, a heterocyclic group, an alkoxy group, an alkylthio group, an alkylsulfonyl group, a halogen atom, a formyl group, an acyl group, a hydroxy group, a sulfo group or a salt thereof, a carboxy group or a salt thereof, a boronic acid group or a salt thereof, a carbamoyl group, a sulfamoyl group, or an onto group (preferably an ammonio group including a quaternary ammonio group) is further preferred.

The compound represented by Formula (A) is generally classified into two kinds described below as a preferred range, although the compound depends on the purpose of use.

A preferred first embodiment is a compound in combination with the following substituents.

The embodiment refers to a compound in which R^{A1}, R^{A3} and R^{A5} are each independently a hydrogen atom, an alkyl group, cycloalkyl group, an alkenyl group or an aromatic group. The alkyl group, the cycloalkyl group, the alkenyl group and the aromatic group may have a substituent. As a preferred substituent, the compound has a substituent other than the above-described soluble group in the group exemplified as the substituent S.

The substituent which the each group of those may have, is preferably an alkyl group, a cycloalkyl group, an alkenyl group, an aromatic group, a heterocyclic group, an alkoxy group, an alkylthio group, an acyl group, a silyl group, or a halogen atom.

Any of R^{A1}, R^{A3} and R^{A5} is preferably a group having a ring structure, and the number of ring structures is preferably 1 to 6, more preferably 2 to 6, further preferably 2 to 5, and particularly preferably 3 to 5.

Examples of such a ring are preferably an aliphatic hydrocarbon ring and an aromatic hydrocarbon ring; more preferably a cyclopentane ring, a cyclohexane ring, a benzene ring, and a naphthalene ring; and further preferably a cyclohexane ring and a benzene ring.

When R^{A1}, R^{A3} and R^{A5} are a cyclic group, a cycloalkyl group or an aryl group is preferred. When R^{A1}, R^{A3} and R^{A5} are a group having a ring structure, specific examples of the substituent include a group having a cycloalkyl moiety or an aryl moiety among those exemplified as the substituent S, and a group having the cycloalkyl group or the aryl group as the substituent is preferred, and a cycloalkyl-substituted alkyl group or aralkyl group is particularly preferred, and a benzyl group is most preferred.

As the cyclic group or the group having a ring structure, among them, a cycloalkyl group, an aryl group or an aralkyl group is preferred.

The molecular weight of the compound of the first embodiment is preferably 250 to 1,200, more preferably 300 to 800, and particularly preferably 350 to 600.

When the protective film for a polarizing plate is formed, for example, a film that is excellent in inhibition of volatilization of the compound represented by Formula (A) from the protective film for a polarizing plate, and has high transparency can be obtained by combining the substituents and adjusting the molecular weight to such a preferred range.

A preferred second embodiment is a compound in combination with the following substituents.

This embodiment, in a manner contrary to the first embodiment, utilizes a polar effect, and diffusibility in the formed film is also taken into consideration.

R^{A1} and R^{A3} are each independently a hydrogen atom, an alkyl group, a cycloalkyl group, an alkenyl group or an aromatic group, and R^{A5} is a hydrogen atom or a substituent: and 1) a compound in which any of R^{A1}, R^{A3} and R^{A5} is a soluble group or a group containing a soluble group; 2) a compound the molecular weight of which is 128 or more and less than 250; or/and 3) a compound in which any one or two of R^{A1}, R^{A3} and R^{A5} is a hydrogen atom.

The molecular weight of the compound of the second embodiment is preferably 128 to 1,200, and more preferably 150 to 800.

Specific examples of the compound represented by Formula (A) are shown below, but the present invention is not limited to these.

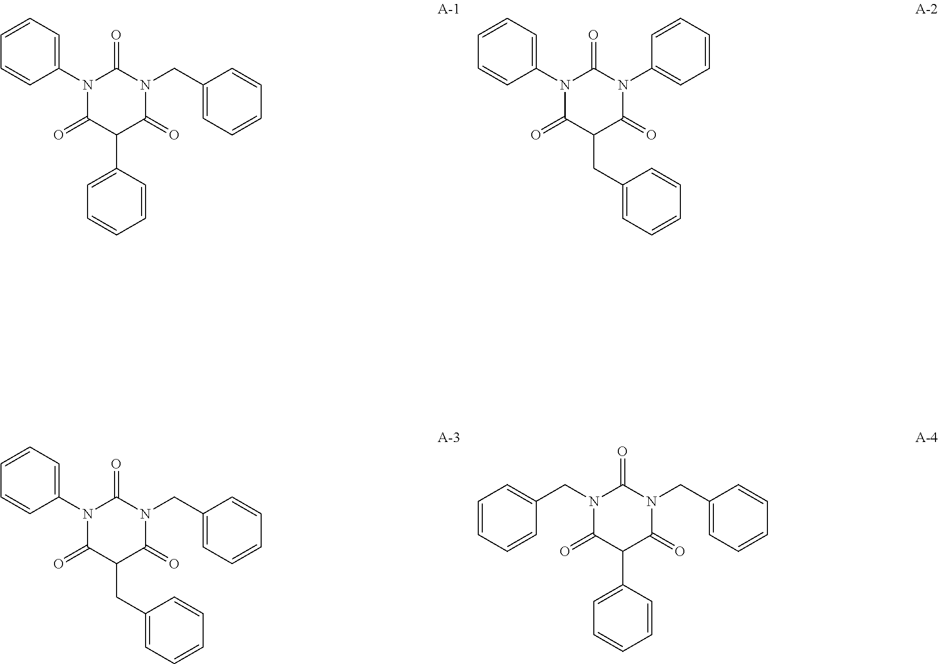 [SMILES: O=C1C(c2ccccc2)C(=O)N(c2ccccc2)C(=O)N1Cc1ccccc1 ; O=C1C(Cc2ccccc2)C(=O)N(c2ccccc2)C(=O)N1c1ccccc1 ; O=C1C(Cc2ccccc2)C(=O)N(c2ccccc2)C(=O)N1Cc1ccccc1 ; O=C1C(c2ccccc2)C(=O)N(Cc2ccccc2)C(=O)N1Cc1ccccc1]

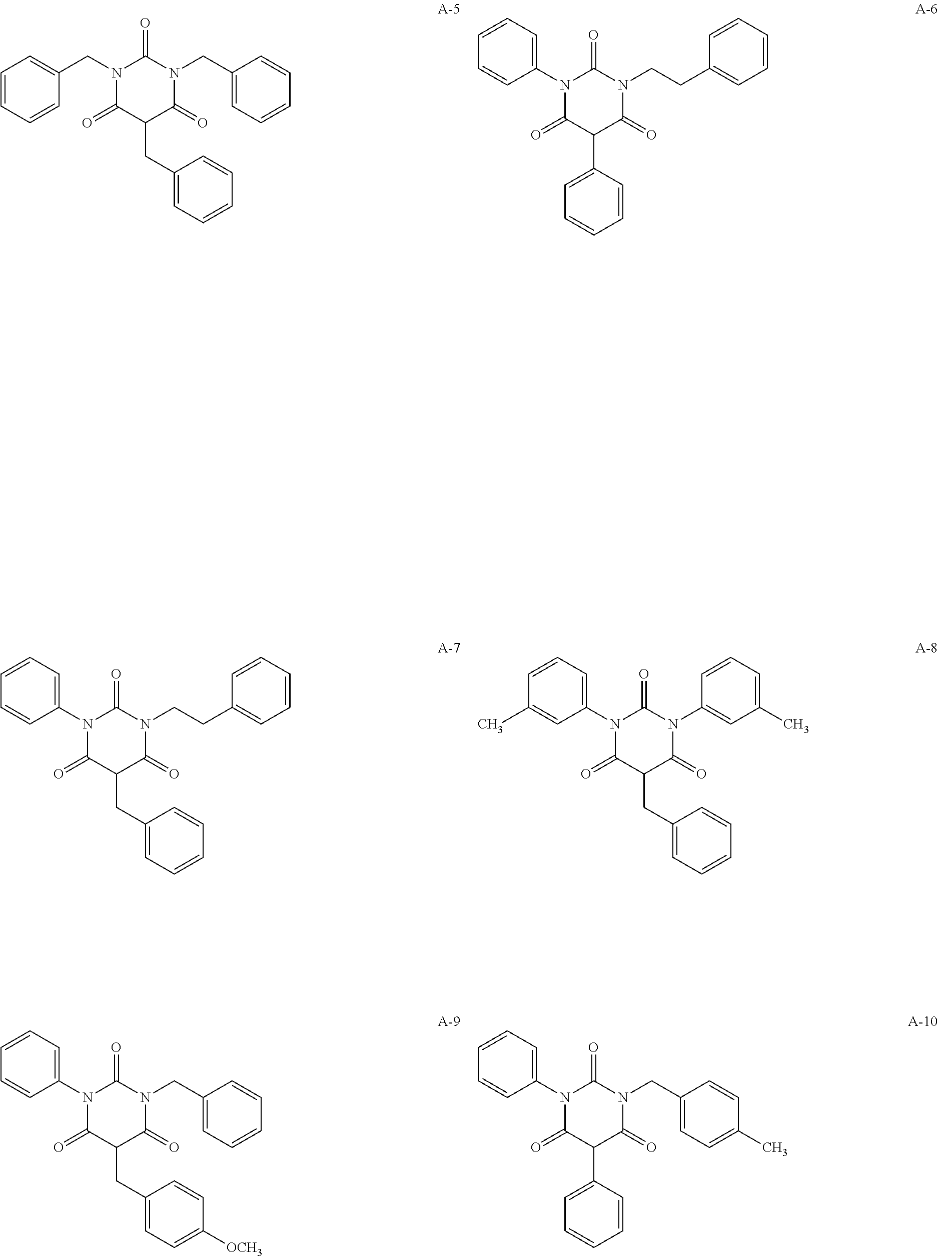

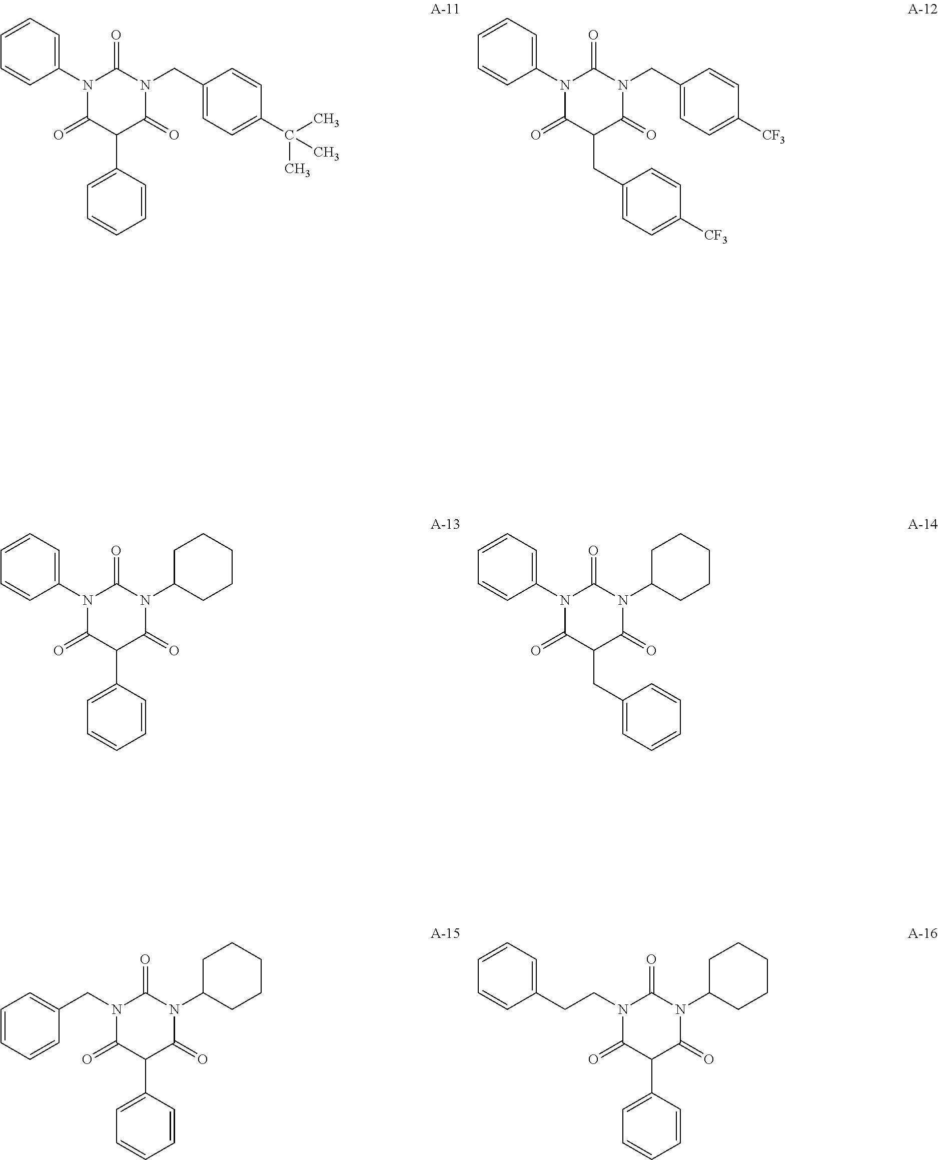 [SMILES: CC(C)(C)c1ccc(CN2C(=O)C(c3ccccc3)C(=O)N(c3ccccc3)C2=O)cc1 ; O=C1C(Cc2ccc(C(F)(F)F)cc2)C(=O)N(c2ccccc2)C(=O)N1Cc1ccc(C(F)(F)F)cc1 ; O=C1C(c2ccccc2)C(=O)N(C2CCCCC2)C(=O)N1c1ccccc1 ; O=C1C(Cc2ccccc2)C(=O)N(C2CCCCC2)C(=O)N1c1ccccc1 ; O=C1C(c2ccccc2)C(=O)N(C2CCCCC2)C(=O)N1Cc1ccccc1 ; O=C1C(c2ccccc2)C(=O)N(C2CCCCC2)C(=O)N1CCc1ccccc1]

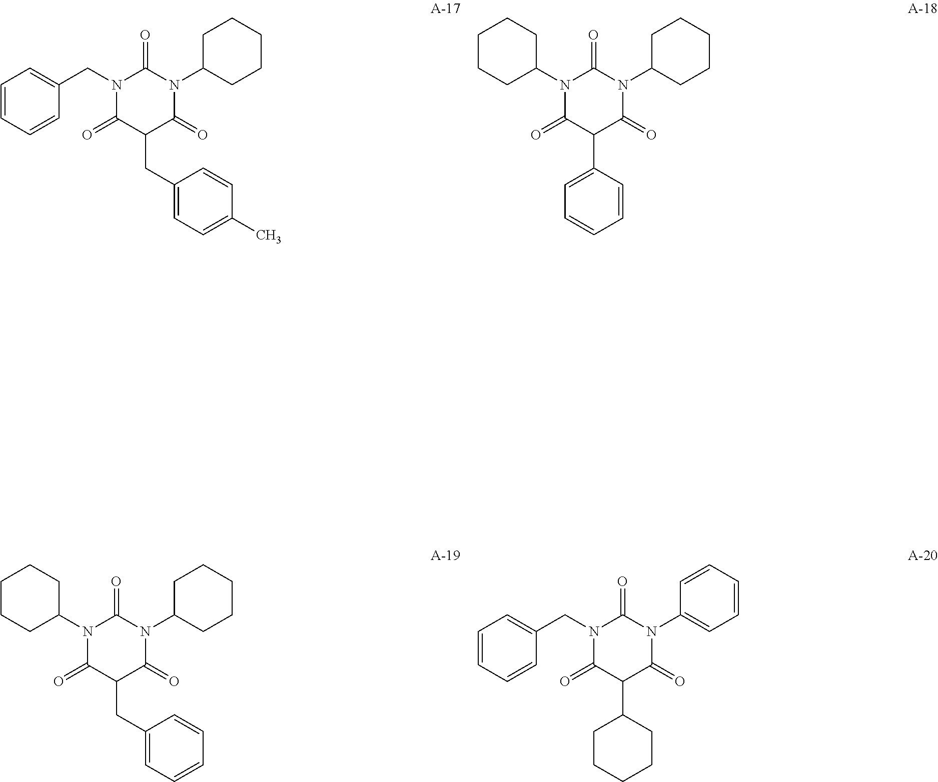 [SMILES: Cc1ccc(CC2C(=O)N(Cc3ccccc3)C(=O)N(C3CCCCC3)C2=O)cc1 ; O=C1C(c2ccccc2)C(=O)N(C2CCCCC2)C(=O)N1C1CCCCC1 ; O=C1C(Cc2ccccc2)C(=O)N(C2CCCCC2)C(=O)N1C1CCCCC1 ; O=C1C(C2CCCCC2)C(=O)N(c2ccccc2)C(=O)N1Cc1ccccc1]

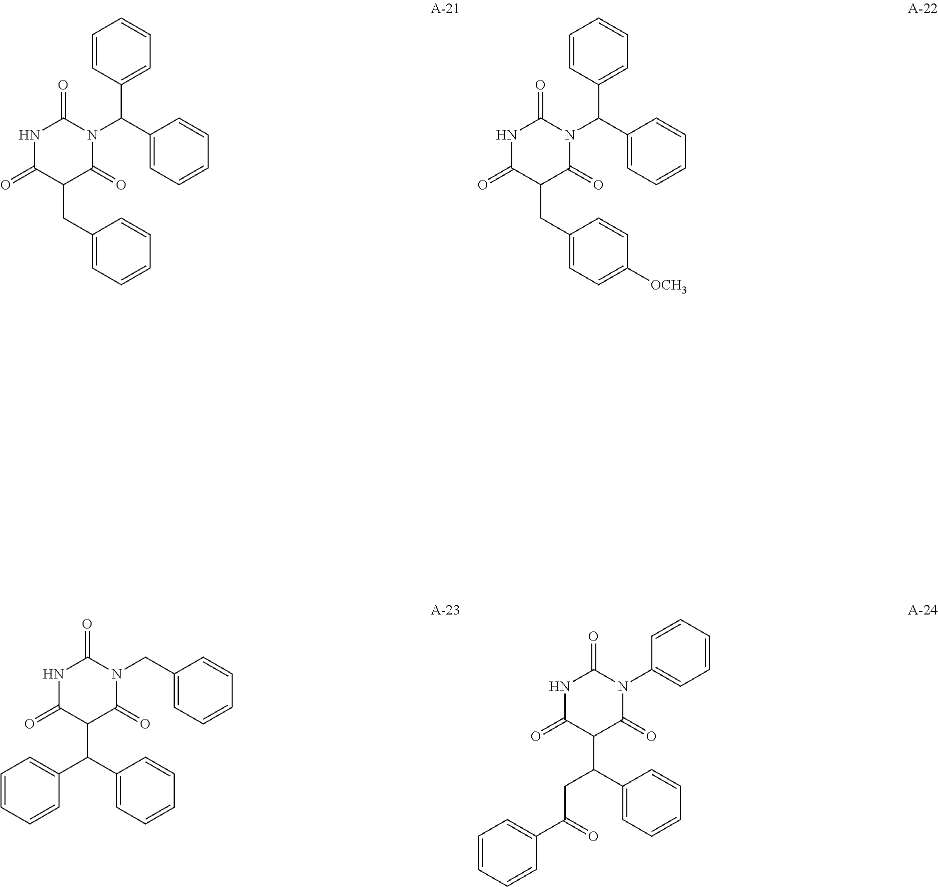 [SMILES: O=C1NC(=O)N(C(c2ccccc2)c2ccccc2)C(=O)C1Cc1ccccc1 ; COc1ccc(CC2C(=O)NC(=O)N(C(c3ccccc3)c3ccccc3)C2=O)cc1 ; O=C1NC(=O)N(Cc2ccccc2)C(=O)C1C(c1ccccc1)c1ccccc1 ; O=C(CC(c1ccccc1)C1C(=O)NC(=O)N(c2ccccc2)C1=O)c1ccccc1]

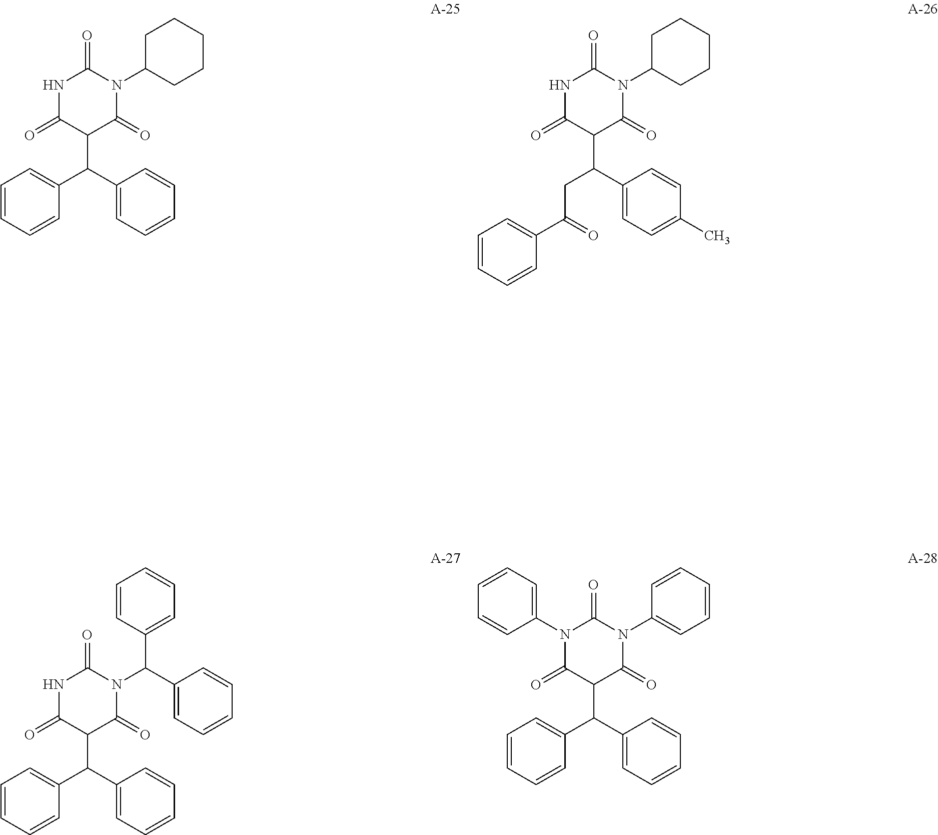 [SMILES: O=C1NC(=O)N(C2CCCCC2)C(=O)C1C(c1ccccc1)c1ccccc1 ; Cc1ccc(C(CC(=O)c2ccccc2)C2C(=O)NC(=O)N(C3CCCCC3)C2=O)cc1 ; O=C1NC(=O)N(C(c2ccccc2)c2ccccc2)C(=O)C1C(c1ccccc1)c1ccccc1 ; O=C1C(C(c2ccccc2)c2ccccc2)C(=O)N(c2ccccc2)C(=O)N1c1ccccc1]

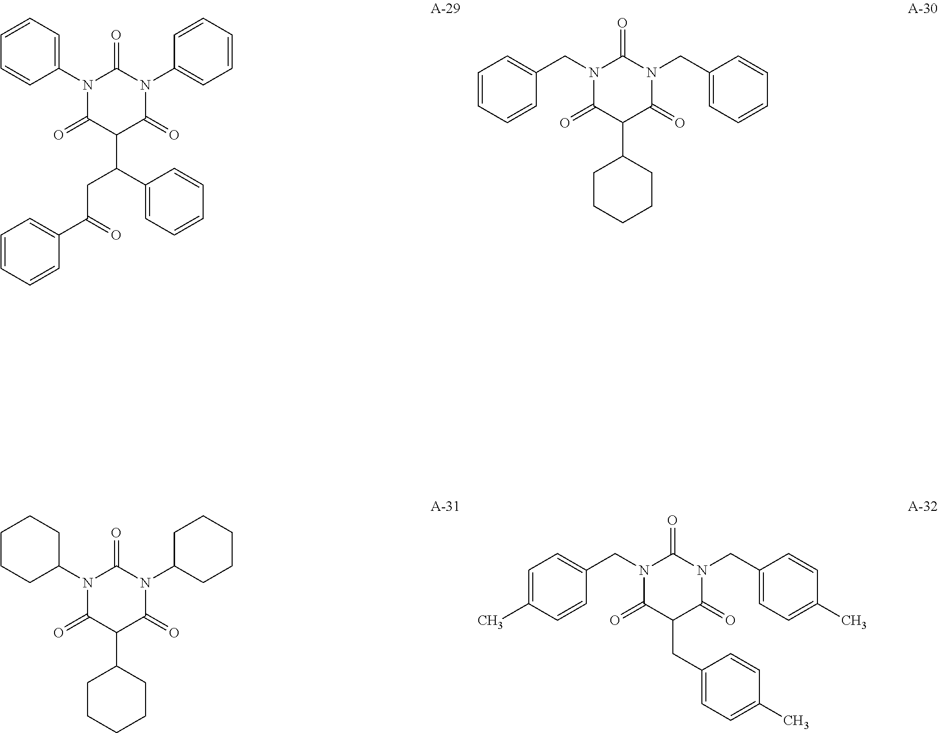

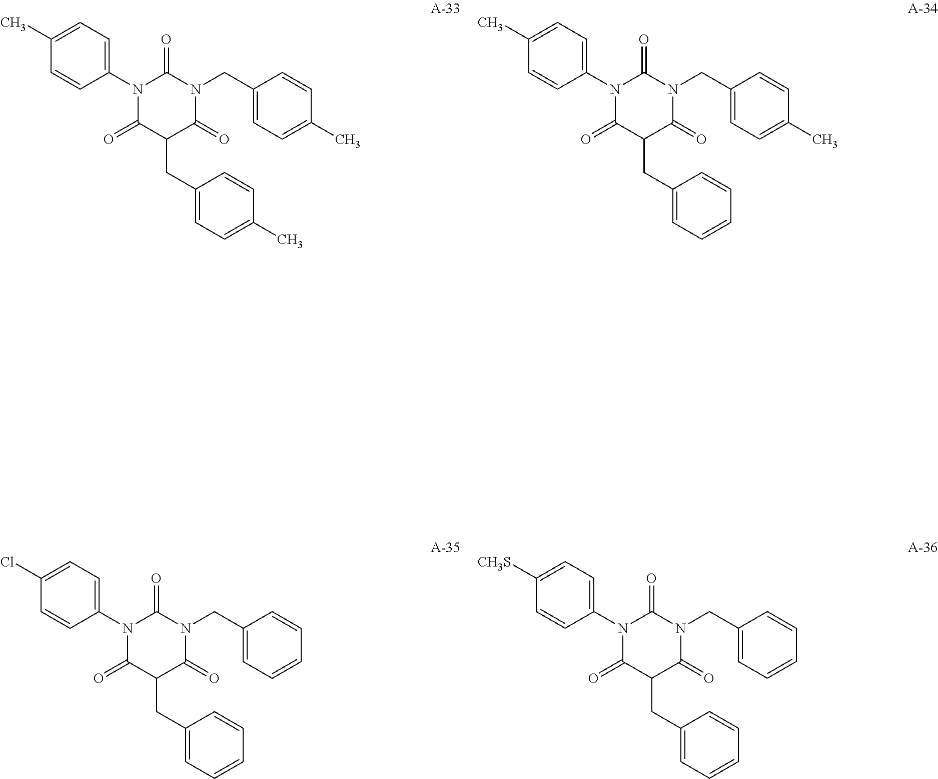

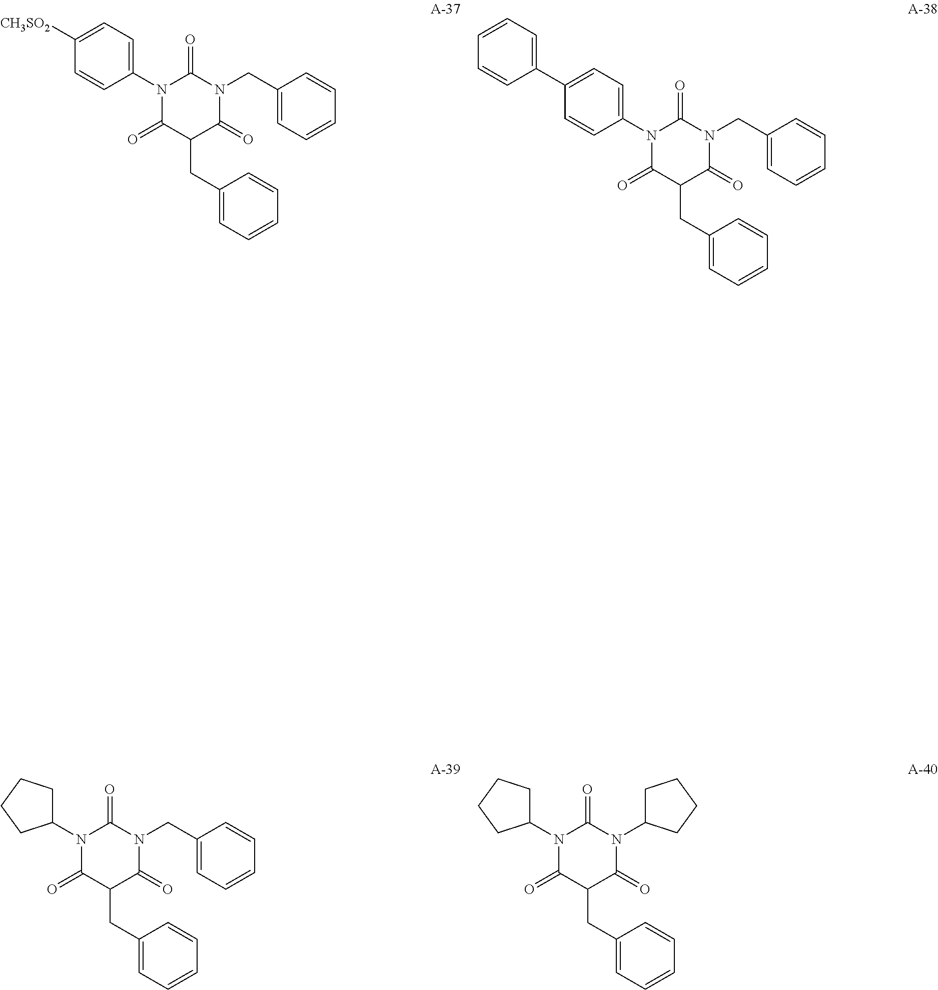

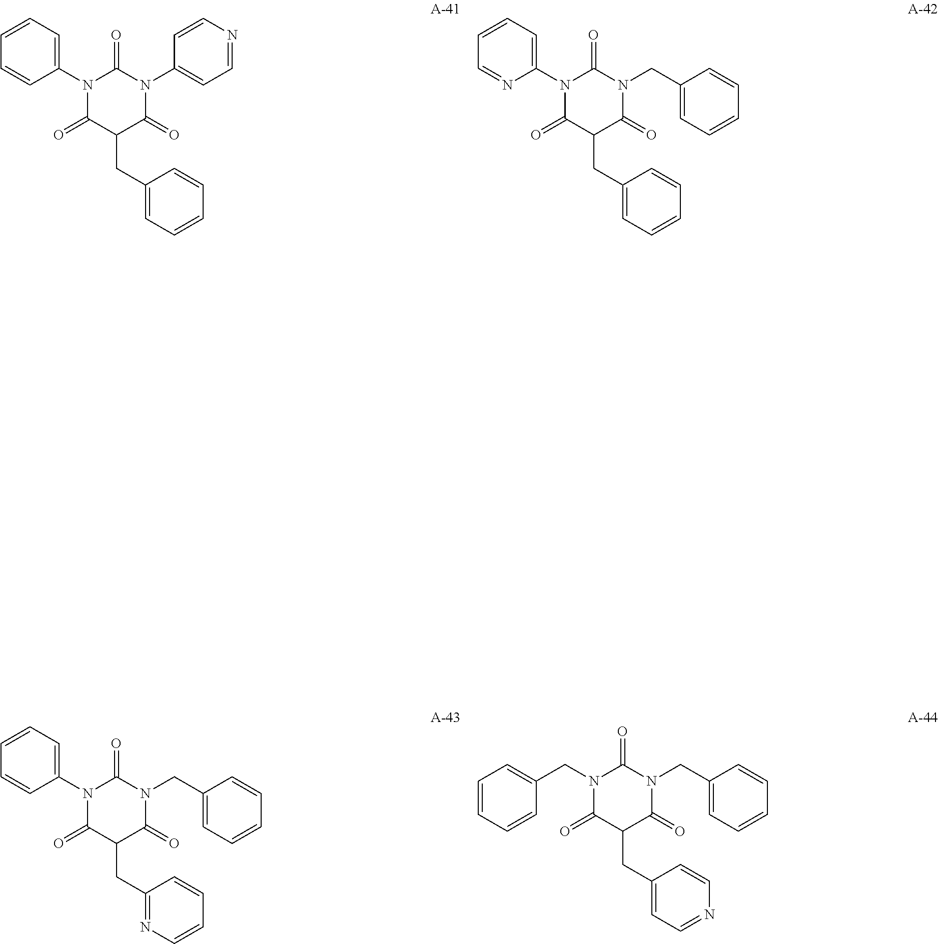 [SMILES: O=C1C(Cc2ccccc2)C(=O)N(c2ccncc2)C(=O)N1c1ccccc1 ; O=C1C(Cc2ccccc2)C(=O)N(c2ccccn2)C(=O)N1Cc1ccccc1 ; O=C1C(Cc2ccccn2)C(=O)N(c2ccccc2)C(=O)N1Cc1ccccc1 ; O=C1C(Cc2ccncc2)C(=O)N(Cc2ccccc2)C(=O)N1Cc1ccccc1]

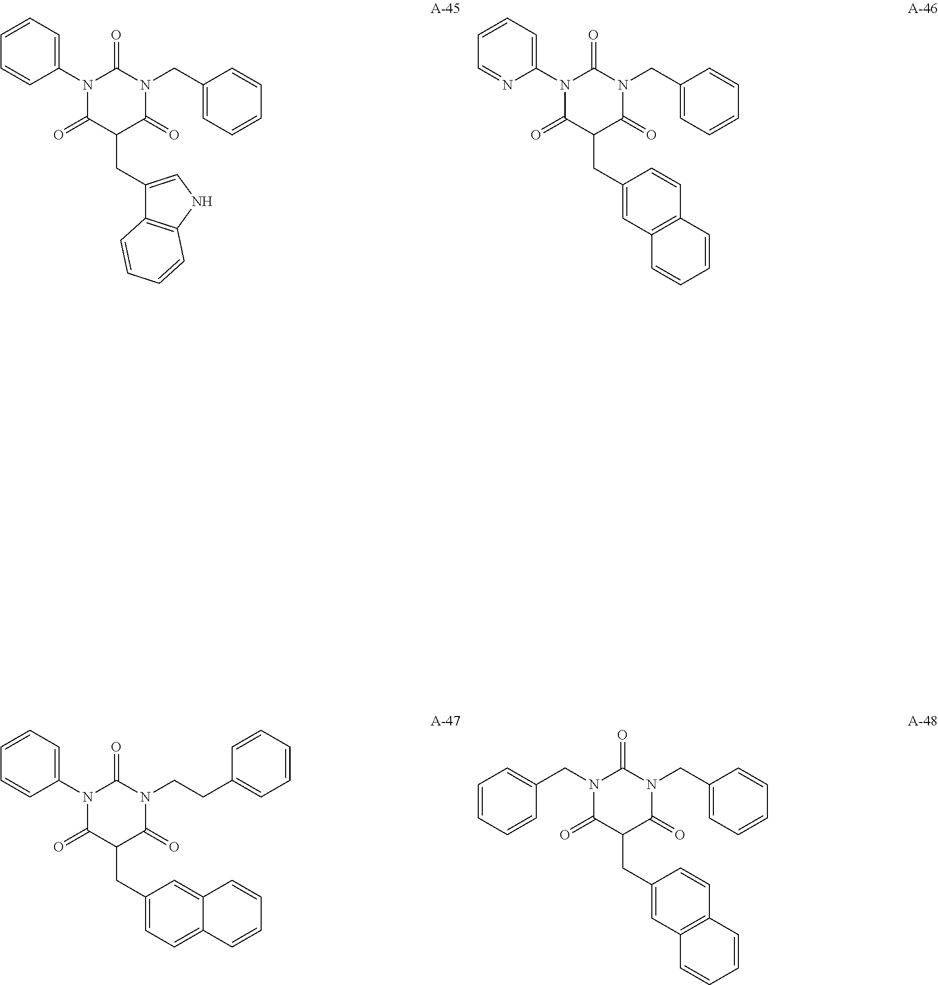 [SMILES: O=C1C(Cc2c[nH]c3ccccc23)C(=O)N(c2ccccc2)C(=O)N1Cc1ccccc1 ; O=C1C(Cc2ccc3ccccc3c2)C(=O)N(c2ccccn2)C(=O)N1Cc1ccccc1 ; O=C1C(Cc2ccc3ccccc3c2)C(=O)N(c2ccccc2)C(=O)N1CCc1ccccc1 ; O=C1C(Cc2ccc3ccccc3c2)C(=O)N(Cc2ccccc2)C(=O)N1Cc1ccccc1]

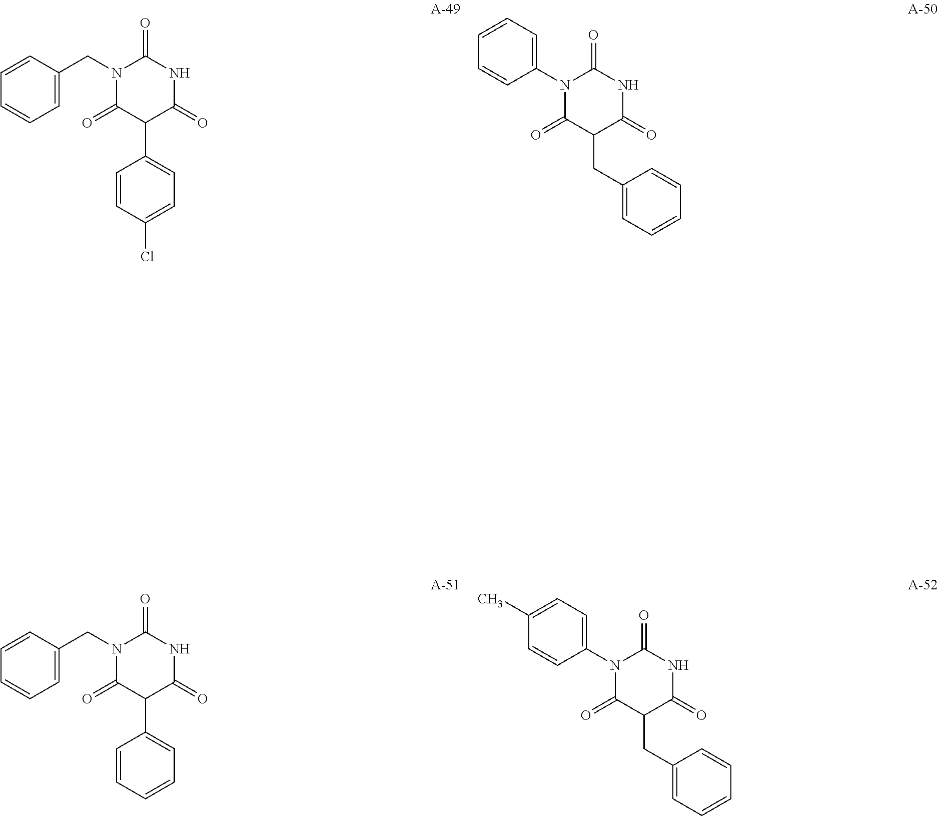 [SMILES: O=C1NC(=O)N(Cc2ccccc2)C(=O)C1c1ccc(Cl)cc1 ; O=C1NC(=O)N(c2ccccc2)C(=O)C1Cc1ccccc1 ; O=C1NC(=O)N(Cc2ccccc2)C(=O)C1c1ccccc1 ; Cc1ccc(N2C(=O)NC(=O)C(Cc3ccccc3)C2=O)cc1]

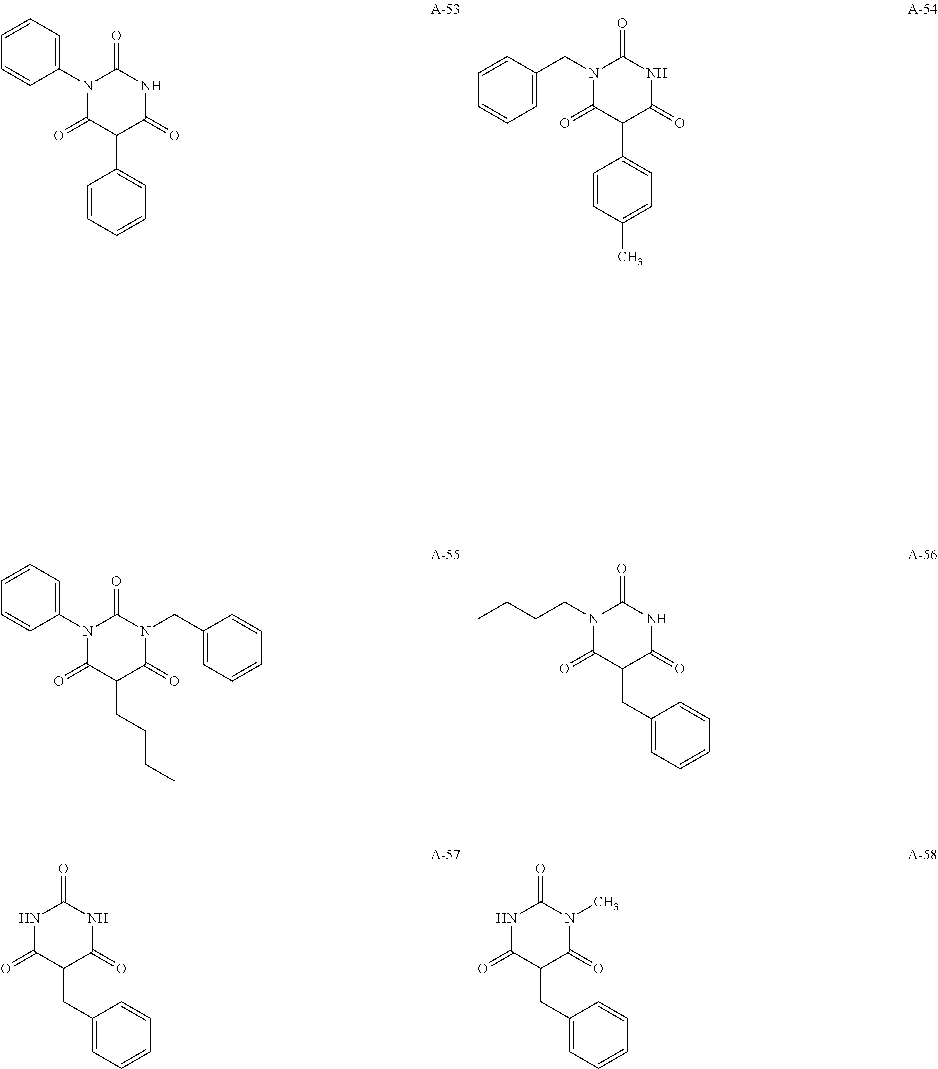 [SMILES: O=C1NC(=O)N(c2ccccc2)C(=O)C1c1ccccc1 ; Cc1ccc(C2C(=O)NC(=O)N(Cc3ccccc3)C2=O)cc1 ; CCCCC1C(=O)N(Cc2ccccc2)C(=O)N(c2ccccc2)C1=O ; CCCCN1C(=O)NC(=O)C(Cc2ccccc2)C1=O ; O=C1NC(=O)C(Cc2ccccc2)C(=O)N1 ; CN1C(=O)NC(=O)C(Cc2ccccc2)C1=O]

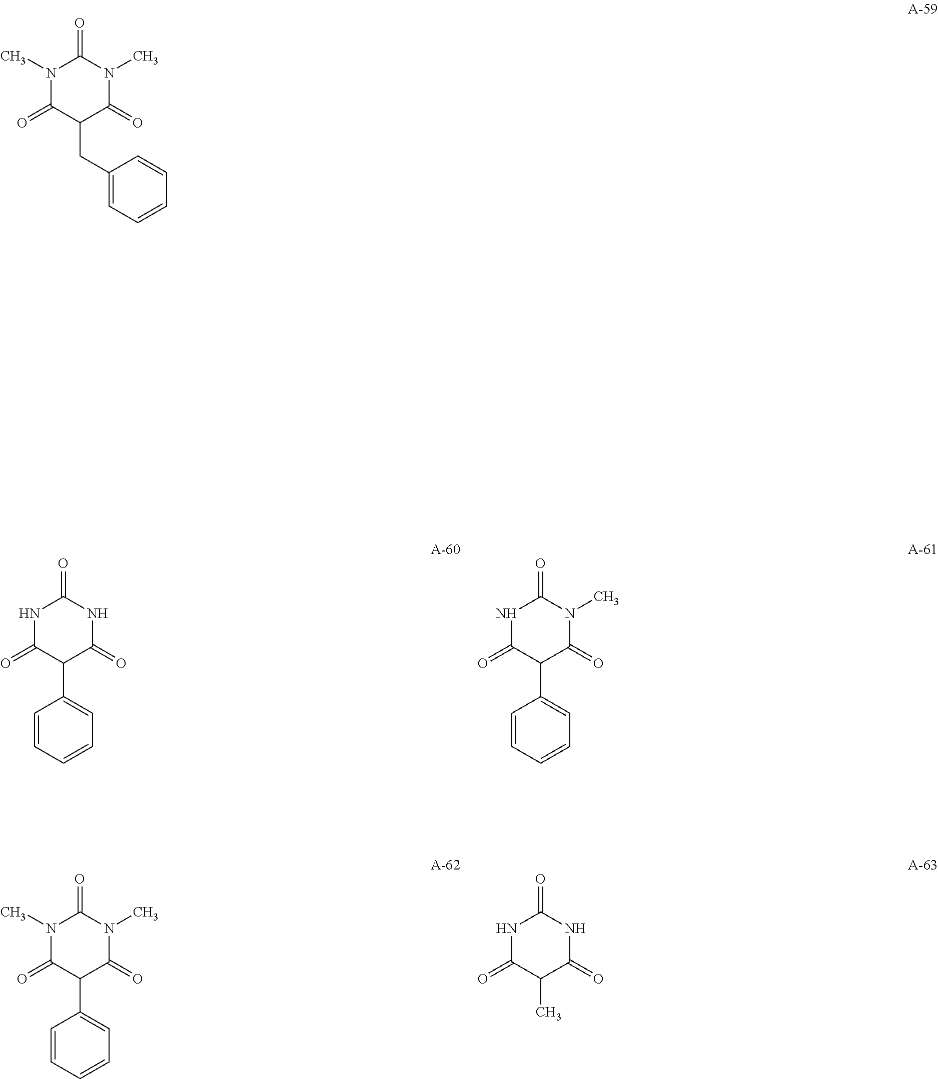

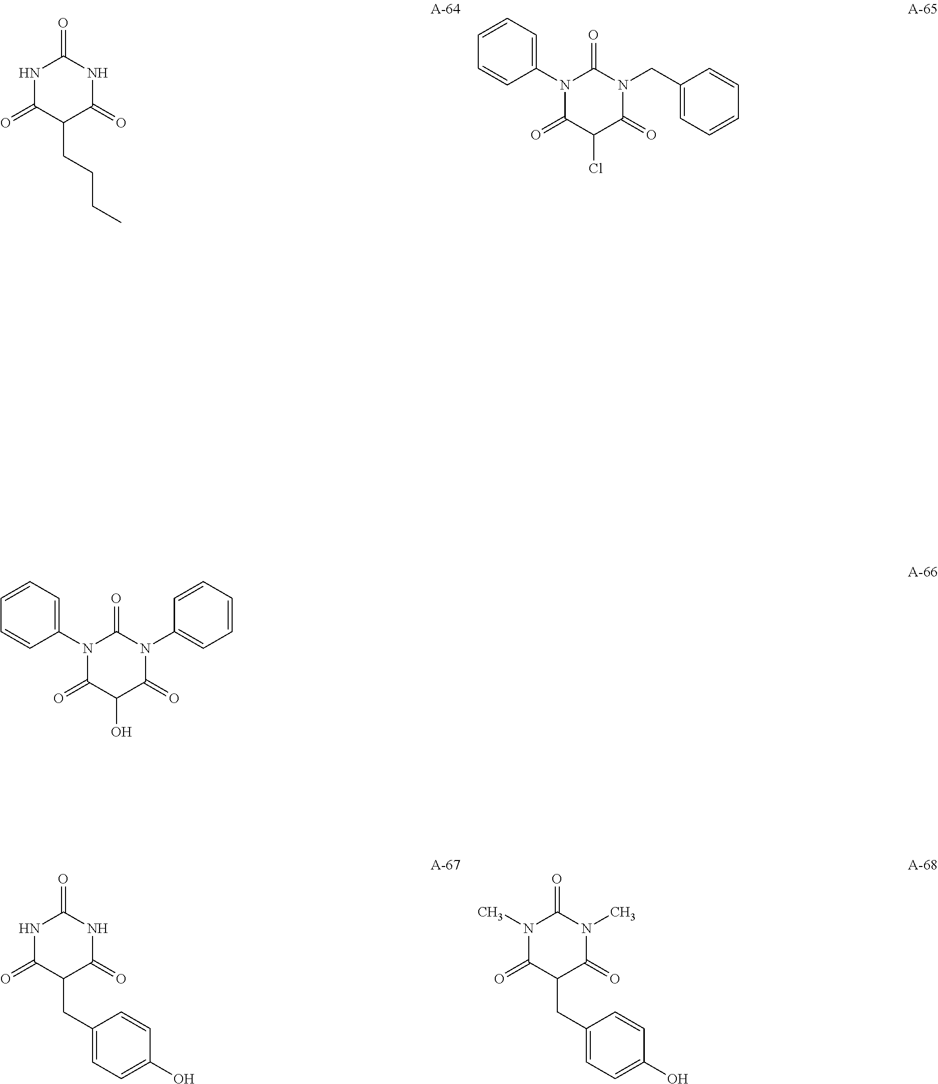 [SMILES: CCCCC1C(=O)NC(=O)NC1=O ; O=C1C(Cl)C(=O)N(c2ccccc2)C(=O)N1Cc1ccccc1 ; O=C1C(O)C(=O)N(c2ccccc2)C(=O)N1c1ccccc1 ; O=C1NC(=O)C(Cc2ccc(O)cc2)C(=O)N1 ; CN1C(=O)C(Cc2ccc(O)cc2)C(=O)N(C)C1=O]

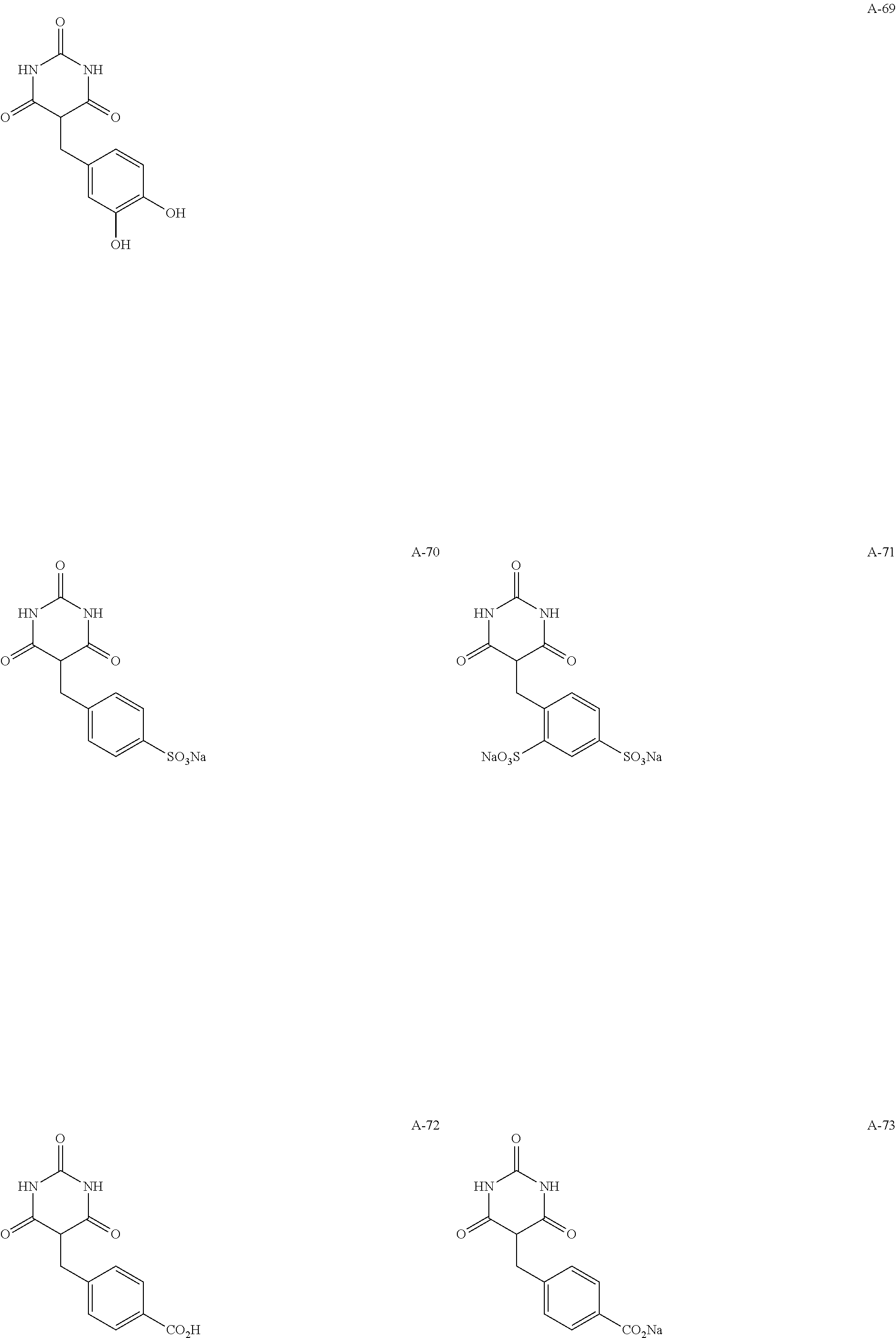

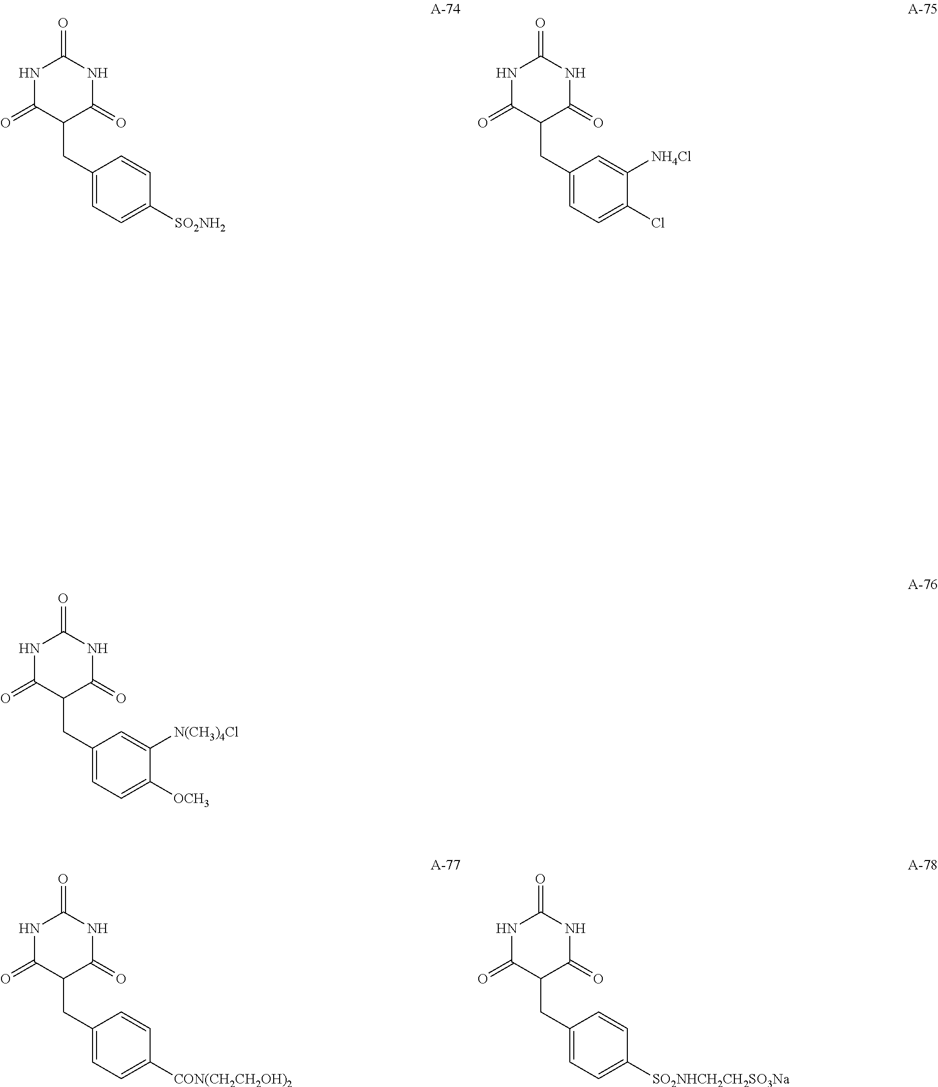

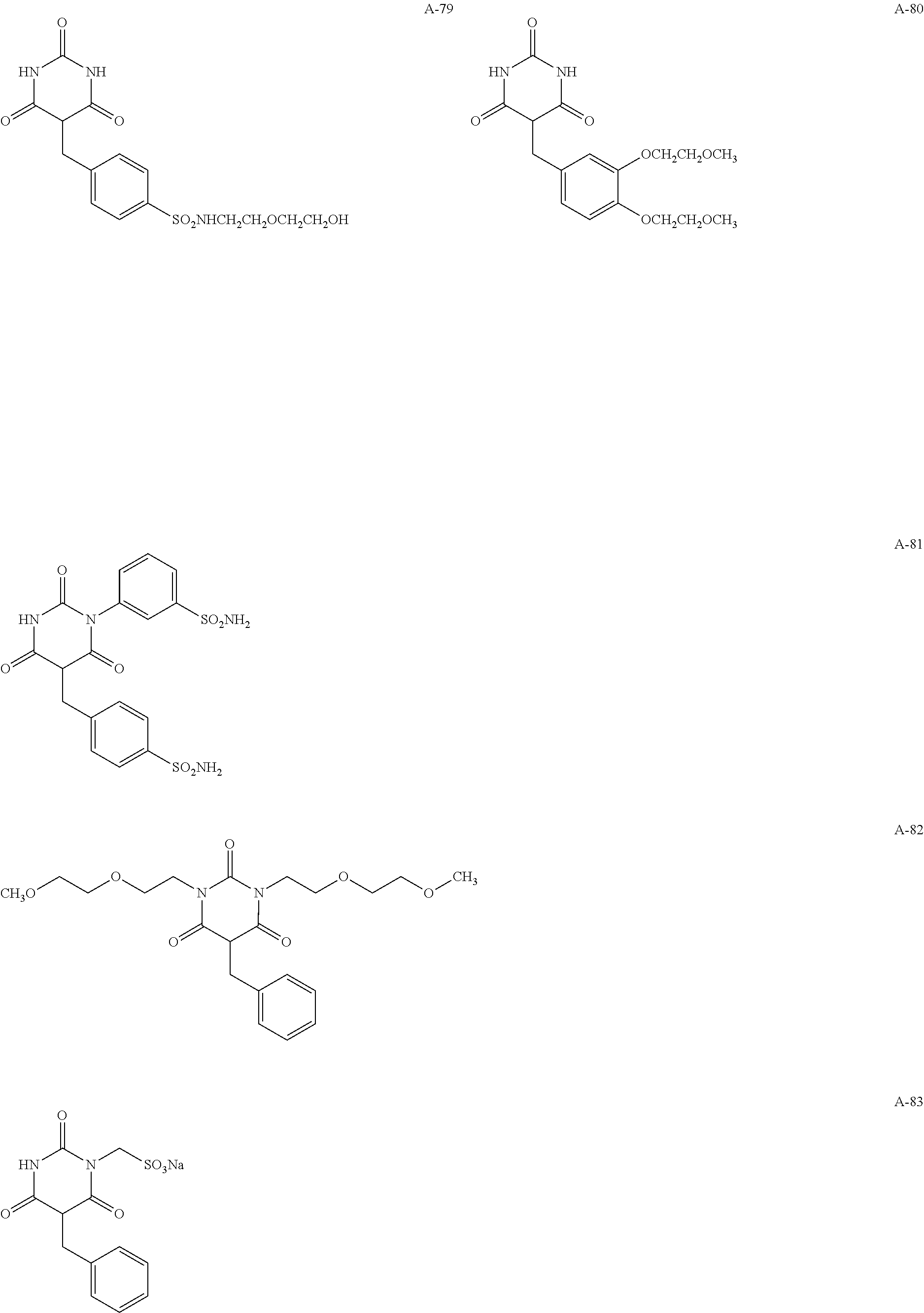

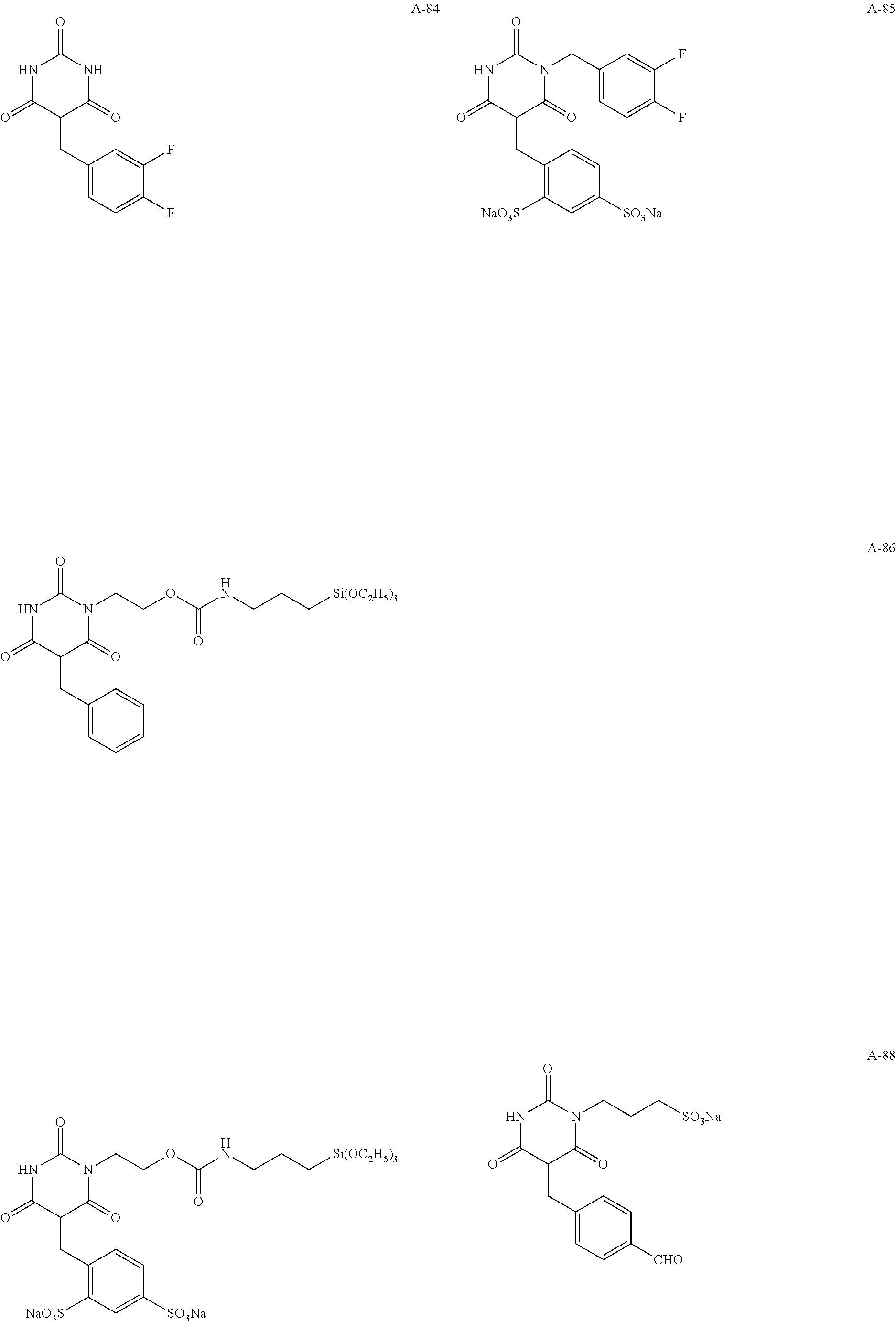

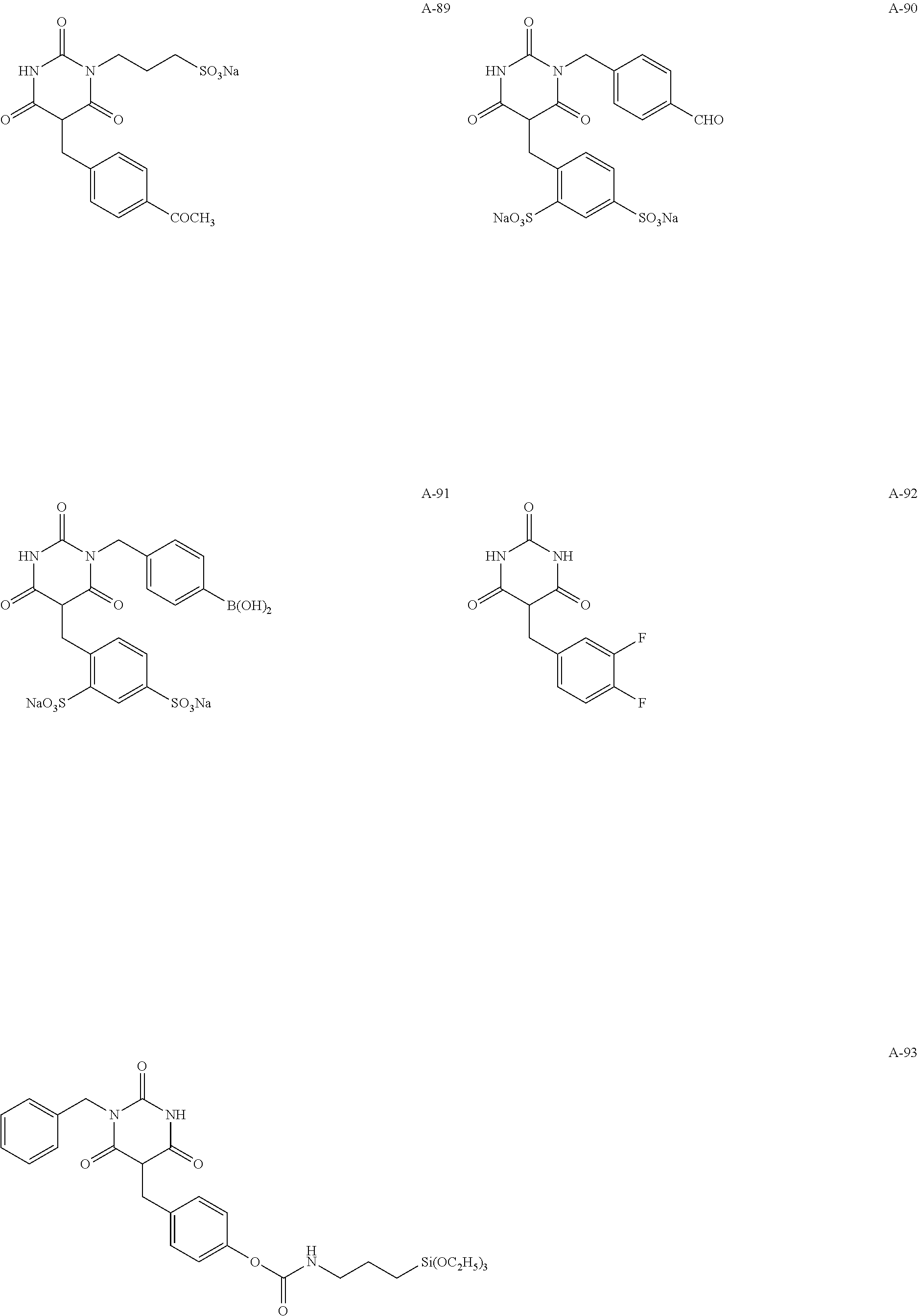

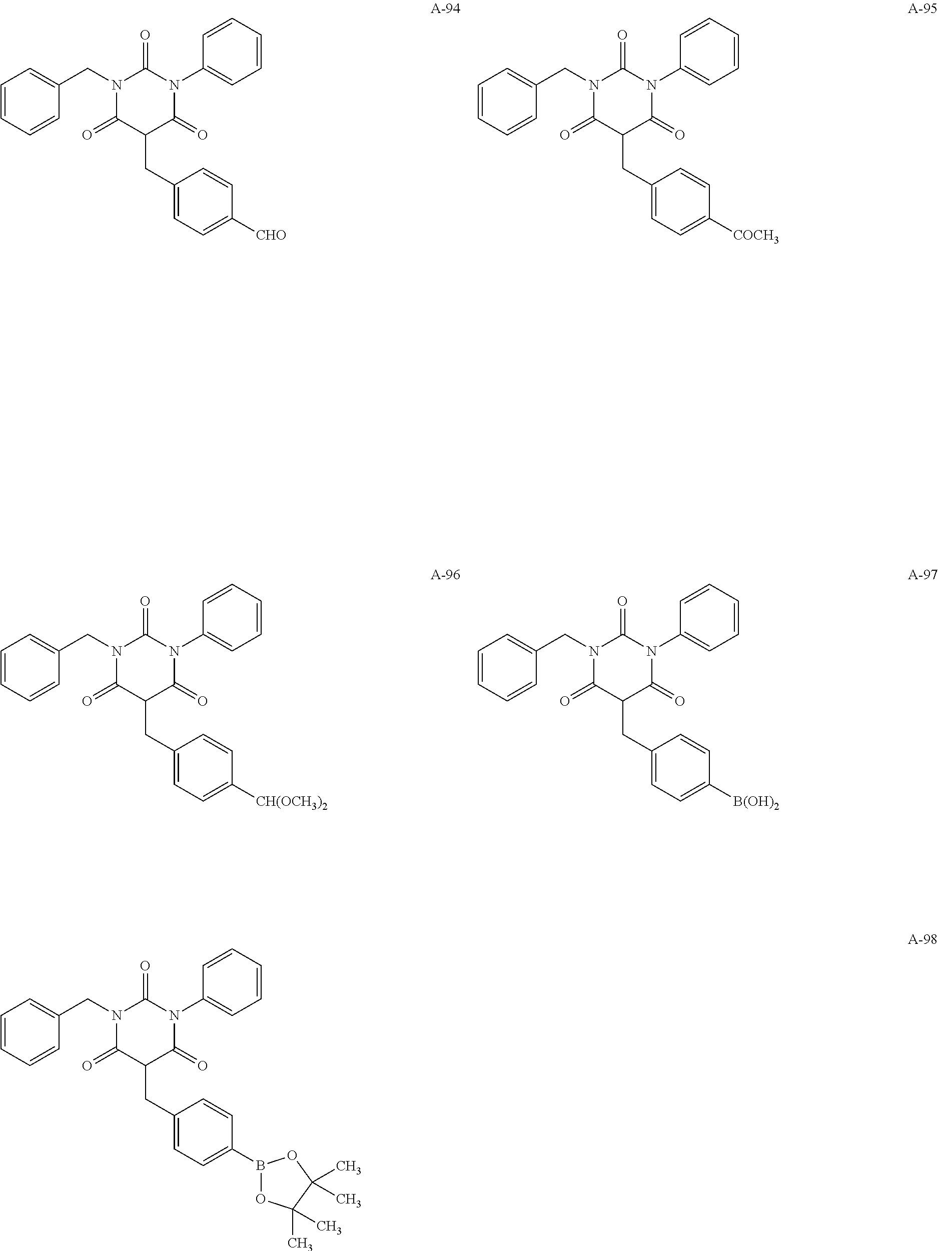

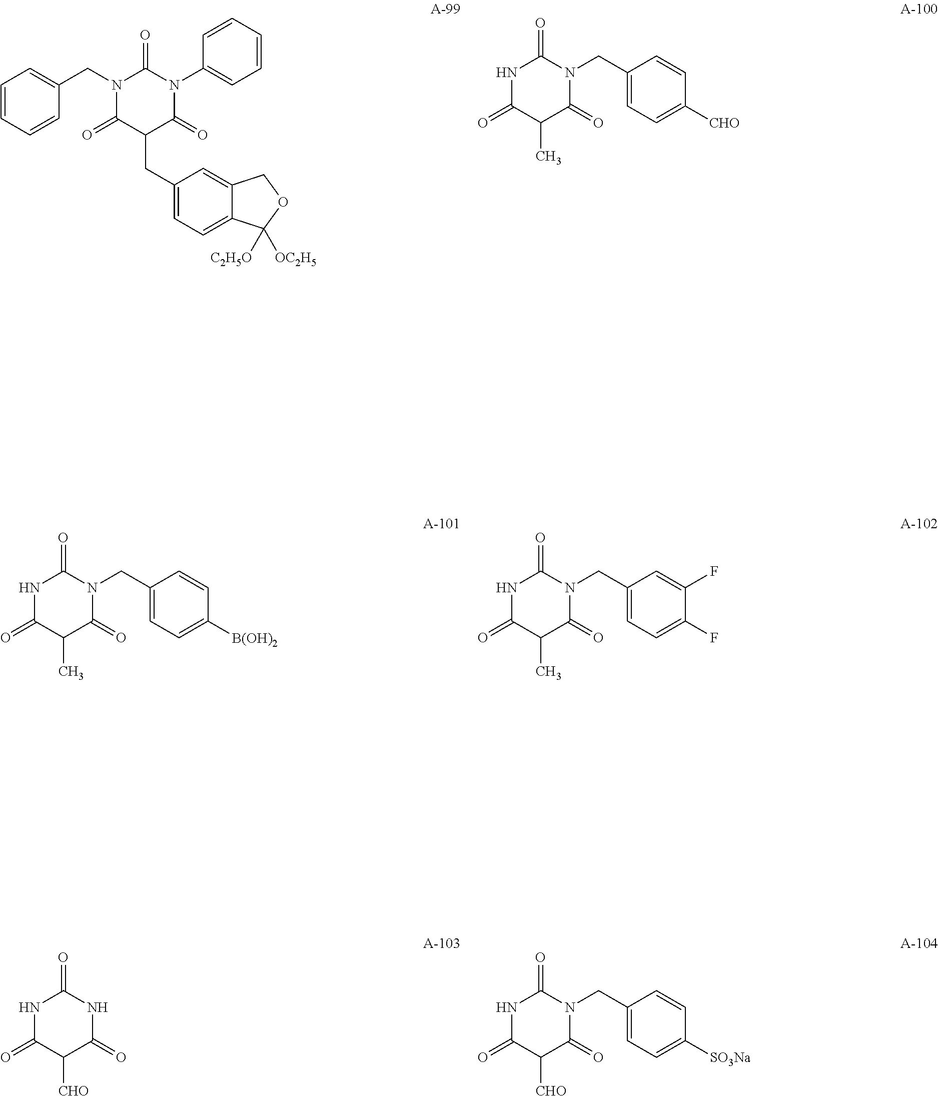

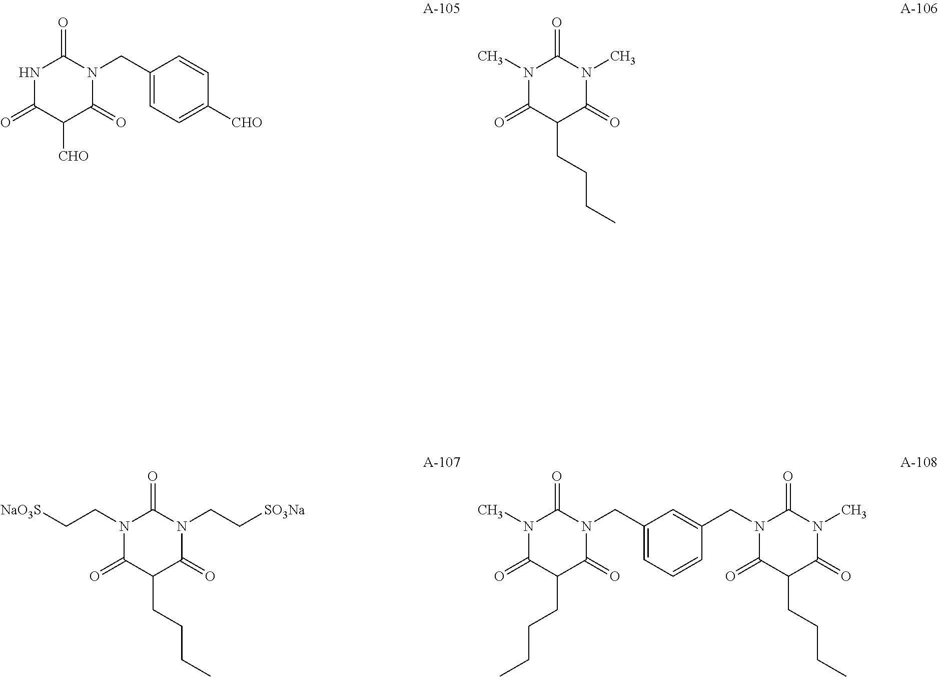

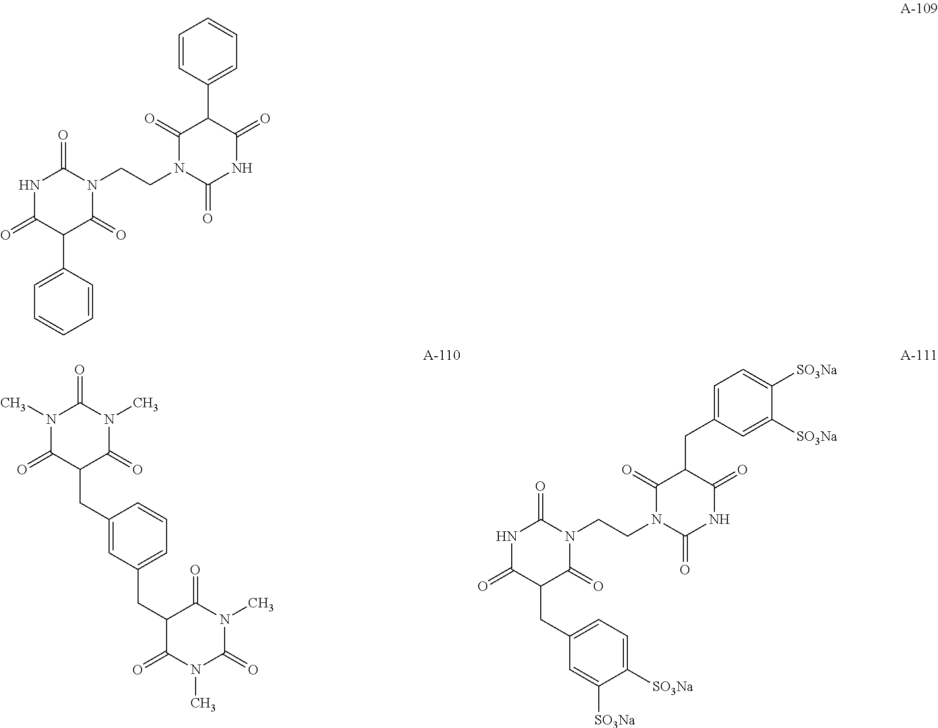

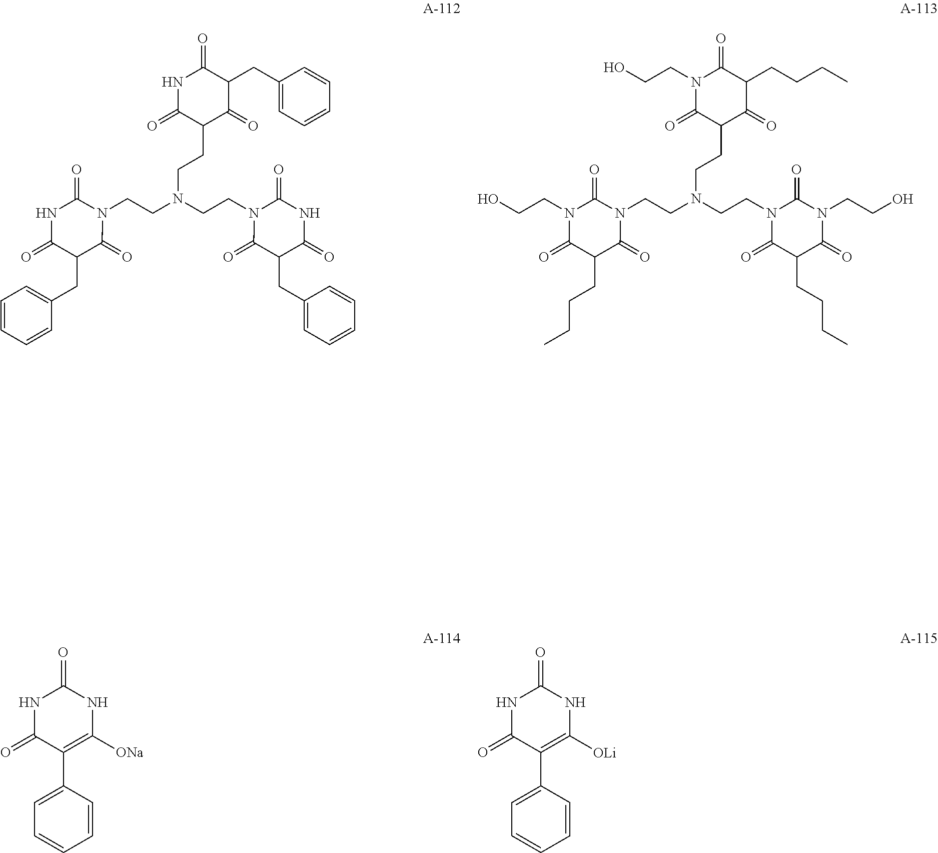

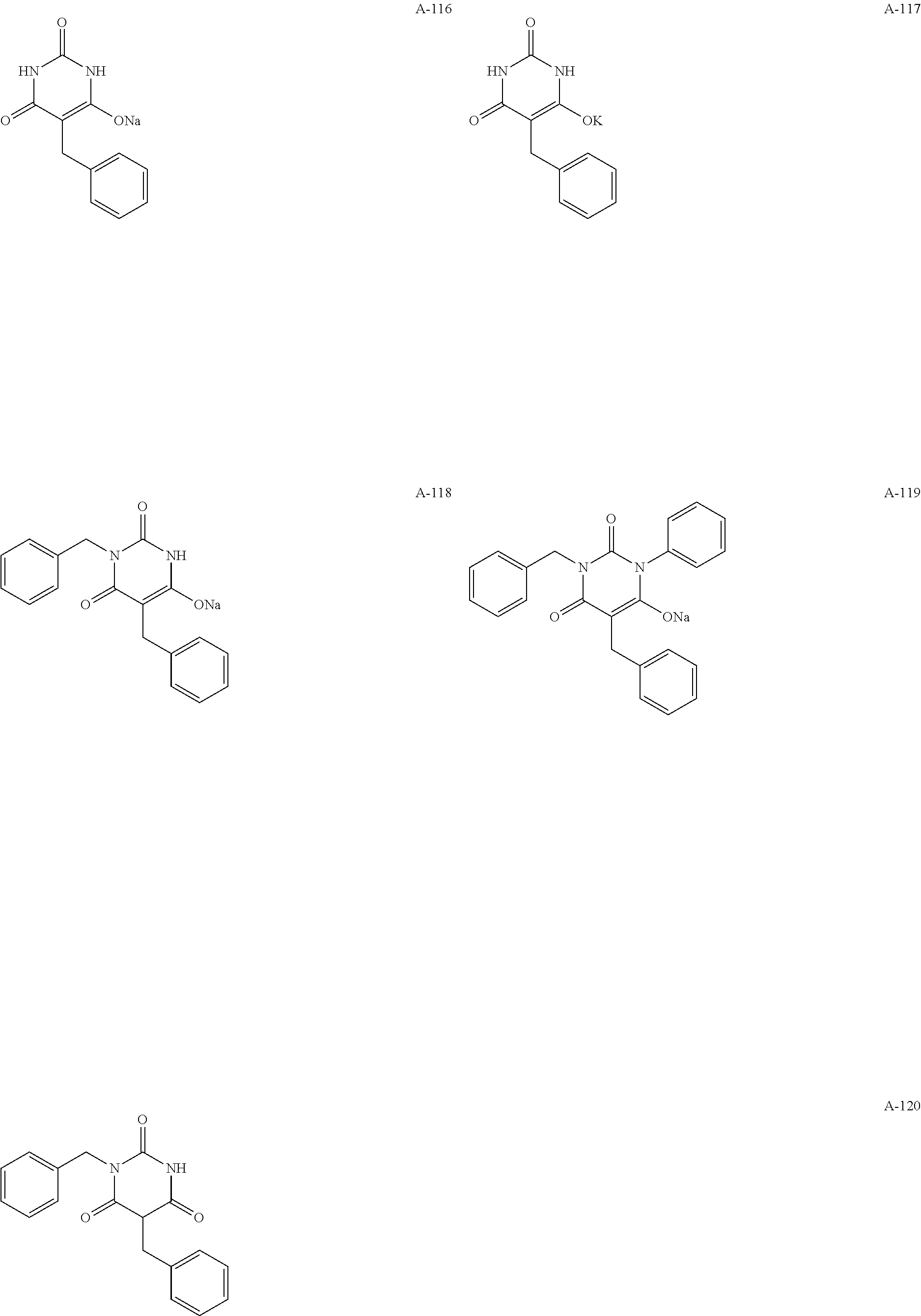

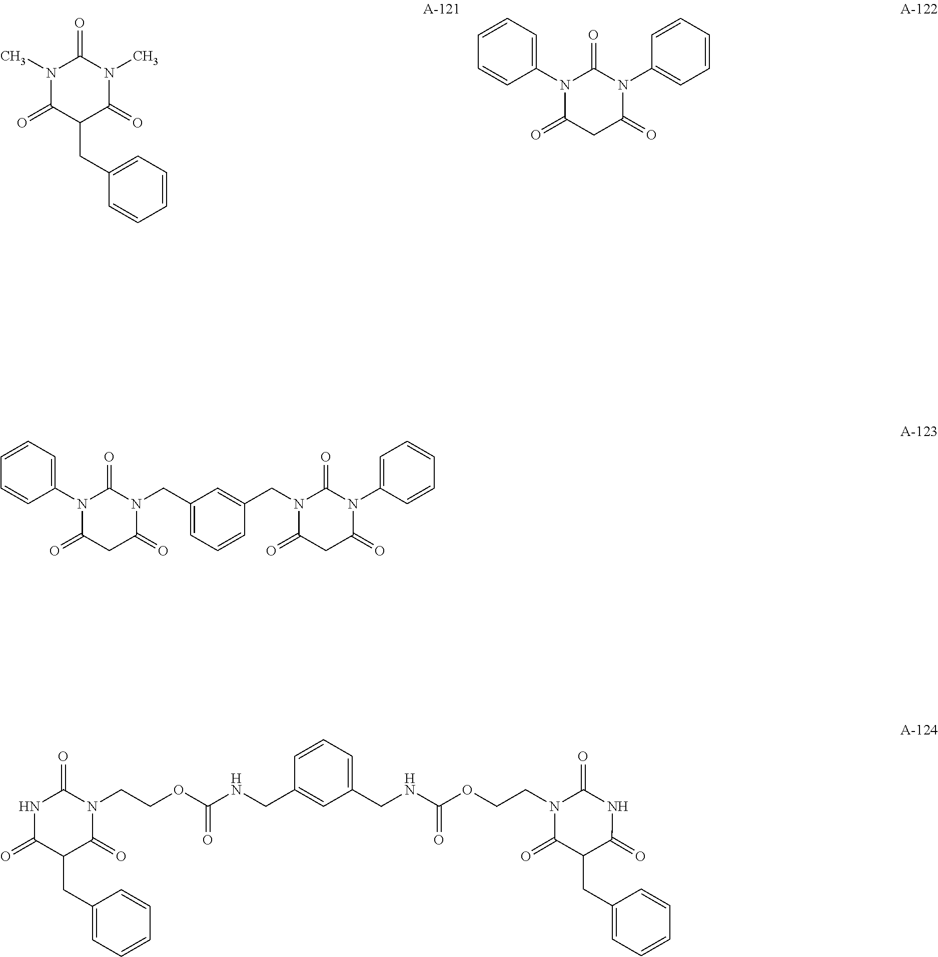 [SMILES: CN1C(=O)C(Cc2ccccc2)C(=O)N(C)C1=O ; O=C1CC(=O)N(c2ccccc2)C(=O)N1c1ccccc1 ; O=C1CC(=O)N(c2ccccc2)C(=O)N1Cc1cccc(CN2C(=O)CC(=O)N(c3ccccc3)C2=O)c1 ; O=C(NCc1cccc(CNC(=O)OCCN2C(=O)NC(=O)C(Cc3ccccc3)C2=O)c1)OCCN1C(=O)NC(=O)C(Cc2ccccc2)C1=O]

It is known to be able to synthesize the compound represented by Formula (A) by a method of synthesizing barbituric acid, based on condensation of a urea derivative with a malonic acid derivative. The barbituric acid having two substituents on the N atoms may be obtained, by heating a N,N′-disubstituted urea with malonyl chloride, or by heating with a combination of malonic acid and an activator, such as acetic anhydride. For example, methods described in: Journal of the American Chemical Society, vol. 61, p. 1015 (1939), Journal of Medicinal Chemistry, vol. 54, p. 2409 (2011), Tetrahedron Letters, vol. 40, p. 8029 (1999), and WO 2007/150011, are preferably used.

In addition, both unsubstituted and substituted malonic acids are acceptable for use in the condensation. By using malonic acid having any of correspondent substituent for R^{A5} so as to configure barbituric acid, the compounds represented by Formula (A) can be synthesized by constituting the barbituric acid compound. Moreover, when unsubstituted malonic acid and a urea derivative are condensed, barbituric acid in which the 5-position is unsubstituted can be obtained. Therefore, the compound represented by Formula (A) may be synthesized by modifying this.

As a method of modification on the 5-position, nucleophilic substitution reaction with an alkyl halide or the like, or an addition reaction such as a Michael addition reaction can be applied. Moreover, a method can also be preferably applied in which an alkylidene or aryl idene compound is formed by allowing dehydrating condensation with aldehyde or ketone, and then a double bond is reduced. For example, the method of reduction with zinc is described in Tetrahedron Letters, vol. 44, p. 2203 (2003), the reduction method by catalytic reduction is described in Tetrahedron Letters, vol. 42, p. 4103 (2001) and Journal of the American Chemical Society, vol. 119, p. 12849 (1997), and the method of reduction with NaBH₄ is described in Tetrahedron Letters, vol. 28, p. 4173 (1987) or the like, respectively. All of these are synthesis methods that can be preferably applied thereto when the compound has an aralkyl group or an cycloalkyl group in the 5-position.

The synthetic method of the compound represented by Formula (A) is not limited to the above.

Although the content of the compound represented by Formula (A) in the resin composition is not particularly limited, the content is preferably 0.1 to 20 mass parts, more preferably 0.2 to 15 mass parts, further preferably 0.3 to 12 mass parts, further preferably 0.5 to 12 mass parts, further preferably 1 to 12 mass parts, further preferably 2 to 12 mass parts, and further preferably 3 to 10 mass parts, with respect to 100 mass parts of the resin.

The water vapor transmission rate can be effectively reduced, and generation of haze of the film formed of the resin composition is inhibited by adjusting the addition amount of the compound represented by Formula (A) to the above-described preferable range.

### (Hardness Improver)

The resin composition of the present invention preferably contains a hardness improver having a plurality of amide, urethane or ureido bonds. Above all, the compounds represented by Formulae (I) and (A-100) as described in WO 2014/133041, or the compound represented by Formula (I) described in JP-A-2013-127058 is preferred.

Such a hardness improver is effective in improving hardness of the film, particularly the protective film for a polarizing plate formed using the resin composition according to the present invention, or in inhibiting deterioration of the performance of the polarizer during wet heat aging.

Herein, “cellulose acylate film” described in WO 2014/133041 is replaced by “the resin film formed of the resin composition according to the present invention,” and “cellulose acylate” described therein is replaced by “resin,” and the statements in paragraph numbers [0065] to [0256] in the same pamphlet is preferably incorporated thereinto.

It should be noted that reference to “Formula (A-3)” in [Formula 50] in paragraph number [0215] is to be replaced by reference to “Formula (A-103).”

Further, “cellulose acylate film or polarizing plate protective film” or “cellulose acylate film” described in JP-A-2013-127058 is replaced by “the resin film formed of the resin composition according to the present invention,” and “cellulose acylate” described therein is replaced by “resin,” and the statements in paragraph numbers [0094] to [0116] the same official gazette are preferably incorporated herein.

### <Application of Resin Composition>

The resin composition of the present invention is preferably used for forming a resin film.

Above all, the composition is preferably used for forming a cellulose acylate film or a protective film for a polarizing plate.

As a representative example of the resin film, the protective film for a polarizing plate, and a polarizing plate and a display using the protective film for a polarizing plate will be described below in the above order.

### <<Protective Film for Polarizing Plate>>

The protective film for a polarizing plate may be a monolayer or a laminate of a plurality of layers. In the case where the protective film for a polarizing plate is the laminate having at least two layers, a double-layered or three-layered structure is preferable, and a three-layered structure is more preferable. In the case of the three-layered structure, it is preferable to have one layer of a core layer (that is, it is the thickest layer, and it is also referred to as the base layer hereinafter), and a skin layer A and a skin layer B, which sandwich the core layer. Among these, in the present invention, the three-layered structure formed of: (skin layer B)/(core layer)/(skin layer A) is preferred. The skin layer B is a layer brought into contact with a metal support as described later, and the skin layer A is a layer at the interface with the air on the side opposite to the metal support, when the protective film for a polarizing plate is produced by the solution film formation. It is noted that, generally, both the skin layer A and the skin layer B are also referred to as a skin layer (or surface layer).

### <Method of Producing the Protective Film for Polarizing Plate>

The protective film for a polarizing plate according to the present invention can be produced by a solution casting film formation method. Hereinafter, a method of producing the protective film for a polarizing plate is described by taking as an example an aspect in which cellulose acylate is used as a resin of a main component, but the protective film for a polarizing plate can also be produced in a similar manner when any other resin is used.

In the solution casting film formation method, the film is produced using solution (dope) in which cellulose acylate is dissolved into organic solvent.

The organic solvent preferably contains solvent selected from the group consisting of an ether having 3 to 12 carbon atoms, a ketone having 3 to 12 carbon atom, an ester having 3 to 12 carbon atoms and a halogenated hydrocarbon having 1 to 6 carbon atoms.

The ether, the ketone and the ester may have a cyclic structure. Moreover, a compound having two or more of any functional groups (namely, —O—, —CO— and —COO—) of the ether, the ketone and the ester can also be used as the organic solvent.

The organic solvent may have any other functional group such as an alcoholic hydroxyl group. In the case of the organic solvent having two or more kinds of functional groups, the number of carbon atoms is preferably 1 to 12, and more preferably 3 to 12.

An amount of cellulose acylate in the cellulose acylate solution is preferably adjusted such that cellulose acylate is contained in 10 to 40 mass % in the resultant solution. The amount of cellulose acylate is further preferably 10 to 30 mass %. The above-mentioned arbitrary additive may be added to the organic solvent (main solvent).

In the solution casting film formation method, the method of drying is described in U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, British Patent No. 640731, British Patent No. 736892, JP-B-45-4554 (“JP-B” means examined Japanese patent publication), JP-B-49-5614, JP-A-60-176834, JP-A-60-203430, and JP-A-62-115035. Drying on a band or a drum can be performed by blowing air or an inert gas such as nitrogen thereonto.

Film formation can also be achieved by using the prepared cellulose acylate solution (dope) to perform casting of the solution in two or more layers. In this case, the cellulose acylate film is preferably prepared by the solution casting film formation method. The dope is preferably cast onto the drum or the band, and evaporating the solvent to form the film. A concentration of the dope before casting is preferably adjusted to be in the range of 10 to 40 mass % in an amount of solid. A surface of the drum or the band is preferably finished into a mirror surface state.

When a plurality of cellulose acylate solutions in two or more layers are cast, the plurality of cellulose acylate solutions can be cast, and the film may be prepared while lamination is made by casting the solutions containing cellulose acylate from a plurality of casting openings provided at an interval in a direction of forwarding the support. For these, for example, the methods described in JP-A-61-158414, JP-A-1-122419 and JP-A-11-198285 can be applied thereto. Moreover, film formation can also be achieved by casting the cellulose acylate solution from two casting openings. For example, the methods described in JP-B-60-27562, JP-A-61-94724, JP-A-61-94725, JP-A-61-104813, JP-A-61-158413 and JP-A-6-134933 can be applied thereto. Further, the casting method for the cellulose acylate film as described in JP-A-56-162617 can also be applied, in which flow of a cellulose acylate solution with high viscosity is enveloped with a cellulose acylate solution with low viscosity, and the cellulose acylate solution with high viscosity and the cellulose acylate solution with low viscosity are simultaneously extruded.

Moreover, the film can also be prepared by using two casting openings to strip off film formed on the support from a first casting opening, and performing second casting on a side in contact with the support surface. Specific examples include the method described in JP-B-44-20235.

As the cellulose acylate solution to be cast, an identical solution may be used, or two or more kinds of different cellulose acylate solutions may be used. In order to provide a plurality of cellulose acylate layers with functions, the cellulose acylate solutions according to the functions only need to be extruded from each casting opening. Further, the cellulose acylate solution in the present invention can also be cast simultaneously with any other functional layer (for example, an adhesion layer, a dyestuff layer, an antistatic layer, an antihalation layer, an ultraviolet absorption layer or a polarizing layer).

### (Addition of Additive)

Timing of adding the additives such as the compounds represented by Formula (1) and (TA1) specified in the present invention, a barbituric acid compound, a hardness improver, and a degradation inhibitor to the cellulose acylate solution being one example of resin raw materials of the protective film for a polarizing plate is not particularly limited as long as the additives are added thereto at a time point at which the film is to be formed. For example, they may be added at the time when the cellulose acylate is synthesized. Alternatively, they may be mixed with the cellulose acylate at the time of preparing dope.

The steps from casting to post-drying may be performed under an air atmosphere or an atmosphere of an inert gas such as a nitrogen gas. A winder used for production of the protective film for a polarizing plate in the present invention may be one that is generally used, and the film can be wound according to a winding method such as a constant tension control method, a constant torque control method, a taper tension control method, and a program tension control method in which internal stress is constant.

### (Stretching Process)

The protective film for a polarizing plate according to the present invention can also be subjected to stretching process. The protective film for a polarizing plate can be provided with desired retardation by the stretching process. A direction of stretching the cellulose acylate film may be any of a width direction or a longitudinal direction.

A method of stretching the film in the width direction is described in, for example, JP-A-62-115035, JP-A-4-152125, JP-A-4-284211, JP-A-4-298310 and JP-A-11-48271.

The film is stretched under heating conditions. The film can be stretched by processing in drying, and such a stretching is particularly effective when the solvent remains. In the case of stretching in the longitudinal direction, for example the film is stretched by adjusting a speed of a transport roller of the film to increase a film winding speed in comparison with a film stripping-off speed. In the case of stretching in the width direction, the film can be stretched also by transporting the film while retaining a width thereof with a tenter to gradually increase a width of the tenter. The film can also be stretched after the film is dried by using a stretching machine (preferably uniaxial stretching using a long stretching machine).

### (Saponification Treatment)

The protective film for a polarizing plate or the laminate thereof may be subjected to alkali saponification treatment to be provided with adhesion with a material of the polarizer, such as PVA, and the resultant material can be used as the protective film for a polarizing plate.

With regard to the method of saponification, the method described in JP-A-2007-86748, paragraph Nos. [0211] and [0212] can be applied.

For example, the alkali saponification treatment to be protective film for a polarizing plate or the laminate thereof is preferably performed in a cycle in which the film surface is immersed into an alkaline solution, and then the solution is neutralized with acidic solution, and the film is washed with water and dried. Specific examples of the alkaline solution include potassium hydroxide solution and sodium hydroxide solution. A concentration of a hydroxide ion is preferably in the range of 0.1 to 5.0 mol/L, and further preferable 0.5 to 4.0 mol/L. A temperature of the alkaline solution is preferably in the range of room temperature to 90° C., and further preferably 40 to 70° C.

In place of the alkali saponification treatment, an easy adhesion processing, as described in JP-A-6-94915 and JP-A-6-118232, may be used.

### [Film Thickness of Protective Film for a Polarizing Plate]

The thickness of the resin film being the protective film for a polarizing plate according to the present invention is preferably 1 to 40 μm, more preferably 1 to 30 μm.

The film or the polarizing plate can be stably transported in a transport step during producing the film and preparing the polarizing plate by adjusting the thickness of the protective film for a polarizing plate to 1 to 40 μm.

Furthermore, in the present invention, advantageous effects of the present invention can be effectively produced when the film thickness is low as described above.

### <<Functional Layer>>

In the protective film for a polarizing plate according to the present invention, a functional layer according to the intended purpose can be provided on the protective film for a polarizing plate, if desired.

Specific examples of the functional layer include a hard coat layer, an antireflection layer, a light scattering layer, a stain-proofing layer, an antistatic layer, an adhesion layer, a dyestuff layer, an antihalation layer, an antiglare (antidazzle) layer, a gas barrier layer, an antireflection layer, a slip layer, an ultraviolet absorption layer and a polarizing layer. These may serve as a plurality of functions in one layer.

For example, the hard coat layer is a layer for imparting hardness or scratch resistance to the protective film for a polarizing plate. It is possible to form a hard coat layer exhibiting high adhesive property with respect to the protective film for a polarizing plate, especially the cellulose acylate film, in cooperation with the compound represented by Formula (I), for example, by applying a coating composition on the protective film and curing it. A filler and/or an additive may be added to the hard coat layer, thereby to make the hard coat layer itself have mechanical, electrical or optical physical performance or chemical performance, such as water repellency or oil repellency. The thickness of the hard coat layer is preferably 0.1 to 6 μm, and more preferably from 3 to 6 μm. Having such a thin hard coat layer of which the thickness falls within the range, the resultant protective film containing the hard coat layer can have improved physical preferably in point of brittleness reduction and curling prevention, and can attain other advantages of weight saving and production cost cutting.

The hard coat layer is preferably formed by curing a curable composition. The curable composition is preferably prepared as a liquid coating composition. One example of the coating composition contains a monomer or an oligomer for a matrix formation binder, a polymer and organic solvent. Curing the coating composition applied to the substrate film can form the intended hard coat layer. The curing reaction includes crosslinking or polymerization.

### <Characteristics of Protective Film for Polarizing Plate>

The protective film for a polarizing plate is required to be low in the water vapor transmission rate, high in hardness such as Knoop hardness and pencil hardness, and low in ultraviolet transmittance and haze.

### (Water-Vapor Transmission Ratio)

In the protective film for a polarizing plate according to the present invention, the water vapor transmission rate after aging for 24 hours at 40° C. and at 90% relative humidity is preferably 1,050 g/m² or less, and more preferably 990 g/m² or less. Polarization performance deterioration of the polarizer into which the polarizing plate film according to the present invention is assembled under an environment of high temperature and high humidity can be reduced by adjusting the water vapor transmission rate within the above-described range.

A value of the water vapor transmission rate refers to a value obtained by measuring mass (g) of water vapor passing through a sample for 24 hours in an atmosphere of a temperature of 40° C. and a relative humidity of 90%, and converting the mass into the value per m² of a sample area in accordance with testing of water vapor transmission rate (dish method) of JIS Z 0208.

### (Hardness of Protective Film for a Polarizing Plate)

In the protective film for a polarizing plate of the present invention, surface hardness measured at an indentation load of 50 mN by using a Knoop indenter is preferably 210 N/mm² or more. A minimum value of Knoop hardness is further preferably 210 N/mm² or more, in which measurement is carried out by rotating the Knoop indenter in the same indentation position at the indentation load of 50 mN in accordance with the method of JIS Z 2251. The surface hardness (Knoop hardness) is measured according to a nanoindentation method. JIS Z 2251 is one of the Japan Industrial Standards created based on ISO4545. For example, a minimum value of the Knoop hardness in 18 directions in total is 210 N/mm² or more, in which measurement is carried out by rotating the Knoop indenter each time by 10° in the same indentation position. The surface hardness of the protective film for a polarizing plate is more preferably 220 N/mm² or more, and further preferably 230 N/mm² or more.

The surface hardness of the protective film for a polarizing plate can be adjusted depending on a kind and an addition amount of the additives, a polymerization degree of the resin, a composition of the dope solvent and the stretching processing of the film, or the like.

### (Ultraviolet Transmittance)

In a film formed of the resin composition according to the present invention, transmittance at the wavelength of 300 nm before testing of irradiation with light is preferably 3% or less, and more preferably 0.5% or less. In particular, the transmittance at the wavelength of 300 nm is preferably adjusted to 3% or less from a viewpoint of inhibiting deterioration of performance of polarization by light.

In the film formed of the resin composition according to the present invention, transmittance at the wavelength of 380 nm is preferably 10% or less, and more preferably 4% or less. In particular, the transmittance at the wavelength of 380 nm is preferably adjusted to 4% or less from a viewpoint of inhibiting deterioration of performance of polarization by light.

### (Haze)

The haze of the protective film for a polarizing plate according to the present invention is preferable 0.01 to 0.80%, and more preferably 0.05 to 0.50%. When the haze is 0.80% or less, contrast in the liquid crystal display is improved, and such a case is preferred.

The haze can be measured and determined by using a haze meter, for example, Haze Meter HGM-2DP (Suga Test Instruments Co., Ltd.) in accordance with JIS K-7136.

The protective film for for a polarizing plate or the laminate thereof to be measured is processed into a test piece having a size of 40 mm×80 mm, and the haze of the test piece is measured under conditions of 60% relative humidity at 25° C.

### <<Polarizing Plate>>

The polarizing plate of the present invention contains a polarizer and at least one protective film for a polarizing plate of the present invention.

The polarizing plate of the present invention contains the polarizer, and at least one protective film for a polarizing plate of the present invention arranged only on one side of the polarizer. In general, the polarizing plate is widely used in which both surfaces are protected by interposing both surfaces of the polarizer with the protective films for a polarizing plate.

In addition, when the polarizing plate has the protective films for a polarizing plate on both surfaces of the polarizer, on a surface opposite to the surface having the protective film for a polarizing plate of the present invention, a protective film for a polarizing plate different from the protective film for a polarizing plate of the present invention or a known protective film for a polarizing plate may be applied.

Specific examples of the protective film for a polarizing plate different from the protective film for a polarizing plate of the present invention include one in which an additive to be contained therein is different in a kind and a content, one having different characteristics, one with or without a functional layer or one having different functional layers.

### <Shape and Configuration>

The shape of the polarizing plate of the present invention includes a film piece that is cut to a size capable of being mounted as it is in a display, as well as a film that is manufactured in a long shape by continuous production and wound in a roll shape (for example, an aspect having the roll length of 2,500 m or longer and an aspect having the roll length of 3,900 m or longer). When it is intended for the large-screen liquid crystal display, the width of the polarizing plate is preferably set to 1,470 mm or longer.

The polarizing plate of the present invention is formed of the polarizer and at least one sheet of protective film for a polarizing plate according to the present invention. It is also preferably formed by further sticking a protect film (outside the protective film for a polarizing plate according to the present invention) onto one surface of the polarizing plate, and a separate film onto an opposite surface.

The protect film and the separate film are used for the purpose of protecting the polarizing plate during shipping the polarizing plate, product inspection or the like. In this case, the protect film is stuck thereonto for the purpose of protecting the surface of the polarizing plate, and used on a side opposite to the surface on which the polarizing plate is stuck onto a liquid crystal plate. Moreover, the separate film is used for the purpose of covering the adhesion layer to be stuck onto the liquid crystal plate, and used on a side of the surface onto which the polarizing plate is stuck onto the liquid crystal plate.

### <Polarizer>

A polarizer used for the polarizing plate of the present invention will be described.

The polarizer that can be used for the polarizing plate of the present invention is preferably composed of PVA and a dichroic molecule. In addition thereto, as described in JP-A-11-248937, a polyvinylene-based polarizer can also be used, in which PVA or polyvinyl chloride is dehydrogenated and dechlorinated to form a polyene structure, and the resulting material is oriented.

### (Resin)

In the polarizer that can be used in the present invention, a polyvinyl alcohol-based resin is preferably used. The polarizer contains as a main component a polyvinyl alcohol resin, and the resin ordinarily occupies 80 mass % or more in the polarizer. Polyvinyl alcohol is ordinarily a material obtained by saponifying polyvinyl acetate, and may be allowed to contain a component copolymerizable with vinyl acetate, for example as an unsaturated carboxylic acid, an unsaturated sulfonic acid, olefins and vinyl ethers. Moreover, a modified polyvinyl alcohol-based resin containing an acetoacetyl group, a sulfo group, a carboxy group, an oxyalkylene group or the like can also be used.

A saponification degree of the polyvinyl alcohol-based resin is not particularly limited, but from a viewpoint of solubility or the like, is preferably 80 to 100 mol %, and particularly preferably 90 to 100 mol %. A polymerization dearee of the polyvinyl alcohol-based resin is not particularly limited, but is preferably 1,000 to 10,000, and particularly preferably 1,500 to 5,000.

An elastic modulus of the polyvinyl alcohol-based resin film before stretching is preferably 0.1 MPa or more and 500 MPa or less, and further preferably 1 MPa or more and 100 MPa or less in terms of a Young's modulus.

The polyvinyl alcohol-based resin film that is excellent in an effect on inhibiting generation of wrinkles after stretching and has sufficient strength can be produced by adjusting the modulus to such a range.

### (Dichroic Dye)

The polarizer that can be used in the present invention contains a dichroic dye. Herein, the dichroic dye means a dye absorbance of which is different depending on directions, and includes an iodine ion, a diazo dye, a quinone dye and other known dichroic dyestuff. As the dichroic dye, a high-order iodine ion such as I₃⁻ and I₅⁻, or dichroic dyestuff can be preferably used.

In the present invention, the high-order iodine ion is particularly preferably used. With regard to the high-order iodine ion, as described in “Henkoban no Oyo,” edited by Ryo Nagata, CMC Publishing Co., Ltd., or Kogyo Zairyo, vol. 28, No. 7, pp. 39 to 45, polyvinyl alcohol is immersed into liquid in which iodine is dissolved in potassium iodide aqueous solution and/or boric acid aqueous solution, and the high order iodine ion is formed in a state in which iodine is adsorbed and oriented on polyvinyl alcohol.

The content of the dichroic dye is preferably 0.1 to 50 mass parts, more preferably 0.5 to 20 mass parts, and further preferably 1.0 to 5.0 mass parts, with respect to 100 mass parts of the polyvinyl alcohol-based resin.

In addition to the polyvinyl alcohol-based resin and the dichroic dye, a plasticizer or a surfactant may be added, when necessary, to the polarizer that can be used in the present invention.

### (Thickness of Polarizer)

A polarizer may be produced by any of methods of stretching or application. A film thickness is not particularly limited, but is preferably 0.1 μm to 1 mm, and particularly preferably 5 to 200 μm.

When production is made by stretching, the film thickness of the polarizer before stretching is not particularly limited, but from viewpoints of stability of film retention and homogeneity of stretching, the film thickness of the prepared polarizer is preferably 1 μm to 1 mm, and particularly preferably 5 to 200 μm.

In addition, as described in JP-A-2002-236212, such a thin PVA film may be used in which stress generated upon stretching by 4 times to 6 times in water reaches 10 N or less.

In the present invention, subjects of durability improvement and haze control can be effectively solved in the polarizer having low thickness such as 1 to 20 μm, by using a compound represented by Formula (1) and a compound represented by Formula (TA1).

### <Method of Producing Polarizer>

The method of producing the polarizer is not particularly restricted. However, for example the polarizer is preferably formed by achieving film formation of the PVA, and then introducing a dichroic molecule thereinto. Production of the PVA film can be made with reference to the method described in JP-A-2007-86748, paragraphs [0213] to [0237], Japanese Patent No. 3342516, JP-A-9-328593, JP-A-2001-30281, JP-A-2002-144401 or the like.

### <Method of Laminating Polarizer and Protective Film for Polarizing Plate>

With regard to the polarizing plate, at least one sheet of protective film for a polarizing plate according to the present invention is laminated on at least one surface of the polarizer obtained as described above.

In the present invention, the polarizing plate is preferably prepared according to a method in which a surface of the protective film for a polarizing plate is subjected to alkali treatment, and the resultant film is stuck, by using completely saponified polyvinyl alcohol solution, onto at least one surface, and preferably both surfaces of the polarizer prepared by immersing the PVA film into iodine solution and stretching the film.

Examples of the adhesive that is used for sticking the processed surface of the protective film for a polarizing plate and both sides of polarize together, include polyvinyl alcohol-based adhesives, such as polyvinyl alcohol and polyvinyl butyral; and vinyl-based latexes derived from butyl acrylate or the like.

In addition, a lamination method other than the above-mentioned lamination method can also be applied. For example, an ultraviolet-curable adhesive or the like can be used in the range in which capability of the compounds represented by Formulae (1) and (TA) according to the present invention can be maintained.

Upon sticking the protective film for a polarizing plate according to the present invention onto the polarizer, both are preferably stuck such that a transmission axis of the polarizer and the slow axis of the protective film for a polarizing plate are bisected at right angles, parallel, or crossed at 45°.

Herein, with regard to being parallel and bisected at right angles, the angle includes a range of an allowable difference in the technical field to which the present invention belongs. For example, it means that it is within a range of less than ±10° from the exact angle to be parallel or to be bisected at right angles, and the difference from the exact angle is preferably 5° or less and more preferably 3° or less.

That the transmission axis of the polarizer layer and the slow axis of the protective film for a polarizing plate are parallel means that the direction of principal refractive index nx of the protective film for a polarizing plate and the direction of the transmission axis of the polarizing plate are crossed at the angle of ±10°. This angle is preferably within 5°, more preferably within 3°, further preferably within 1°, and most preferably within 0.5°.

Further, that the transmission axis of the polarizer layer and the slow axis of the protective film for a polarizing plate are bisected at right angles, means that the direction of principal refractive index nx of the protective film for a polarizing plate and the direction of the transmission axis of the polarizer are crossed at the angle of 90°±10°. This angle, in which they are crossed, is preferably 90°±5°, more preferably 90°±3°, further preferably 90°±1°, and most preferably 90°±0.1°. When the angle is within the range as mentioned above, reduction of polarization degree performance under polarizing plate crossed Nicol is inhibited, and light leakage is reduced, and such a case is preferred.

### <Functionalization of Polarizing Plate>

The polarizing plate of the present invention can also be preferably used as a functionalized polarizing plate conjugated with an antireflection film or a brightness enhancement film for improving visibility of a display, or an optical film having a functional layer such as a hard coat layer, a forward-scattering layer, and an antiglare (antidazzle) layer. The antireflection film and the brightness enhancement film for functionalization, any other functional optical film, the hard coat layer, the forward-scattering layer, and the antiglare layer are described in JP-A-2007-86748, paragraphs [0257] to [0276], and the functionalized polarizing plate can be prepared based on these descriptions.

### <<Display>>

The present invention is preferably applied as an application of a display using the polarizer.

Specific examples include an antireflection application of a liquid crystal display or an organic electroluminescence display as such a display.

When the application is described by taking the liquid crystal display as an example, the liquid crystal display according to the present invention has at least a liquid crystal cell and the polarizing plate of the present invention. In the liquid crystal display, a configuration is taken in which the liquid crystal cell is arranged between two polarizing plates, such as a first polarizing plate and a second polarizing plate. A mode of driving the liquid crystal cell is not particularly limited, but each driving mode such as TN, OCB, VA and IPS is generally used. Further, an optically anisotropic layer for performing optical compensation is preferably used according to the mode of driving the liquid crystal cell, and is arranged between the liquid crystal cell and the polarizing plate. In addition, the protective film for a polarizing plate may have a function of the optically anisotropic layer.

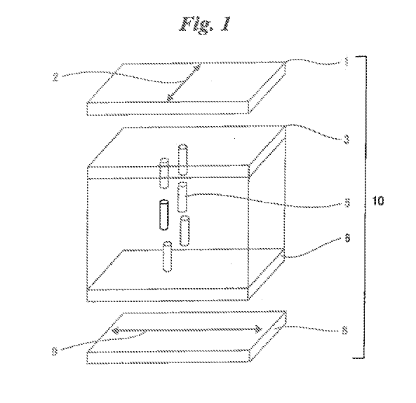

FIG. 1 is one example of a schematic diagram showing an example of a display according to the present invention as a liquid crystal display. In FIG. 1, a liquid crystal display 10 is formed of a liquid crystal cell having a liquid crystal layer 5, and a liquid crystal cell upper electrode substrate 3 and a liquid crystal cell lower electrode substrate 6 that are vertically arranged thereon, and an upper polarizing plate 1 and a lower polarizing plate 8 that are arranged on both sides of the liquid crystal cell. A color filter may be arranged between the liquid crystal cell and each polarizing plate. When the liquid crystal display 10 is used as a transmissive type, a back light using as the light source a cold cathode or hot cathode fluorescent tube, or a light-emitting diode, a field emission element or an electroluminescent element is arranged on a back surface.

The upper polarizing plate 1 and the lower polarizing plate 8 have a configuration of lamination such that the polarizer is interposed with two protective films for a polarizing plate. In the liquid crystal display 10 according to the present invention, at least one polarizing plate is the polarizing plate of the present invention. In the liquid crystal display 10 according to the present invention, the protective film for a polarizing plate according to the present invention, the polarizer, and a general transparent protective film are preferably laminated in this order from an outside (side far from the liquid crystal cell) of the display.

### EXAMPLES

The present invention will be described in more detail based on examples given below.

Materials, amounts of use, ratios, treatment contents, treatment procedures or the like as shown in Examples can be appropriately changed as long as they are not departed from the spirit of the present invention. Accordingly, the scope of the present invention should not be restrictively interpreted by the Examples shown below.

### Example 1

As described below, a resin composition containing ultraviolet absorbers was prepared, a protective film for a polarizing plate was prepared using the prepared resin composition, and performance of the obtained protective film for a polarizing plate was evaluated.

### (1) Preparation of Protective Film for Polarizing Plate 101

### (Preparation of Cellulose Acylate Solution 101)

The composition described below was charged into a mixing tank, stirred to dissolve each component thereinto, to prepare cellulose acylate solution 101.

Formulation of cellulose acylate solution 101

| | |
|---|---|
| Cellulose acetate | 100 mass parts |
| (Acetyl substitution degree: 2.88, Mw: 33,000, Mn: 15,000) | |
| Additive A-3 | 10.0 mass parts |
| Methylene chloride (first solvent) | 412.2 mass parts |
| Ethanol (second solvent) | 35.8 mass parts |

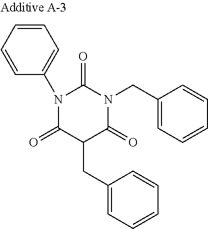 [SMILES: O=C1C(Cc2ccccc2)C(=O)N(c2ccccc2)C(=O)N1Cc1ccccc1]

### (Preparation of Matting Agent Solution 102)

The composition described below was charged into a disperser, and stirred to dissolve each component thereinto, to prepare matting agent solution 102.

Formulation of matting agent solution 102

| | |
|---|---|
| Silica particles having a mean particle size of | 2.0 mass parts |
| 20 nm (AEROSIL R972, manufactured by | |
| Nippon Aerosil Co., Ltd.) | |
| Methylene chloride (first solvent) | 79.9 mass parts |
| Ethanol (second solvent) | 6.9 mass parts |
| Cellulose acylate solution 101 | 0.9 mass part |

### (Preparation of Ultraviolet Absorber Solution 103)

The composition described below was charged into a mixing tank, stirred while being heated to dissolve each component thereinto, to prepare ultraviolet absorber solution 103.

Formulation of ultraviolet absorber solution 103

| | |
|---|---|
| Ultraviolet absorber (S-18) | 3.9 mass parts |
| Ultraviolet absorber (90) | 7.9 mass parts |
| Methylene chloride (first solvent) | 73.6 mass parts |
| Ethanol (second solvent) | 6.4 mass parts |

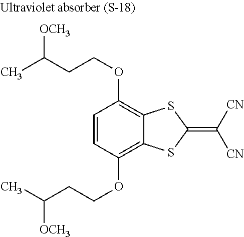 [SMILES: COC(C)CCOc1ccc(OCCC(C)OC)c2c1SC(=C(C#N)C#N)S2]

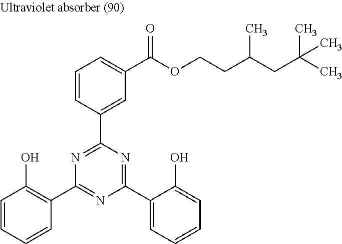 [SMILES: CC(CCOC(=O)c1cccc(-c2nc(-c3ccccc3O)nc(-c3ccccc3O)n2)c1)CC(C)(C)C]

### <Casting>

Then, 1.3 mass parts of the matting agent solution 102 and 2.6 mass parts of the ultraviolet absorber solution 103 were subjected to filtration, respectively, and then mixed using an inline mixer, and 96.1 mass parts of the cellulose acylate solution 101 was further added thereto and mixed using the inline mixer to prepare resin solution (dope). The prepared dope was cast onto a casting support made from stainless steel (temperature of the support: 22° C.) using a band casting apparatus. The formed film was stripped off when an amount of remaining solvent in the dope was into a state of about 20 mass %. Crosswise both ends of the stripped-off film were gripped with a tenter, the film in the state of 5 to 10 mass % in the amount of remaining solvent was dried while the film was stretched 1.10 times (10%) in the width direction under a temperature of 120° C., and then transported between rolls of a heat treatment apparatus, and then further dried to obtain a protective film for a polarizing plate 101. The thickness of the protective film for a polarizing plate 101 obtained was 25.8 μm, and a width thereof was 1,480 mm.

### (2) Preparation of Protective Film for a Polarizing Plate 102 to 114, and c01 to c04

Protective films for a polarizing plate 102 to 109 of the present invention and protective films for a polarizing plate c01 to c04 in Comparative Examples were prepared in a manner similar to preparation of the protective film for a polarizing plate 101 except that the kinds and addition amounts of the ultraviolet absorbers and the thickness of the film were changed as described in Table 1 below in preparation of the protective film for a polarizing plate 101.

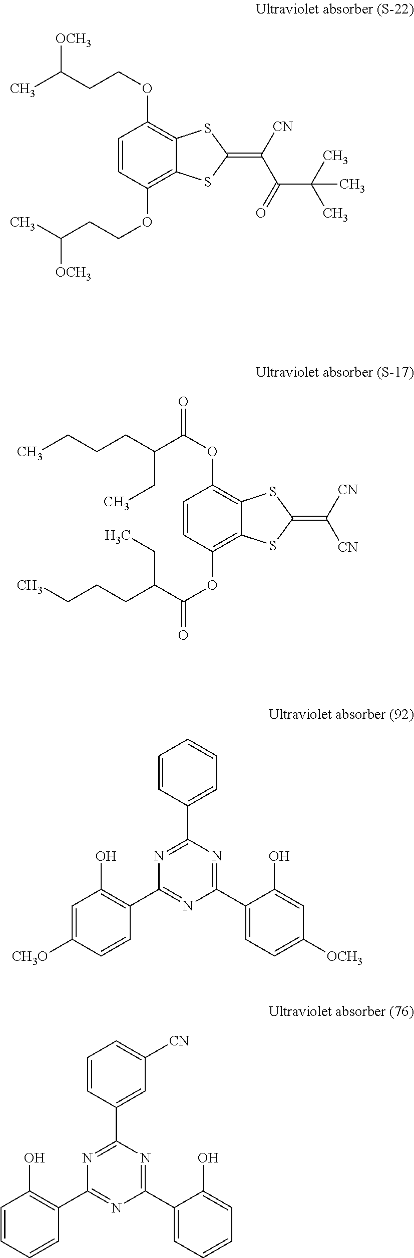

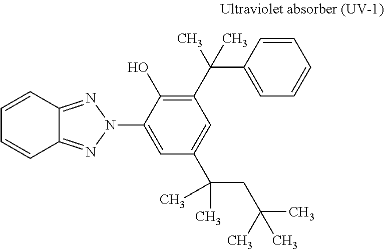 [SMILES: CC(C)(C)CC(C)(C)c1cc(-n2nc3ccccc3n2)c(O)c(C(C)(C)c2ccccc2)c1]

### (3) Performance Evaluation of Protective Film for Polarizing Plate

Haze, presence or absence of coloring and light resistance of each protective film for a polarizing plate (change of ultraviolet transmittance by continuous irradiation with the ultraviolet rays) were evaluated.

### <Measurement of Haze of Protective Film for Polarizing Plate>

Measurement was carried out on the film sample of 40 mm×80 mm under an environment of 60% relative humidity at 25° C. by using Haze Meter HGM-2DP (Suga Test Instruments Co., Ltd.) in accordance with JIS K-7136.

### <Evaluation of Coloring of Protective Film for Polarizing Plate>

After the continuous irradiation with ultraviolet light for 100 hours in Evaluation of light resistance of protective film for a polarizing plate as described below, presence or absence of coloring of the protective film for a polarizing plate was evaluated by visual observation. The results are shown in Table 1.

### <Evaluation of Light Resistance of Protective Film for Polarizing Plate>

Transmittance of the film before and after irradiation with light was measured, and light resistance of the protective film for a polarizing plate was evaluated based thereon.

The transmittance of the film was measured at wavelengths of 300 nm and 380 nm by means of Spectrophotometer UV-3150 manufactured by Shimadzu Corporation.

Each protective film for a polarizing plate before irradiation with light was irradiated with light at the wavelengths of 300 nm and 380 nm to measure the transmittance of light at each wavelength. Subsequently, each protective film for a polarizing plate was continuously irradiated with ultraviolet light for 100 hours under an environment of 50% relative humidity at 60° C. by using Super Xenon Weather Meter SX75 manufactured by Suga Test Instruments Co., Ltd., and then each protective film for a polarizing plate was again irradiated with light at the wavelengths of 300 nm and 380 nm to measure the transmittance (%) of light with each wavelength. Light resistance can be judged from a change of the transmittance of before and after the light irradiation.

The obtained results are shown together in Table 1.

### Example 2

A polarizing plate i gas prepared, and durability of a polarizer was evaluated as described below.

### (1) Preparation of Polarizing Plate H101

### (a) Saponification Treatment of Protective Film for Polarizing Plate

The protective film for a polarizing plate 101 prepared as Example 1 was immersed into 2.3 mol/L sodium hydroxide aqueous solution for 3 minutes at 55° C. The film was washed in a water-washing bath at room temperature, and neutralized at 30° C. by using 0.05 mol/L sulfuric acid. The film was again washed in the water-washing bath at room temperature, and further dried using hot air at 100° C.

### (b) Preparation of Polarizing Plate

A polarizer was prepared by adsorbing iodine onto a stretched polyvinyl alcohol film.

The saponification-treated protective film for a polarizing plate 101 was stuck, by using a polyvinyl alcohol-based adhesive, onto one side of the polarizer. A commercially available cellulose triacetate film (FUJITAC TD80UF, manufactured by Fujifilm Corporation) was also subjected to similar saponification treatment, and this saponification-treated cellulose triacetate film was stuck, by using a polyvinyl alcohol-based adhesive, onto a surface of the polarizer on a side opposite to the side on which the saponification-treated protective film for a polarizing plate 101 was stuck.

On this occasion, arrangement was made such that the transmission axis of the polarizer and the slow axis of the saponification-treated protective film for a polarizing plate 101 became orthogonal. Moreover, arrangement was also made such that the transmission axis of the polarizer and the slow axis of the commercially available saponification-treated cellulose triacetate film became orthogonal.

Thus, a polarizing plate H101 of the present invention was prepared.

### (2) Preparation of Polarizing Plates H102 to H109 and Hc01 to Hc04

Polarizing plates H102 to H109 of the present invention and comparative polarizing plates Hc01 to Hc04 were prepared in a manner similar to preparation of the polarizing plate H101 except that the protective film for a polarizing plate 101 was changed to any one of the protective films for a polarizing plate 102 to 109 and c01 to c04 in preparation of the polarizing plate H101.

### (3) Evaluation of Polarizing Plate Durability

Orthogonal transmittance at the wavelength of 700 nm was measured, on each polarizing plate prepared as described above, by the method described below.

Orthogonal transmittance of the polarizing plate was measured at a wavelength of 700 nm using an automatic polarization film measuring apparatus VAP-7070 manufactured by JASCO Corporation according to the following method.

Two samples (5 cm×5 cm) each prepared by sticking a polarizing plate onto glass through a removable adhesive were prepared. On this occasion, the plate was stuck thereon such that the protective film for a polarizing plate prepared as described above was placed on a side (air interface side) opposite to the glass. Orthogonal transmittance was measured by setting this assembly by affecting the glass side of this sample toward a light source. Measurement was performed on two samples, and mean value thereof was taken as the orthogonal transmittance.

Then, the samples were continuously irradiated with ultraviolet light for 400 hours by using Super Xenon Weather Meter SX75 manufactured by Suga Test Instruments Co., Ltd. under an environment of 50% relative humidity at 60° C. The orthogonal transmittance was also measured on the polarizing plates after the continuous irradiation with ultraviolet in a similar manner as described above.

An amount of change of the orthogonal transmittance before and after irradiation with light (difference of the orthogonal transmittance before and after irradiation with light) was determined from the obtained measured values. A change ratio (%) of the orthogonal transmittance at the wavelength of 700 nm was calculated from a formula: (amount of change/orthogonal transmittance before the continuous irradiation with ultraviolet light)×100. The change ratio was evaluated based on the following criteria, and the results were taken as the durability of the polarizing plate, and described in Table 1.
A: The change ratio was less than 0.2%.
B: The change ratio was 0.2% or more and less than 1.0%.
C: The change ratio was 1.0% or more.

TABLE 1

| | | Total addition | Before continuous irradiation | | After continuous irradiation | |
|---|---|---|---|---|---|---|
| Protective | Combination of | Amount | with ultraviolet rays | | with ultraviolet rays | |
| film No. for | ultraviolet absorbers | of ultraviolet | Transmittance | Transmittance | Transmittance | Transmittance |
| polarizing plate | (Addition amount*) | absorbers* | (%) at 300 nm | (%) at 380 nm | (%) at 300 nm | (%) at 380 nm |
| 101 | Ultraviolet absorber (S-18) (0.75 mass part) | 2.25 mass parts | 2.25 | 3.33 | 2.25 | 3.88 |
| | Ultraviolet absorber (90) (1.5 mass parts) | | | | | |
| 102 | Ultraviolet absorber (S-18) (0.75 mass part) | 1.98 mass parts | 0.0569 | 2.98 | 0.0594 | 3.56 |
| | Ultraviolet absorber (92) (1.23 mass parts) | | | | | |
| 103 | Ultraviolet absorber (S-22) (0.86 mass part) | 2.36 mass parts | 2.83 | 3.55 | 2.79 | 3.76 |
| | Ultraviolet absorber (90) (1.5 mass parts) | | | | | |
| 104 | Ultraviolet absorber (S-22) (0.86 mass part) | 2.09 mass parts | 0.0832 | 3.01 | 0.0976 | 3.65 |
| | Ultraviolet absorber (92) (1.23 mass parts) | | | | | |
| 105 | Ultraviolet absorber (S-17) (0.89 mass part) | 2.39 mass parts | 2.70 | 3.11 | 2.85 | 3.95 |
| | Ultraviolet absorber (90) (1.5 mass parts) | | | | | |
| 106 | Ultraviolet absorber (S-17) (0.89 mass part) | 2.12 mass parts | 0.0612 | 2.76 | 0.0655 | 3.01 |
| | Ultraviolet absorber (92) (1.23 mass parts) | | | | | |
| 107 | Ultraviolet absorber (S-18) (0.75 mass part) | 1.82 mass parts | 2.45 | 3.50 | 2.50 | 3.77 |
| | Ultraviolet absorber (76) (1.07 mass parts) | | | | | |
| 108 | Ultraviolet absorber (S-22) (0.86 mass part) | 1.93 mass parts | 2.66 | 3.47 | 2.81 | 3.98 |
| | Ultraviolet absorber (76) (1.07 mass parts) | | | | | |
| 109 | Ultraviolet absorber (S-17) (0.89 mass part) | 1.96 mass parts | 2.50 | 3.65 | 2.63 | 3.89 |
| | Ultraviolet absorber (76) (1.07 mass parts) | | | | | |
| c01 | Ultraviolet absorber (S-18) (0.75 mass part) | 2.04 mass parts | 2.097 | 3.70 | 3.751 | 16.73 |
| | Ultraviolet absorber (UV-1) (1.29 mass parts) | | | | | |
| c02 | Ultraviolet absorber (UV-1) (3.5 mass parts) | 3.50 mass parts | 0.066 | 13.49 | 0.083 | 14.33 |
| c03 | Ultraviolet absorber (S-22) (0.86 mass part) | 2.15 mass parts | 2.23 | 3.80 | 3.911 | 18.21 |
| | Ultraviolet absorber (UV-1) (1.29 mass parts) | | | | | |
| c04 | Ultraviolet absorber (S-17) (0.89 mass part) | 2.18 mass parts | 2.18 | 3.75 | 3.854 | 17.22 |
| | Ultraviolet absorber (UV-1) (1.29 mass parts) | | | | | |

| Protective | | | | | |
|---|---|---|---|---|---|
| film No. for | Film thickness | | | Polarizing plate | |
| polarizing plate | (μm) | Haze (%) | Coloring | durability | Remarks |
| 101 | 25.8 | 0.25 | Absence | A | This invention |
| 102 | 26.2 | 0.24 | Absence | A | This invention |
| 103 | 25.5 | 0.23 | Absence | A | This invention |
| 104 | 25.1 | 0.22 | Absence | A | This invention |
| 105 | 25.4 | 6.26 | Absence | A | This invention |
| 106 | 25.5 | 0.27 | Absence | A | This invention |
| 107 | 25.6 | 0.22 | Absence | A | This invention |
| 108 | 25.9 | 0.24 | Absence | A | This invention |
| 109 | 25.5 | 0.25 | Absence | A | This invention |
| c01 | 26.0 | 0.24 | Presence | B | Comparative Example |
| c02 | 40.0 | 1.23 | Absence | C | Comparative Example |
| c03 | 25.8 | 0.27 | Presence | B | Comparative Example |
| c04 | 26.4 | 0.25 | Presence | B | Comparative Example |

*Mass parts with respect to 100 mass parts of cellulose acylate

In the protective films for a polarizing plate 101 to 109 obtained using the resin composition in which both the compound represented by Formula (1) and the compound represented by Formula (TA1) were used, the transmittance at the wavelength of 380 nm was low for all even by the continuous irradiation with the ultraviolet rays, and the effect of shielding the ultraviolet light was satisfactorily maintained.

In contrast, in the protective films for a polarizing plate c01, c03 and c04 formed using the resin composition in which the compound represented by Formula (1) was combined with the hitherto-known ultraviolet absorber (UV-1), it was found that the transmittance at the wavelength of 380 nm was significantly increased by the continuous irradiation with the ultraviolet rays, and satisfactory maintenance of the effect of shielding the ultraviolet light was not allowed. This result suggests a possibility with which UV-1 accelerated photolysis of the compounds represented by Formula (1). Further, with regard to the protective film for a polarizing plate c02 obtained using the resin composition in which the hitherto-known ultraviolet absorber was added alone, the transmittance at the wavelength of 380 nm was high, and the effect of shielding the ultraviolet tight was insufficient, even though the film thickness increased by about 1.5 times.

Moreover, all of the protective films for a polarizing plate 101 to 109 of the present invention had only limited generation of haze, and the polarizing plates using the same had excellent light resistance.

Having described our invention as related to the present embodiments, it is our intention that the invention not be limited by any of the details of the description, unless otherwise specified, but rather be construed broadly within its spirit and scope as set out in the accompanying claims.

### REFERENCE SIGNS LIST

1 Upper polarizing plate
2 Upper polarizing plate absorption axis direction
3 Liquid crystal cell upper electrode substrate
5 Liquid crystal layer
6 Liquid crystal cell lower electrode substrate
8 Lower polarizing plate
9 Lower polarizing plate absorption axis direction
10 Liquid crystal display

1. A resin composition, comprising:
a resin,
a compound represented by Formula (1), and
a compound represented by Formula (TA1): 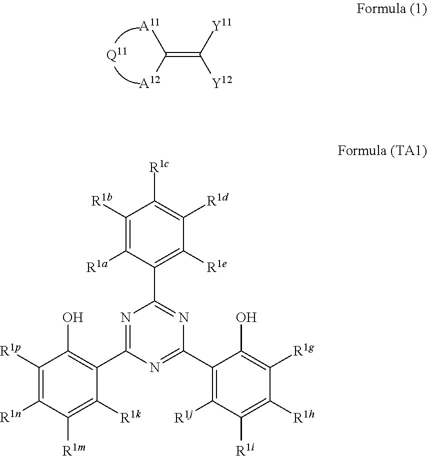
wherein, in Formula (1), A¹¹ and A¹² each independently designate a heteroatom; Y¹¹ and Y¹² each independently designate a hydrogen atom or a substituent; at least one of Y¹¹ and Y¹² is a substituent having the Hammett's substituent constant σp value of 0.2 or more; Y¹¹ and Y¹² may bond to each other to form a ring; and Q¹¹ designates a group of atoms required for forming a 5- or 6-membered ring bonded with A¹¹, A¹² and the carbon atom of >C═; and
wherein, in Formula (TA1), R^{1a} to R^{1e} each independently designate a hydrogen atom or a substituent other than a hydroxy group; when at least one of R^{1a} to R^{1e} is a substituent, at least one of the substituent is a substituent having the Hammett's substituent constant σp value of 0.3 or more; R^{1g} to R^{1j} and R^{1k} to R^{1p} each independently designate a hydrogen atom or a substituent; and among R^{1g} to R^{1j} and R^{1k} to R^{1p}, two substituents adjacent with each other may be bonded to form a ring.

2. The resin composition according to claim 1, wherein the compound represented by Formula (1) is a compound represented by Formula (2): 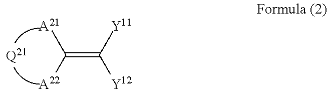
wherein Y¹¹ and Y¹² have the same meaning as the Y¹¹ and Y¹² of Formula (1); A²¹ and A²² each independently designate a heteroatom selected from the group consisting of an oxygen atom, a nitrogen atom, and a sulfur atom; and Q²¹ designates a group of atoms required for forming a 5- or 6-membered ring bonded with A²¹, A²² and the carbon atom of >C═.

3. The resin composition according to claim 2, wherein the compound represented by Formula (2) is a compound represented by Formula (3): 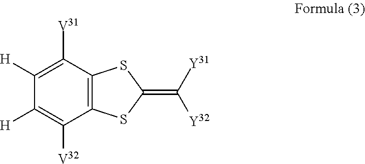
wherein Y³¹ and Y³² each independently designate a substituent; at least one of Y³¹ and Y³² is a cyano group, and the other is a cyano group, an alkylcarbonyl group, an arylcarbonyl group, a heterocyclic carbonyl group, an alkylsulfonyl group, or an arylsulfonyl group; and V³¹ and V³² each independently designate a hydrogen atom or a substituent.

4. The resin composition according to claim 3, wherein the compound represented by Formula (3) is a compound represented by Formula (4): 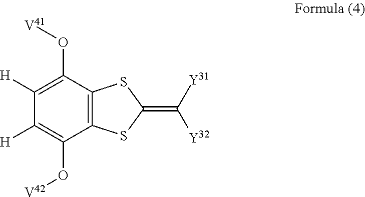
wherein Y³¹ and Y³² have same meaning as the Y³¹ and Y³² of Formula (3); and V⁴¹ and V⁴² each independently designate an alkyl group, an acyl group, a carbamoyl group, or an alkoxycarbonyl group.

5. The resin composition according to claim 1 wherein the Hammett's substituent constant σp value in Formula (TA1) is 0.3 to 1.2.

6. The resin composition according to claim 1, wherein the substituent satisfying the Hammett's substituent constant σp value defined in Formula (TA1) is a group selected from the group consisting of —COOR^{r}, —CON(R^{s1})(R^{s2}), a cyano group, —CF₃, —NO₂ and —SO₃M; R^{r}, R^{s1} and R^{s2} are each independently a hydrogen atom or a substituent; and M is a hydrogen atom or an alkaline metal.

7. The resin composition according to claim 1, wherein the substituent satisfying the Hammett's substituent constant σp value defined in Formula (TA1) is —COOR^{r} or a cyano group; and R^{r} is a hydrogen atom or a substituent.

8. The resin composition according to claim 1, wherein the substituent satisfying the Hammett's substituent constant σp value defined in Formula (TA1) is R^{1d}.

9. The resin composition according to claim 1, wherein, in Formula (TA1), R^{1a} to R^{1e} each are a hydrogen atom, and R^{1h} and R¹ⁿ each are an alkoxy group.

10. The resin composition according to claim 1, wherein the resin is a cellulose acylate.

11. The resin composition according to claim 1, wherein
the resin is a cellulose acylate, and the content of the cellulose acylate is from 5% to 99% by mass with respect to the total solid content of the resin composition,
the content of the compound represented by Formula (1) is 0.1 to 5 mass parts with respect to 100 mass parts of the resin content, and
the content of the compound represented by Formula (TA1) is 0.1 to 5 mass parts with respect to 100 mass parts of the resin content.

12. The resin composition according to claim 1, wherein the total content of the compound represented by Formula (1) and the compound represented by Formula (TA1) is 0.5 to 5 mass parts, with respect to 100 mass parts of the resin content.

13. The resin composition according to claim 1, wherein the content of the compound represented by Formula (TA1) is higher than the content of the compound represented by Formula (1).

14. The resin composition according to claim 1, further comprising a barbituric acid compound represented by Formula (A): 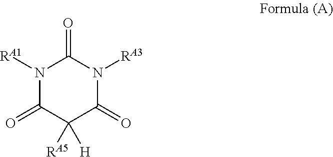
wherein R^{A1} and R^{A3} each independently designate a hydrogen atom, an alkyl group, a cycloalkyl group, an alkenyl group, or an aromatic group; and R^{A5} designates a hydrogen atom or a substituent.

15. The resin composition according to claim 14, wherein the content of the compound represented by Formula (A) is 0.1 to 20 mass parts with respect to 100 mass parts of the resin.

16. A protective film for a polarizing plate, which is formed of the resin composition according to claim 1.

17. The protective film according to claim 16, wherein the thickness of the protective film is 1 to 40 μm.

18. A polarizing plate, comprising at least one of the protective film for a polarizing plate according to claim 16.

19. A display, comprising at least one of the polarizing plate according to claim 18.
